(19) United States
(12) Patent Application Publication
(10) Pub. No.: US 2014/0081613 A1
(43) Pub. Date: Mar. 20, 2014

(54) METHOD, SYSTEM AND COMPUTER READABLE MEDIUM FOR SCENARIO MANGEMENT OF DYNAMIC, THREE-DIMENSIONAL GEOLOGICAL INTERPRETATION AND MODELING

(71) Applicant: Austin GeoModeling, Inc., (US)

(72) Inventors: Robin Dommisse, Austin, TX (US); Tron Isaksen, Austin, TX (US)

(73) Assignee: AUSTIN GEOMODELING, INC., Austin, TX (US)

(21) Appl. No.: 13/666,757

(22) Filed: Nov. 1, 2012

Related U.S. Application Data
(60) Provisional application No. 61/554,249, filed on Nov. 1, 2011.

(51) Int. Cl. G06T 17/05

(52) U.S. Cl. CPC G06T 17/05
USPC 703/10

(57) ABSTRACT

Techniques and a system for performing geological interpretation operations in support of energy resources exploration and production perform well log correlation operations for generating a set of graphical data describing the predetermined geological region. The process and system interpret the geological environment of the predetermined geological region from measured surface and fault data associated with the predetermined geological region. Allowing the user to query and filter graphical data representing the predetermined geological region, the method and system present manipulable three-dimensional geological interpretations of two-dimensional geological data relating to the predetermined geological region and provide displays of base map features associated with the predetermined geological region. The method and system automatically update the manipulable three-dimensional geological interpretations of two-dimensional data relating to the predetermined geological region, as well as calculate three-dimensional well log and seismic interpretations of geological data relating to the predetermined geological region.

### CROSS REFERENCE TO RELATED APPLICATION

This application claims the priority of U.S. Provisional Application No. 61/554,249 entitled “METHOD, SYSTEM AND COMPUTER READABLE MEDIUM FOR SCENARIO MANAGEMENT OF DYNAMIC, THREE-DIMENSIONAL GEOLOGICAL INTERPRETATION AND MODELING” and filed on Nov. 1, 2011.

### FIELD

The disclosed subject matter relates to geological information analysis and processing methods and systems. More particularly, this disclosure relates to a method and system for dynamic, three-dimensional geological interpretation and modeling.

### DESCRIPTION OF THE RELATED ART

Known well log correlation software tools succeed in transferring the paper-based workflows to the computer workstation. The drawback of such tools includes that they solve correlation and mapping problems in a two-dimensional environment, merely replacing the paper workflows with computer screens without truly speeding the geological interpretation process. Current three-dimensional modeling applications are not capable of rendering real-time results, because they do not work practically as geological interpretation tools. Not surprisingly, many geologists in both major and independent oil and gas companies continue to prefer to perform geological interpretation using traditional hard copy well logs. With such systems, three-dimensional visualization is implemented as an afterthought or is introduced during the three-dimensional geological modeling phase, where such visualization is often performed by expert three-dimensional modelers or reservoir engineers instead of interpreting geoscientists.

Just as major oil companies have embraced sequence stratigraphic concepts and computer technology in exploration and production, so, too, must independent exploration and production companies. This is because a company's success increasingly depends on data management, visualization, stratigraphic analysis or interpretation technologies. Moreover, these activities depend on the speed at which they develop and deliver a energy resource (oil or gas) production prospect to an investor.

A typical interpretation system example is its ability to visualize and correlate hundreds of horizontal wells directly in three-dimensional, thus significantly simplifying the geological interpretation process involving complex well trajectories. Currently, geoscientists have to use separate applications for well-log correlation, surface modeling, and mapping, and for three-dimensional modeling and visualization. The functional development of these applications has stagnated in recent years, despite costing oil and gas companies millions of dollars in maintenance and deployment costs.

Today, market-leading products are not easily portable or scalable. Instead of creating an environment of continuous innovation, no known solutions enable oil and gas companies to optimize their workflows through time savings or the use of new features. The known systems require expensive and complicated software maintenance and support, essentially due to their lack of integration between the ever-growing lists of PC or smaller applications.

One key limitation of known systems supporting geological interpretation, derives from the use of centralized databases. Centralized database systems have been invaluable in bringing order to the chaotic abundance of data managed by asset teams and interpreters. Building a database project forces the user to address data related issues such as quality and relevance. Because data is obtained from a wide variety of sources, this is not a trivial task and often requires days, and sometimes weeks, to complete. One of the drawbacks of centralized database systems is an inflexibility regarding the quick integration of certain geological data types. Database schemas also are rigidly defined, forcing the user to spend significant amounts of time massaging data in preparation for database loading. As a result, exclusion of important data occurs due to a lack of time.

Another limitation of known systems and process for geological interpretation is that well plans created using static geological interpretation and modeling tools rarely match the real world geology encountered during drilling. Conventional well planning solutions spread the interpretation while drilling (IWD) workflows across multiple applications and data management modules, making it difficult and time consuming for energy resource exploration and production teams to integrate new data in order to reconstruct the geological interpretation. Increasingly more complex drilling environments call for more accurate predictive well planning, using real-time operational decisions to drill more cost-effective wells.

One of the advantages of sequence stratigraphy in well log interpretation, for example, lies in the power of its predictive capacity. A robust interpretation, based on complete log suites, cores and sequence stratigraphic correlation, may help predict reservoir-prone facies. The speed and accuracy of this process has been greatly enhanced by advancements in computer technology and more versatile software programs.

However, for those who are trying to compete using paper-based interpretation workflows, the development of a robust interpretation is a slow and tedious process. Furthermore, with each new data point, updating paper cross-sections and maps is frustratingly slow and cumbersome. Valuable time is therefore lost throughout the entire process, from data collection to the delivery of a finalized prospect.

In traditional interpretation application suites, if a geoscientist identifies an interpretation problem in a three-dimensional modeling application, he must return to his two-dimensional well log correlation software to change the interpretation, then re-grid the horizons in the mapping software, before returning to the three-dimensional modeling software to observe the changes. This process may take from hours to days to complete, and is tediously repetitive, costing valuable time and resources before finalizing an interpretation.

To address the two-dimensional focus of traditional well log correlation and mapping software, a need exists for new geological interpretation tools to enable transitioning the geological interpretation process from the two-dimensional domain to the three-dimensional domain.

There is the need for a system that enables a geologist to solve complex geological interpretation problems that cannot be resolved using software that relies on traditional two-dimensional technology.

There is a need for a system that employs computer technologies to create a three-dimensional environment of sequence stratigraphic interpretation workflows.

There is a further need for a method and system that provides drilling and production businesses having limited capital and human resources face the ability to upgrade their interpretation technology and speed to gain a competitive edge.

There is yet the need for a geological interpretation process and supporting system that enable real-time updates and interactive three-dimensional geological interpretation environment optimized for sequence stratigraphic interpretation.

### SUMMARY

Techniques here disclosed include a geological interpretation method and system that replaces known two-dimensional process with an integrated, three-dimensional geological interpretation environment. The disclosed subject matter combines seismic and well-log data into an interactive three-dimensional geological interpretation environment. The disclosed geological interpretation system focuses on interpretation speed, ease of use, and improved accuracy. In essence, the presently disclosed subject matter allows a user to perform geology on a computer workstation to a degree not previously possible.

According to one aspect of the disclosed subject matter, there is provided a method and system for performing geological interpretation operations in support of energy resources exploration and production. The disclosed method and system perform well log correlation operations for generating a set of graphical data that describes the predetermined geological region. The process and system interpret the geological environment of the predetermined geological region from measured surface and fault data associated with the predetermined geological region. The method and system allow the user to query and filter graphical data representing the predetermined geological region, the method and system present manipulable three-dimensional geological interpretations of two-dimensional geological data relating to the predetermined geological region and provide displays of base map features associated with the predetermined geological region. The method and system automatically update the manipulable three-dimensional geological interpretations of two-dimensional data relating to the predetermined geological region, as well as create three-dimensional well log and seismic interpretations of geological data relating to the predetermined geological region. Moreover, time-related visualizations of production volumes relating to the predetermined geological region are provided for enhancing the ability to interpret and model various geological properties of various geological regions.

The present disclosure further provides a geological scenario manager for managing uncertainties and allowing a user to easily perform a risk analysis of multiple 3-D geologic interpretations and models. The geological scenario manager of the present disclosure enables interpretation version control of edits to interpretation objects. Using the teachings of the present disclosure project data created during an entire project lifetime may be tracked. Further, the tracked interpretation objects of the present disclosure do not need to be duplicated for multiple sessions or scenarios. The geological scenario manager allows quantitative and qualitative analysis of multiple interpretations of input data to help a user resolve uncertainties associated with multiple equiprobable 3-D geologic interpretations and models. Further, the geological scenario manager provides a data tracking feature, enabling users to track and record some or all edits to interpretation objects

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features, and advantages here provided will become apparent to one with skill in the art upon examination of the following FIGUREs and detailed description. It is intended that all such additional systems, methods, features and advantages be included within this description, be within the scope of the accompanying claims.

### BRIEF DESCRIPTIONS OF THE DRAWINGS

The patent or application file contains at least one drawing executed in color. Copies of this patent or patent application publication with color drawing(s) will be provided by the Office upon request and payment of the necessary fee.

The features, nature, and advantages of the disclosed subject matter will become more apparent from the detailed description set forth below when taken in conjunction with the drawings in which like reference characters identify correspondingly throughout and wherein:

FIGS. 1 and 2 an exemplary system for employing the novel aspects of the presently disclosed multi-dimensional geological interpretation method and system;

FIG. 3 shows selected aspects of the three-dimensional interpretation environment cascade technology as here disclosed;

FIGS. 4 and 5 presents various displays and interpretation functions provided by the disclosed subject matter;

FIG. 6 provides a diagram representing the automatic cascading updating process as presently disclosed;

FIGS. 7 through 11 show in further detail the various aspects of the automatic cascading updating process as presently disclosed;

FIG. 12 portrays one embodiment of a geological interpretation as a single workflow application according to the present disclosure;

FIG. 13 depicts aspects of geological interpretation using a three-window communication and workflow user interface;

FIG. 14 shows the disclosed functions of immediately updating all interpretational changes in all views of the present geological interpretation system;

FIG. 15 shows how the present system communicates data with a plurality of third-party geological data management systems;

FIG. 16 through 19 exhibit integrating stratigraphic erosional rules into the present geological interpretation system;

FIG. 20 through 22 show importing log curve data into the present geological interpretation system;

FIGS. 23 and 24 importing three-dimensional seismic data into the present geological interpretation system;

FIGS. 25 and 26 display importing deviated and horizontal well data into the present geological interpretation system;

FIGS. 27 through 30 depict an instance of importing well header data into the present geological interpretation system;

FIGS. 31 and 32 show importing interval data into the present geological interpretation system;

FIGS. 32 and 34 present views of importing pointset data into the present geological interpretation system;

FIG. 35 shows exporting grid and map data from the present geological interpretation system;

FIGS. 36 and 37 depict graphical data querying and filtering in association with manipulation of the present geological interpretation system;

FIG. 38 shows adding three-dimensional editable pick representations in association with manipulation of the present geological interpretation system;

FIGS. 39 and 40 provide views of interwell pick interpretation in association with manipulation of the present geological interpretation system;

FIGS. 41 and 42 exhibit forming cross-sectional definitions in association with manipulation of the present geological interpretation system;

FIG. 43 shows forming correlation representations of the predetermined geological region from the present geological interpretation system;

FIGS. 44 and 45 present performing three-dimensional thickness calculations in association with manipulation of the present geological interpretation system;

FIGS. 46 and 47 show displays from the group consisting essentially of structure maps, isochore maps, and well log zone average maps in association with manipulation of the present geological interpretation system;

FIGS. 48 and 49 display seismic slices of the predetermined geological region;

FIGS. 50 and 51 show how the manipulating net-to-gross maps may occur based on well log cutoffs or calculated log curves for the predetermined geological region in association with manipulation of the present geological interpretation system;

FIG. 52 present performing surface modeling of the predetermined geological region in association with manipulation of the present geological interpretation system;

FIGS. 53 through 55 show forming isochore visualizations of the predetermined geological region from the present geological interpretation system, including isochores from structural horizons in addition to isochores calculated from pointsets;

FIGS. 56 and 57 show forming well log zone average visualizations of the predetermined geological region from the present geological interpretation system, including isochores from structural horizons in addition to zone averages calculated from pointsets;

FIGS. 58 and 59 exhibit functions of performing one-step conformable mapping operations for the predetermined geological region from the present geological interpretation system;

FIG. 60 shows performing a one-step seismic tie to log pick operations on the predetermined geological region from the present geological interpretation system;

FIG. 61 presents how the present system executes a set of instructions for tieing fault surfaces to fault-picks in selected wells of the predetermined geological region from the present geological interpretation system;

FIGS. 62 and 63 present how the present system executes a set of instructions for performing recursive conformable mapping operations between multiple horizons of the predetermined geological region using the present geological interpretation system;

FIG. 64 displays draping external grid values onto three-dimensional structure maps of the predetermined geological region from the present geological interpretation system;

FIG. 65 shows a display for forming three-dimensional dip/azimuth pick displays for picks measured on the predetermined geological region using the present geological interpretation system;

FIGS. 66 and 67 relate to performing surface modeling operations using three-dimensional dip/azimuth pick information of the predetermined geological region using the present geological interpretation system;

FIGS. 68 and 69 relate to performing interactive three-dimensional datuming of seismic cross-sections and slices of the predetermined geological region from the present geological interpretation system;

FIGS. 70 and 71 relate to forming three-dimensional visualizations of cross-sections for wells of the predetermined geological region from the present geological interpretation system;

FIG. 72 display views of forming three-dimensional visualizations of cross-sections for wells of the predetermined geological region from the present geological interpretation system;

FIG. 73 show performing interactive seismic opacity filtering for a plurality of views of the predetermined geological region;

FIGS. 74 through 76 exhibit forming stratigraphic slicing of three-dimensional seismic volumetric interpretations of the predetermined geological region;

FIG. 77 depicts forming color-filled three-dimensional contours of the predetermined geological region from the present geological interpretation system;

FIGS. 78 and 79 illustrate performing interactive filtering of three-dimensional structure and zone average maps of the predetermined geological region from the present geological interpretation system;

FIG. 80 shows generating substitute curves for missing log curve data from the predetermined geological region;

FIGS. 81 through 83 display how the present system and process function in integrating time-stamped production and completion intervals;

FIGS. 84 through 86 illustrate how the present system presents in multi-dimensional images changes in energy resource injection volumes over time;

FIG. 87 illustrates the indexing feature of the geological scenario manager of the present disclosure.

FIG. 88 provides a view enabling the user to perform a risk analysis of multiple equiprobable 3-D interpretations and models;

FIG. 89A through 89C show some of the basic session, scenario, and branching features of the present disclosure;

FIG. 90 provides a view of additional features of the present disclosure;

FIG. 91 shows a view for conflict resolution;

FIGS. 92A and 92B provide user interfaces for the partial comparison feature of the present disclosure;

FIGS. 93A, 93B, and 93C illustrate the interpretation object tracker or audit trail features of the present disclosure;

FIG. 94 discloses additional features of the present disclosure;

FIGS. 95 and 96 show user interfaces enabling the filtering features of the present disclosure; and

FIG. 97 shows a software architecture for enabling the geologic scenario manager of the present disclosure.

### DETAILED DESCRIPTION OF THE SPECIFIC EMBODIMENTS

The disclosed geological interpretation system delivers three-dimensional geological interpretation performance with true three-dimensional subsurface solutions, fast interpretation updates, and integration with the Landmark Graphics OpenWorks® and SeisWorks® systems. The effect on user workflow speed and approach is dramatic and translates into higher quality interpretations, lower risk, and improved success.

The disclosed process and system provide high quality interpretation of geological data. A real-time three-dimensional interpretation environment is characterized by the fact that all changes to the interpretation are immediately updated in the three-dimensional, cross-sectional, and base map views. By dramatically speeding the geological interpretation workflow, geoscientists are able to save time, which is used to improve on the quality of the interpretation, effectively lowering finding and development costs.

Using the disclosed geological interpretation system's unique real-time three-dimensional interpretation environment, interpretation changes are made instantaneously. The disclosed system addresses the shortcomings of three-dimensional modeling tools by transferring many of its functions into real-time three-dimensional geological interpretation environment. This eliminates the need for the user to continuously generate multiple three-dimensional models to account for changes to user interpretation. Geoscientists using the disclosed system no longer face the need to master multiple applications in order to complete a geological interpretation workflow. Any changes to the interpretation are immediately updated in three-dimensional, cross-section, and base map views. The disclosed geological interpretation system combines the functionality of these applications into a single three-dimensional interpretation environment, thus reducing the learning curve and increasing the geoscientist's interpretation productivity.

The disclosed geological interpretation system may be designed from the ground up to leverage user existing data management environments such as Landmark® and GeoQuest®. For example, the disclosed system reads and writes data directly to and from the Landmark Graphics OpenWorks® database and accesses three-dimensional seismic directly from the Landmark Graphics SeisWorks® three-dimensional seismic data files. In addition, the disclosed system easily links to best-of-class third-party applications.

The disclosed system includes a process and system for ensuring that any changes to user interpretation are immediately updated in user three-dimensional, cross-section, and base map views. An underlying three-dimensional foundation enables it to solve complex geological interpretation problems that cannot be resolved using software that relies on traditional two-dimensional principles.

The disclosed geological interpretation system's improved geological interpretations lead to more accurate three-dimensional models and reservoir simulations. Accurate models lead to risk reduction and to better business decisions. The disclosed geological interpretation system combines the functionality of multiple applications into a single three-dimensional interpretation environment, thus reducing the learning curve and increases user interpretation productivity. The system employs an interactive three-dimensional spatial environment to maintain unparalleled data quality control by being able to display thousands of well logs together with seismic and production data in three-dimensions.

By dramatically speeding up user geological interpretation workflows using the disclosed system, the user may apply the timesavings to improving the quality of user interpretation, thus lowering user exploration and development costs. The disclosed system's is uniquely equipped to manage the crucial task of data quality analysis and cleanup. By being able to display thousands of wells, together with seismic and production data in three-dimensions, all issues related to data quality may for the first time be addressed in an interactive three-dimensional spatial environment, enabling the user to maintain control over user data.

For example, different stacking patterns (e.g., progradational versus retrogradational, or aggradational) and different geometries (e.g., dip versus strike-orientation) may be composed of completely different facies.

The ability to display core and petrophysical information simultaneously within the well log template, as the disclosed system makes possible, helps interpreters select turn-around points quickly and accurately. Furthermore, in a dynamic interpretation environment, such as here provided, surfaces may be quickly added, deleted, changed, and renamed. This flexibility allows interpreters to select a visualization method that enhances pattern recognition, thereby enhancing their ability to interpret progradational, retrogradational or aggradational stacking patterns in individual wells and develop a stronger correlation framework.

The disclosed geological interpretation technology permits interpreters to correlate in two dimensions or three-dimensions, and to immediately visualize the results in both two- and three-dimensions. Furthermore, interpreters may work with an unlimited number of well logs. By using the sequence stratigraphic methodology, stratigraphic units may be mapped at all scales at the click of a button. Thus, interpreters may quickly display maps in two- and three-dimensions of parasequences, systems tracts, sequences, and composite sequences.

The disclosed interpretation system saves substantial amounts of time by identifying and resolving problems that are traditionally found during the three-dimensional modeling workflow following the geological interpretation phase. This reduces the modeling costs by high grading the geological interpretation. The disclosed system combines and modifies seismic horizons with picks, and allows for the integration of time-stamped production interval data.

The disclosed system calculates log attributes using a free-form equation calculator and maps log attributes in two dimensional and three-dimensional space. The disclosed system allows for multiple correlation framework scenarios to be interactively defined (e.g., to observe the consequences of the inclusion of inter-reservoir shales or high-permeability zones upon transition to the reservoir simulator).

One of the drawbacks of traditional three-dimensional modeling programs is their inadequacy in visualizing well log data in three-dimensions. The disclosed geological interpretation system's ability to visualize large quantities of well log curves in three-dimensions makes it immediately valuable in quality control and data management phases of a reservoir characterization project. Many problems that usually only surface in the petrophysical, three-dimensional modeling, and reservoir simulation stages may now be identified much sooner, thus resulting in significant data management cost-savings.

Raw log curves visualized in three-dimensions immediately highlight problems with normalization of log curves. When investigating curves in two dimensional log visualization software, it is difficult to get a feel for the true spatial variations of the log curves. Differences between measurement errors and geological variation may readily be resolved by investigating the log curves in three-dimensions.

The disclosed system provides interactive zone averaging for identifying and resolving correlation mis-ties, and optimizing log correlations. Various gridding algorithms provided with the present system permit structural, thickness, and zone average mapping and surface modeling. Also, one or more minimum curvature algorithms are optimized for speed as well as traditional search radius based algorithms that closely resembles prior art algorithms.

The disclosed geological interpretation system's next-generation gridding algorithms are optimized to ensure a quick response to changes in the interpretation. The speed of the algorithms allows for a smooth workflow emphasizing true dynamic interpretation. This new design principle has led to the prevention of time-consuming workflow obstacles (e.g., application switching) which are still hampering traditional log correlation and mapping applications.

The disclosed geological interpretation system's open data architecture has been designed to directly interface with industry-standard, third-party data management solutions such as Landmark's OpenWorks®. Links between the disclosed system and other best-of-class software products in the exploration and production industry, permit integrating with third-party applications to ensure a smooth workflow in today's multi-vendor application environment.

The disclosed system has a unique ability to generate scaled hardcopy plots directly from its three-dimensional displays. Hardcopy plots may be generated from all three of the disclosed system views: three-dimensional, two dimensional cross-section, and base map view. In the three-dimensional view the two dimensional plots are obtained by sorting the three-dimensional polygons in the three-dimensional view into a single two-dimensional plane after which the display may be output as a standard CGM or Postscript scaled hardcopy file. These files may be scaled to any size while honoring the native resolution of the hardcopy device.

The disclosed system allows the user to change user interpretation in three-dimensions, whereas other programs only allow a user to visualize it in three-dimensions, and require the user to return to two dimensional point products or modules to perform user interpretation tasks.

Although not a three-dimensional modeling tool, the presently disclosed system operates synergistically with Landmark's Stratamodel® and Powermodel®, Paradigm/EDS's GoCAD®, Roxar's RMS®, or SIS Petrel®. The system may be positioned in front of the three-dimensional modeling workflow and complements these products by allowing geoscientists to quickly change and update their interpretations during a three-dimensional modeling phase.

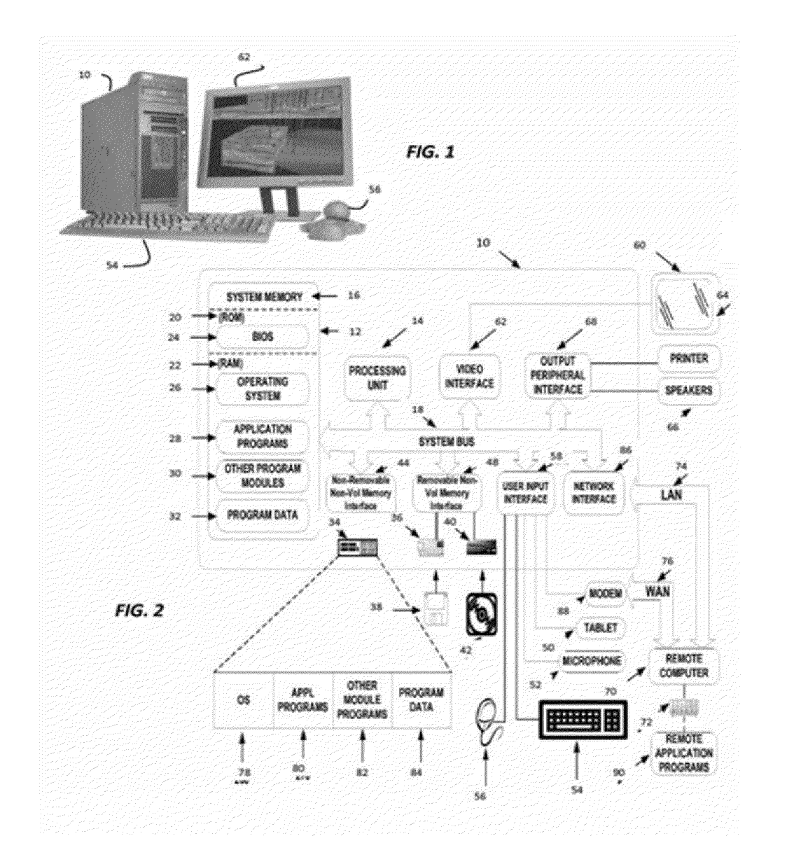

Operating in association with tools like Paradigm's Geolog® or Landmark's PetroWorks®. Working in conjunction with these products, the disclosed system provides three-dimensional log visualization and free-form well log calculator features aids in improving the petrophysical analysis workflow. FIGS. 1 and 2 an exemplary system within a computing environment for implementing the system of the present disclosure and which includes a general purpose computing device in the form of a computing system 10, commercially available from Intel, IBM, AMD, Motorola, Cyrix and others. Components of the computing system 10 may include, but are not limited to, a processing unit 14, a system memory 16, and a system bus 46 that couples various system components including the system memory to the processing unit 14. The system bus 46 may be any of several types of bus structures including a memory bus or memory controller, a peripheral bus, and a local bus using any of a variety of bus architectures.

Computing system 10 typically includes a variety of computer readable media. Computer readable media may be any available media that may be accessed by the computing system 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computing system 10.

The system memory 16 includes computer storage media in the form of volatile and/or nonvolatile memory such as read only memory (ROM) 20 and random access memory (RAM) 22. A basic input/output system 24 (BIOS), containing the basic routines that help to transfer information between elements within computing system 10, such as during start-up, is typically stored in ROM 20. RAM 22 typically contains data and/or program modules that are immediately accessible to and/or presently being operated on by processing unit 14. By way of example, and not limitation, FIG. 1 illustrates operating system 26, application programs 30, other program modules 30 and program data 32.

Computing system 10 may also include other removable/non-removable, volatile/nonvolatile computer storage media. By way of example only, FIG. 4 illustrates a hard disk drive 34 that reads from or writes to non-removable, nonvolatile magnetic media, a magnetic disk drive 36 that reads from or writes to a removable, nonvolatile magnetic disk 38, and an optical disk drive 40 that reads from or writes to a removable, nonvolatile optical disk 42 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 34 is typically connected to the system bus 46 through a non-removable memory interface such as interface 44, and magnetic disk drive 36 and optical disk drive 40 are typically connected to the system bus 46 by a removable memory interface, such as interface 48.

The drives and their associated computer storage media, discussed above and illustrated in FIG. 1, provide storage of computer readable instructions, data structures, program modules and other data for the computing system 10. In FIG. 1, for example, hard disk drive 34 is illustrated as storing operating system 78, application programs 80, other program modules 82 and program data 84. Note that these components may either be the same as or different from operating system 26, application programs 30, other program modules 30, and program data 32. Operating system 78, application programs 80, other program modules 82, and program data 84 are given different numbers hereto illustrates that, at a minimum, they are different copies.

A user may enter commands and information into the computing system 10 through input devices such as a tablet, or electronic digitizer, 50, a microphone 52, a keyboard 54, and pointing device 56, commonly referred to as a mouse, trackball, or touch pad. These and other input devices are often connected to the processing unit 14 through a user input interface 58 that is coupled to the system bus 18, but may be connected by other interface and bus structures, such as a parallel port, game port or a universal serial bus (USB).

A monitor 60 or other type of display device is also connected to the system bus 18 via an interface, such as a video interface 62. The monitor 60 may also be integrated with a touch-screen panel or the like. Note that the monitor and/or touch screen panel may be physically coupled to a housing in which the computing system 10 is incorporated, such as in a tablet-type personal computer. In addition, computers such as the computing system 10 may also include other peripheral output devices such as speakers 64 and printer 66, which may be connected through an output peripheral interface 68 or the like.

Computing system 10 may operate in a networked environment using logical connections to one or more remote computers, such as a remote computing system 70. The remote computing system 70 may be a personal computer, a server, a router, a network PC, a peer device or other common network node, and typically includes many or all of the elements described above relative to the computing system 10, although only a memory storage device 72 has been illustrated in FIG. 1. The logical connections depicted in FIG. 1 include a local area network (LAN) 74 connecting through network interface 86 and a wide area network (WAN) 76 connecting via modem 88, but may also include other networks. Such networking environments are commonplace in offices, enterprise-wide computer networks, intranets and the Internet.

For example, in the present embodiment, the computer system 10 may comprise the source machine from which data is being migrated, and the remote computing system 70 may comprise the destination machine. Note however that source and destination machines need not be connected by a network or any other means, but instead, data may be migrated via any media capable of being written by the source platform and read by the destination platform or platforms.

The central processor operating system or systems may reside at a central location or distributed locations (i.e., mirrored or stand-alone). Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor may read information from, and write information to, the storage medium. In the alternative, the storage medium may be integral to the processor. The processor and the storage medium may also reside in an ASIC. The bus may be an optical or conventional bus operating pursuant to various protocols that are well known in the art. A recommended system may include a Linux workstation configuration with a Linux 64-bit or 32-bit Red Hat Linux WS3 operating system, and an NVIDIA Quadro graphics card. However, the disclosed system may operate on a wide variety of Linux PC hardware, ranging from custom-built desktops to leading laptop vendors.

The present system may display an unlimited number of wells, logs, picks and grids in two dimensional correlation view. The system provides speed-optimized, interactive well correlation and interpretation with instant update of picks, grids and profiles in all views. The system allows a user to add, edit or delete tops and fault picks in all windows, including three-dimensions. Fast interwell pick interpretations with instant update of grids empower the user to define well-to-well and/or arbitrary cross-sections in two dimensional and three-dimensional. Fixed spacing correlation views and interactive switching between XYZ and fixed spacing views in two dimensional, as well as measured depth-based, fixed spacing correlation modes are provided. The user may move or generate new pick with “ghost curves” using any combination of curves in two dimensional.

The present disclosure allows the user to datum an entire data volume (including seismic and wells with and without datum top pick) in two dimensions and/or three-dimensions, display deviated and horizontal well templates in three-dimensions, as well as deviated wells with logs projected into the line of section. The present system provides true XYZ space two dimensional cross-section displays, and well-to-well and pick-based distance measurements. Additional features include interactive changes of line-of-section and associated wells with automatic recalculation of well projections, display independent curve fills in well template (e.g., lithology, fluid type).

The present disclosure provides posting the base map at base of three-dimensional box display. Interactive, graphical AOI redefinition with immediate two dimensional and three-dimensional update, together with net-to-gross maps based on well log cutoffs or calculated log curves. Speed-optimized three-dimensional minimum curvature and search radius mapping algorithms for horizons, faults, isochores and zone average maps.

The disclosed system Cascade Technology™: automatic update of all structures, isochores, and zone average maps in all views upon interpretation changes. Isochores from structural horizons in addition to calculated isochore pointsets. three-dimensional display of structure maps, isochores, and zone average maps. One-step conformable mapping one-step seismic tie to log picks. Tie fault surfaces to fault-picks in wells. Recursive conformable mapping between multiple horizons.

Display unlimited number of wells, logs, picks and grids in three-dimensional view. three-dimensional dip/azimuth pick display. Multiple three-dimensional pick marker types. Interactive three-dimensional visualization and editing of structural surfaces, isochores, and zone average maps. Immediate update of three-dimensional cross-section profiles. Interactive three-dimensional datuming of well logs, cross-sections and horizons. Interactive vertical and lateral scaling in three-dimensions. Interactive three-dimensional datuming of seismic cross-sections and slices. Interwell interpretation on cross section (including seismic backdrop). Three-dimensional and two dimensional seismic visualization of well-to-well cross-sections.

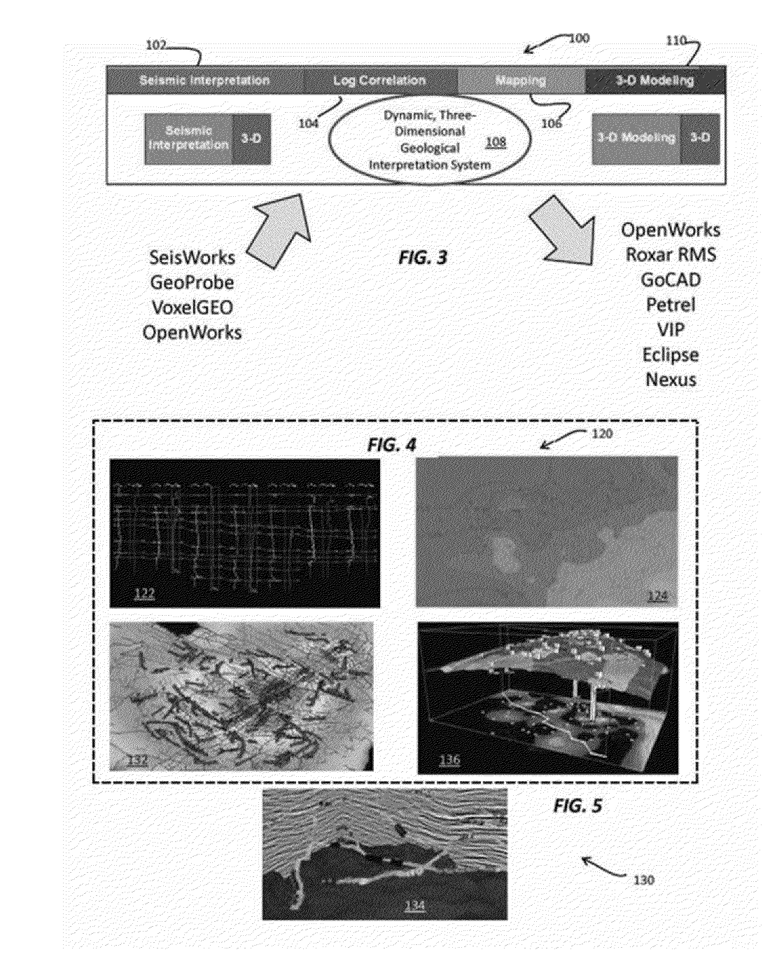

FIG. 2 depicts a three-window communication and workflow design process of the disclosed subject matter. FIG. 3 shows selected aspects of the three-dimensional interpretation environment for the disclosed method and system. In particular, geological interpretation environment 100 forms a process environment that augments and empowers a variety of pre-existing geological visualization and modeling systems. For example, in a seismic interpretation environment 102, a variety of applications provide the ability to interpret seismic data, some providing three-dimensional visualizations of seismic information. Such applications may include SeisWorks®, GeoProbe®, VoxelGEO®, and OpenWorks®, here disclosed. With data from such applications, the geological interpretation environment of the present disclosure operates in conjunction with log correlation functions 104 and mapping applications 106 to establish a dynamic three-dimensional geological interpretation set of functions 108.

In contrast to the known two-dimensional static, and extensively laborious, processes of extracting data and using from the various seismic interpretation programs, the disclosed system provides an interactive, dynamic, and automatic platform for three-dimensional geological interpretation. As a result of the information, knowledge, and intelligence that the disclosed system provides, further interface with three-dimensional modeling and other software systems 110 becomes increasing facile. Such programs may include the already-mentioned OpenWorks®, as well as other modeling systems, such as Roxar RMS®, Paradigm/EDS GoCAD®,SIS Petrel®, Landmark VIP®, SIS Eclipse®, and/or Landmark Nexus®, as well as other similarly capable programs and systems.

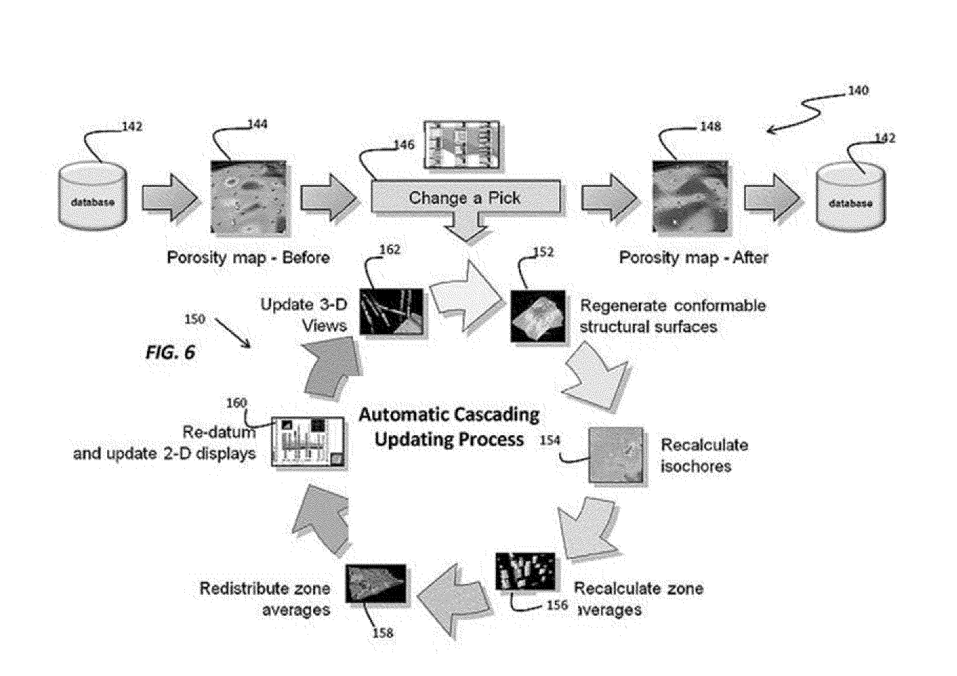

FIGS. 4 and 5 yet further distinguish the result of the presently disclosed system from known programs. For instance, in FIG. 4 appear examples 120 conventional two-dimensional displays of geological interpretation results. One such result includes display 122 of picks interpreted on well log curves in a cross-section view. In such display, three-dimensional views are not available. In addition to well log data display, some known systems provide two-dimensional maps 124 of geological interpretations. Unfortunately, however, such systems provide a manually and laboriously controlled interface. Such interfaces show static displays which do not interactively respond to changes in pick locations or otherwise respond to dynamic queries that a user may desire.

FIG. 5, in contrast, shows examples of displays 130 and functions of the significantly more robust three-dimensional system of the present disclosure. For instance, such displays may include three-dimensional gamma ray well log overlay displays 132, combinations of seismic, horizontal wells and production interval data 134, and various stratigraphic overlays 136, as well as other dynamic displays and configurations as herein disclosed and described.

FIG. 6 shows important novel aspects of the presently dynamic, three-dimensional system 108, here referred to as cascading process 140. In the operation of geological interpretation system 140, a database 108 may be accessed to provide interpretation data 144 and other data describing the location and various related sets of information relating to a geological region. A valuable and novel aspect of the disclosed subject matter includes the ability to change a pick, as shown in step 144, and, in response to the changed pick, instantaneously produce a new porosity map 146 for the geological region. Afterwards, the new porosity map 146 may be stored in the same or a different database 148 for use in various applications.

FIG. 6 further shows the instantaneously update sub-process 150 of cascading process 140. Update process 150 begins at step 152 wherein a regeneration of the conformable structural surfaces occurs. Next, isochore recalculation occurs at step 154, followed by recalculation of zone averages at step 156. Step 158 shows the step of redistributing zone averages, and step 160 portrays the step of re-datuming and updating two-dimensional displays. Finally, at step 162, update process 150 updates the various three-dimensional views of system 108.

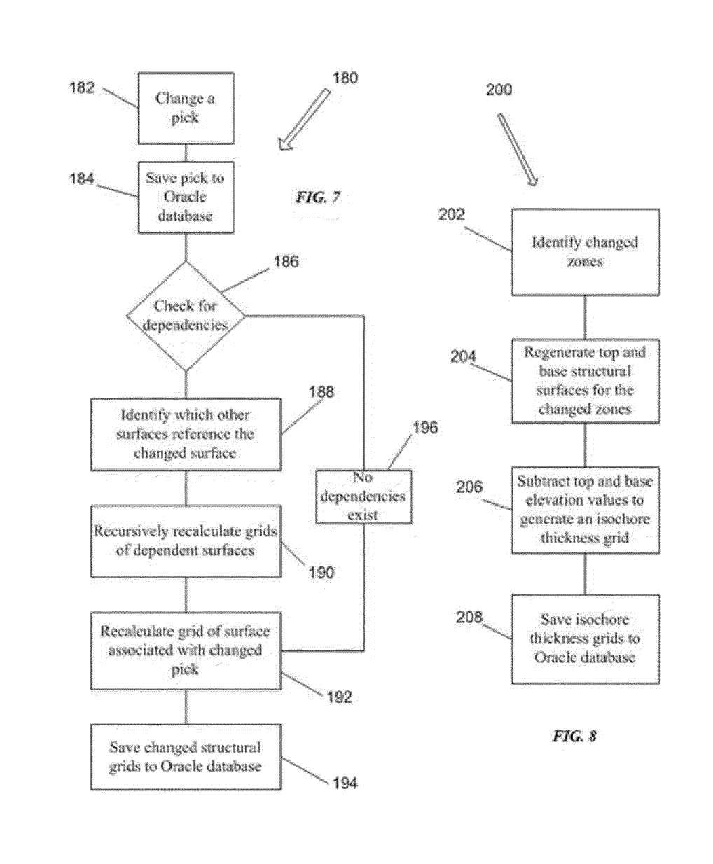

FIGS. 7 through 11 depict functional process diagrams for the steps of instantaneous update sub-process 150, as described above in FIG. 6. In particular, FIG. 7 describes the regeneration process 180 of the present embodiment for generating conformable structural surfaces following a pick change and which corresponds to step 152 of sub-process 150. Regeneration process 180 begins at step 182, wherein a user selects to change a pick. In response to the change, regeneration process 180 saves the pick to a database 142, such as an Oracle database, at step 184. At step 186, regeneration process 180 checks for dependencies. If there are dependencies, then, at step 188, regeneration process 180 identifies which other surfaces reference the changed surface. At step 190, regeneration process 180 recursively recalculates grids of dependent surfaces and at step 192 recalculates a grid of the surface associated with the changed pick. Also, if, at query 186, the determination was made of their being no dependencies, regeneration process 180 also progresses to step 192. Finally, at step 194, the changed structural grids are saved to the database 142

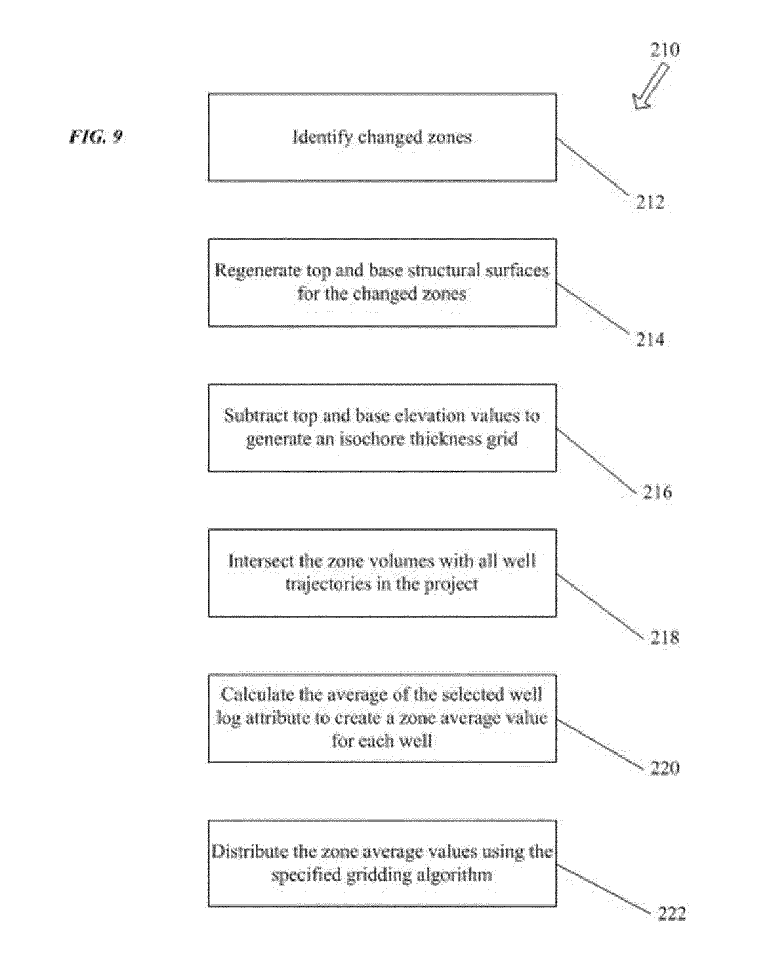

FIG. 8 depicts isochore recalculation process 200 of the present disclosure for regenerating isochores as corresponding to step 154 of sub-process 150. In particular, following regeneration process 180, isochore recalculation process 200 begins at step 202 for identifying changed zones. At step 204, recalculation process 200 regenerates top and base structural surfaces for the changed zones. Then, at step 206, recalculation process 200 subtracts top and base elevation values to generate an isochore thickness grid. Step 208 includes saving the isochore thickness grids to a database 142 and allows sub-process 150 to advance to step 156 wherein zone averages are recalculated.

FIG. 9 illustrates flow diagram 210 corresponding to step 156 wherein sub-process 150 recalculates zone averages. Beginning at step 212, zone averaging process 210 identifies changed zones and then regenerates top and base structural surfaces for the changed zones at step 214. Zone averaging process 210 then subtracts top and base elevation values to generate an isochore thickness grid at step 216. At step 218, zone averaging process 210 intersects the zone volumes with all well trajectories in the project. Then, zone averaging process 210 continues, at step 220, to calculate the average of the selected well log attribute to create a zone average value for each well. At step 222, the process 210 distributes the zone average values using a pre-specified specified gridding algorithm and sub-process 150 flow continues to step 158, wherein the redistribution of zone averages occurs.

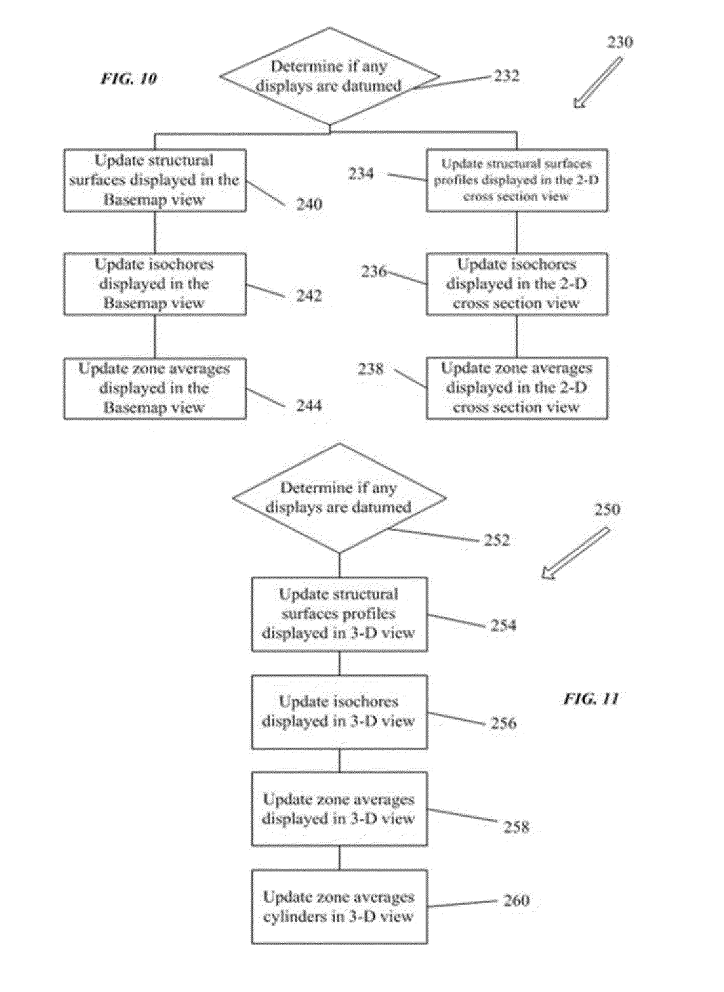

FIG. 10 exhibits re-datuming process 230 for further aspects of the cascade sub-process 150 including the step 158 of re-datuming and updating two-dimensional displays. Re-datuming process 230 begins at query 232 wherein the test of whether any displays are datumed occurs. If not, re-datuming process 230 terminates. Otherwise, process 230 proceeds to step 234 at which the step of updating structural surface profiles are displayed in the two-dimensional cross section view. Step 236 then follows whereupon updated isochores are displayed in the two-dimensional cross section view. Then, at step 238, the updated zone averages are displayed in the two-dimensional cross section view.

Re-datuming process 230 also includes step 240 for updating structural surfaces that are displayed in the basemap views, as well as step 242 for updating isochores displayed in the basemap view. Finally, re-datuming process 230 includes the step of updating zone averages in the basemap view. Then, the cascading sub-process 150 proceeds to step 162, wherein the three-dimensional views are updated.

FIG. 11 depicts three-dimensional updating process 250 of cascading sub-process 150. Three-dimensional updating process 250 begins at query 252 for the determination of whether there are any displays datumed. If not, updating process 250 terminates. If so, updating process 250 continues to step 254 wherein updating of structural surface profiles displayed in three-dimensional views occurs. At step 256, updated isochores are displayed in three-dimensional views. Step 258 represents the step of displaying updated zone average in three-dimensional views, and step 260 finally represents updating zone averages cylinders in three-dimensional views. Following updating process 250, as already mentioned, cascading sub-process 150 is complete at step 162 and a new porosity map 148 is displayed to the user.

Having described the essentially functionality of the cascading sub-process 150 for the presently disclosed system 108, what follows are elucidations of the capabilities here disclosed. To provide such descriptions, this disclosure presents a library of visualizations that the present method and system present to the user.

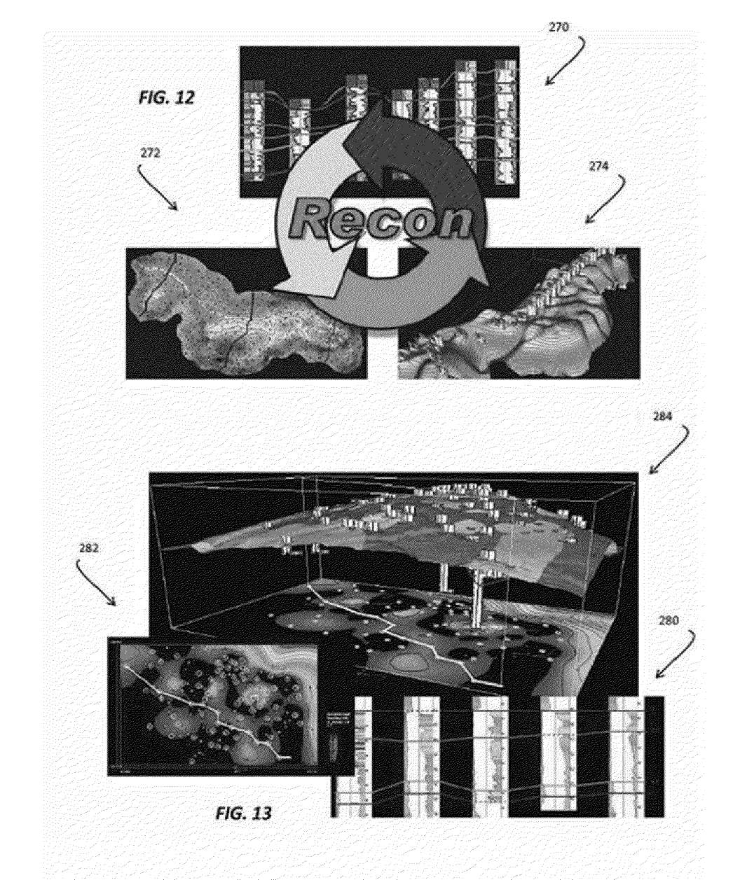

Because of the rich set of visualizations and interpretations here presented, the user clearly has the ability to perform geological interpretations and related analyses at the computer workstation. FIGS. 12 through 86 here described in more detail make such geological interpretations and analyses practical. Thus, what follows are a listing of the many screens available to a user.

FIG. 12 portrays geological interpretation as a single workflow application according to the present disclosure. The presently disclosed manipulable three-dimensional system, for example, allows the user to interpret in screen 270, which represents various pick sets with two-dimensional geological representations, and see the contents of screen 272 displays updated immediately. The results will also be updated in screen 274 which includes vivid multi-colored, 3-D contour maps of the subject geological region. The same results occur when interpreting in screen 272 or screen 274; the other windows will be automatically updated.

FIG. 13, likewise, depicts aspects of geological interpretation using a three-window communication and workflow user interface. In FIG. 13, pick data screen 280 presents to the user information that may be integrated with two-dimensional geological map information and image 282. The result becomes three-dimensional visualization 284. A key advantage of the present disclosure includes the ability to dynamically generate three-dimensional interpretation visualizations 284 in real-time.

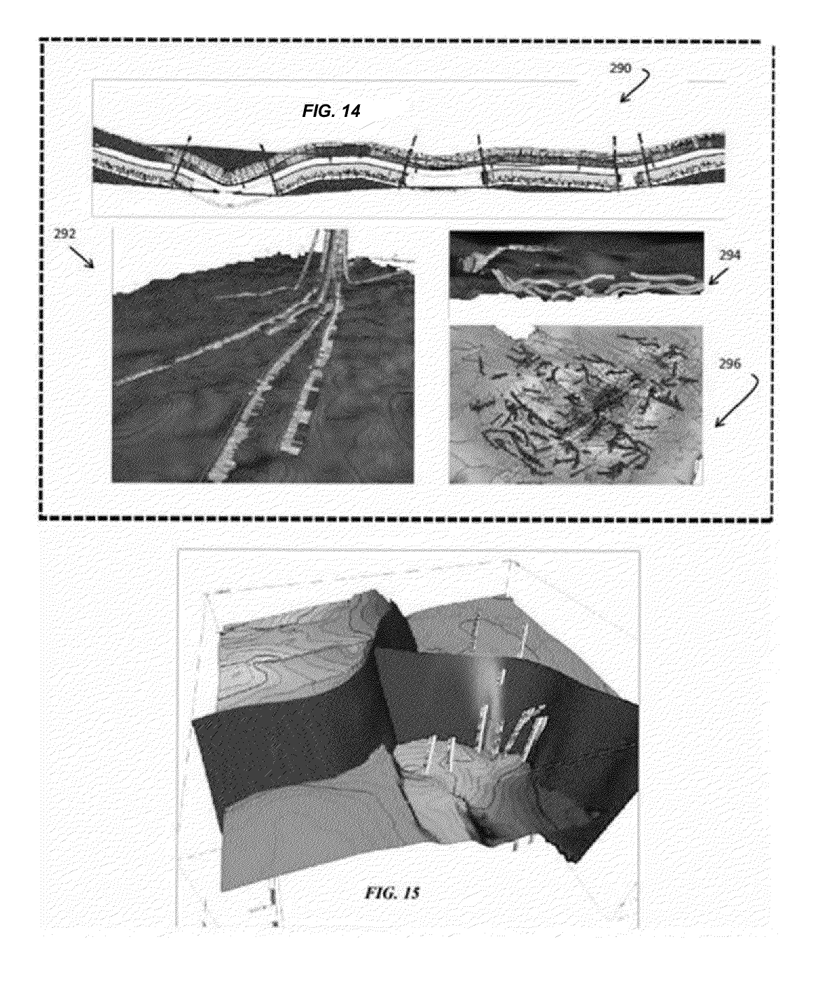

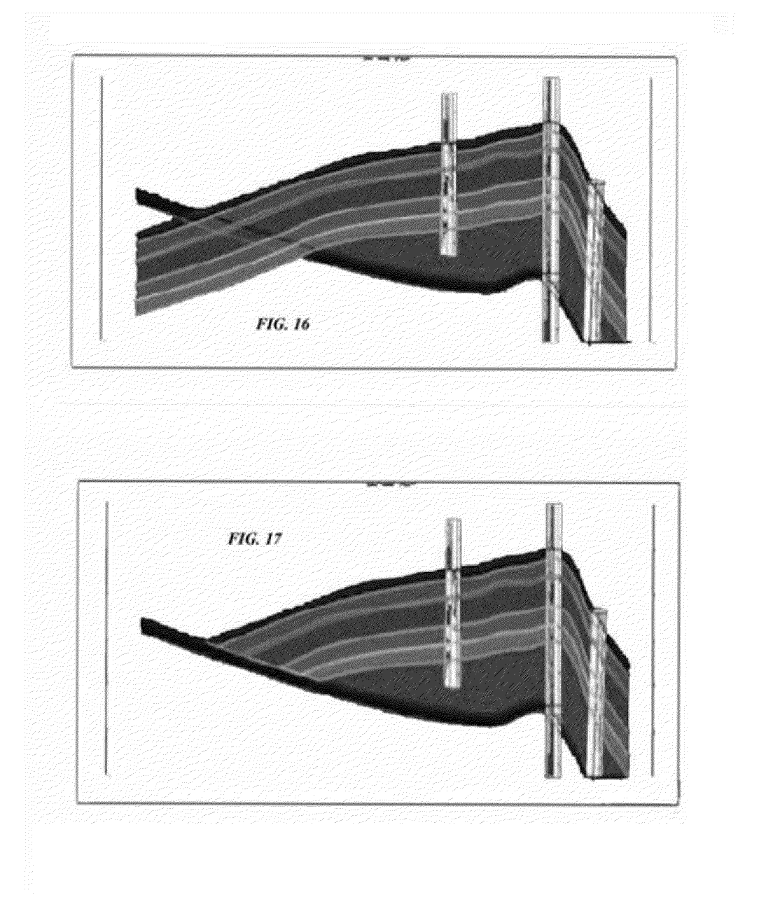

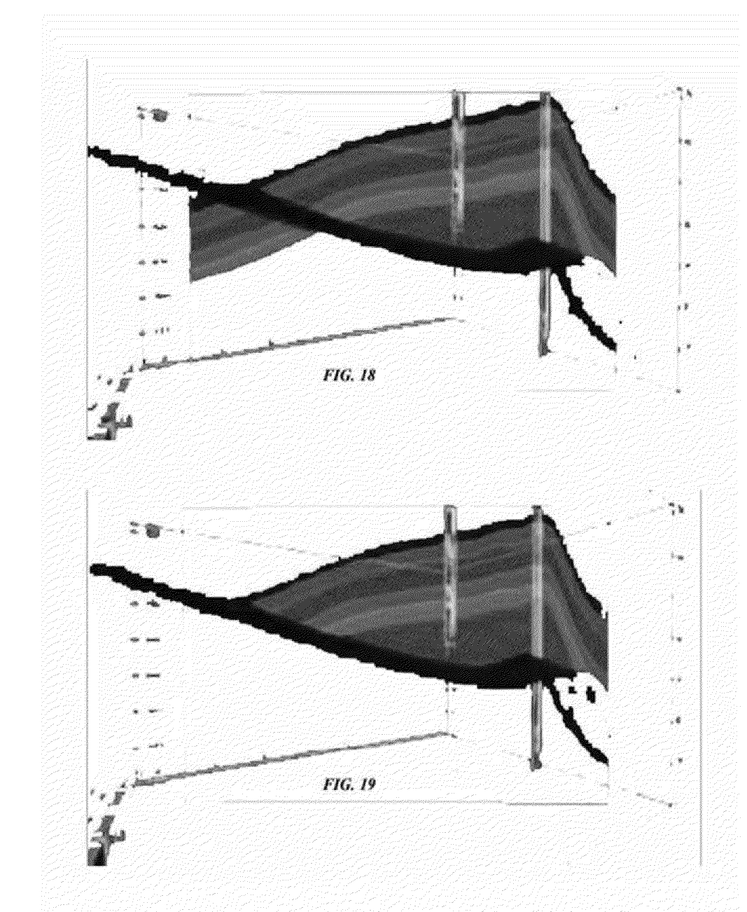

FIG. 14 shows the disclosed functions of immediately updating all interpretational changes in all views of the present geological interpretation system. Thus, with a change in screen shot 290 relating to pick data, the presently disclosed system will automatically update screen shots 292, for showing in three dimensions the new pick or pick data, as well as cross-section screen shot 294 and base map view screen shot 296. FIG. 15 shows how the present system communicates data with a plurality of third-party geological data management systems. FIGS. 16 through 19 exhibit integrating stratigraphic erosional rules into the present geological interpretation system.

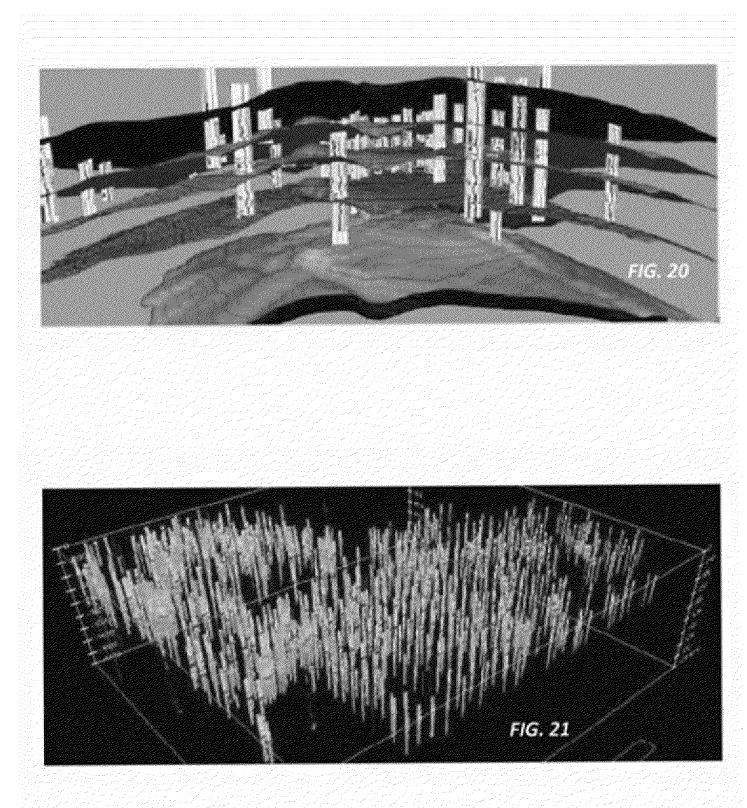

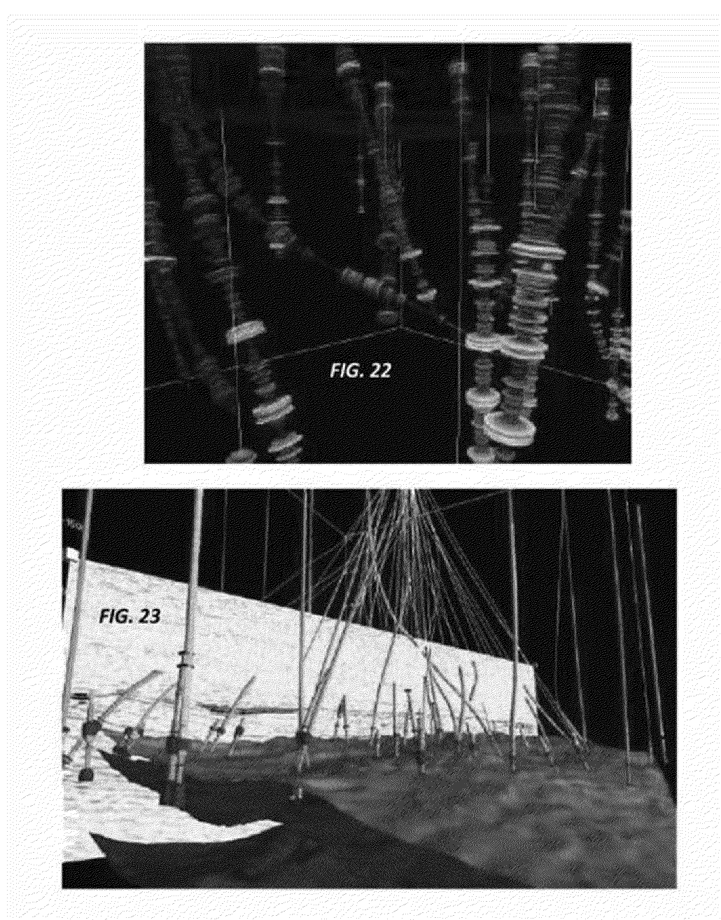

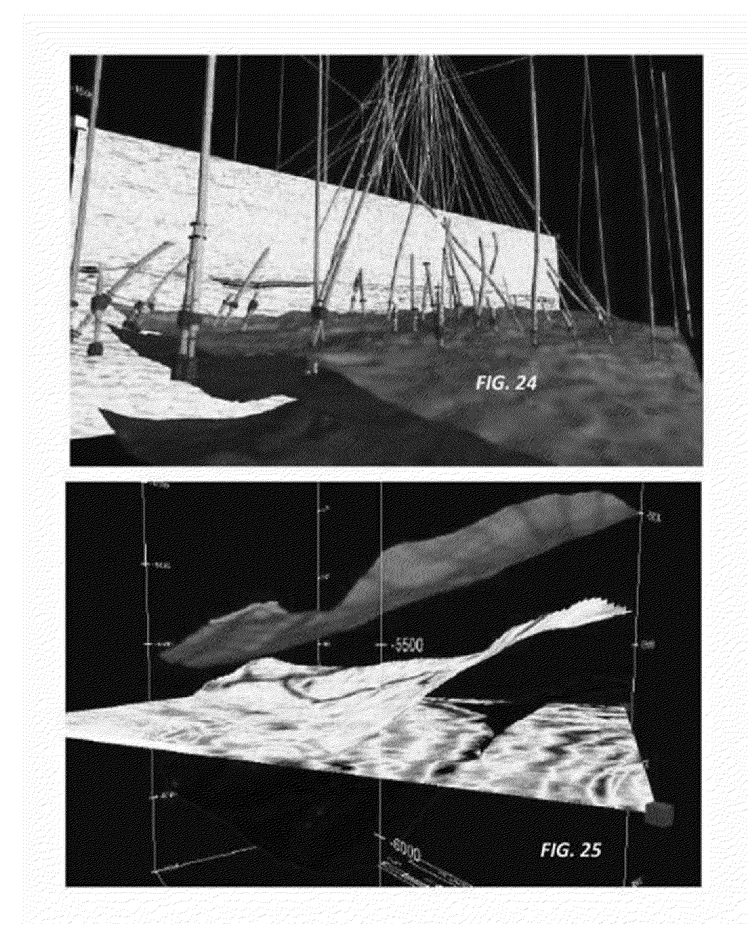

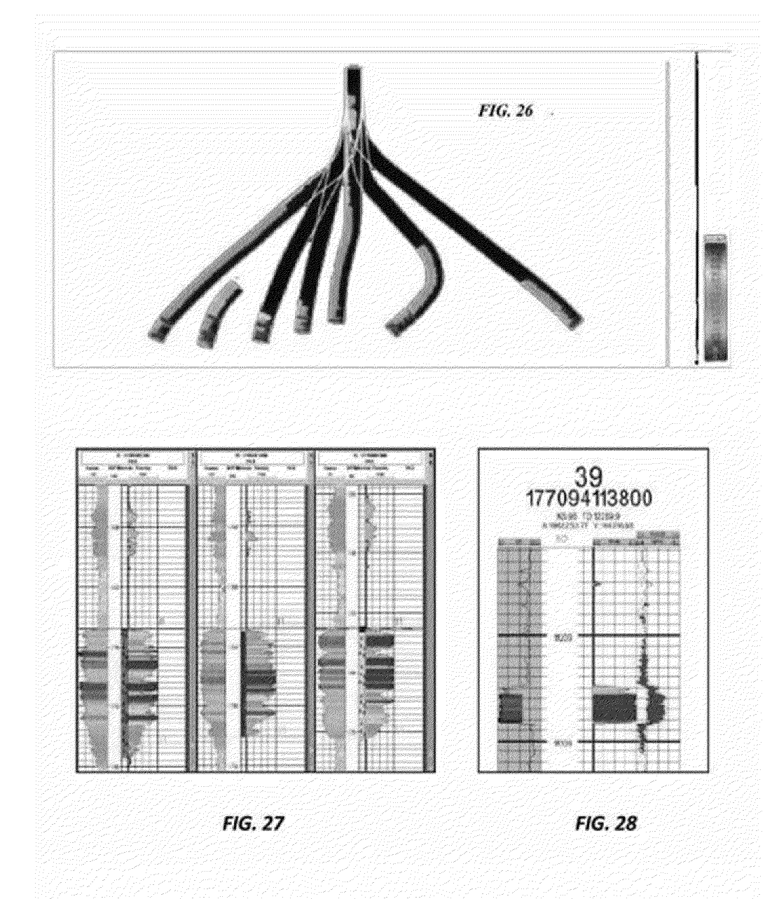

FIGS. 20 through 22 show importing log curve data into the present system. FIGS. 23 and 24 importing three-dimensional seismic data into the present system. FIGS. 25 and 26 display importing deviated and horizontal well data into the present system.

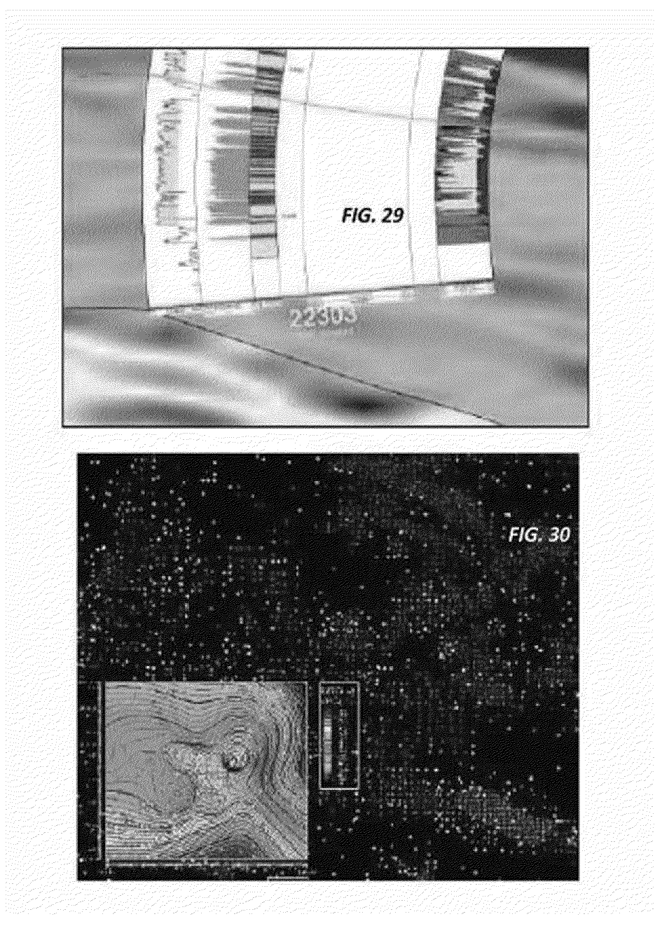

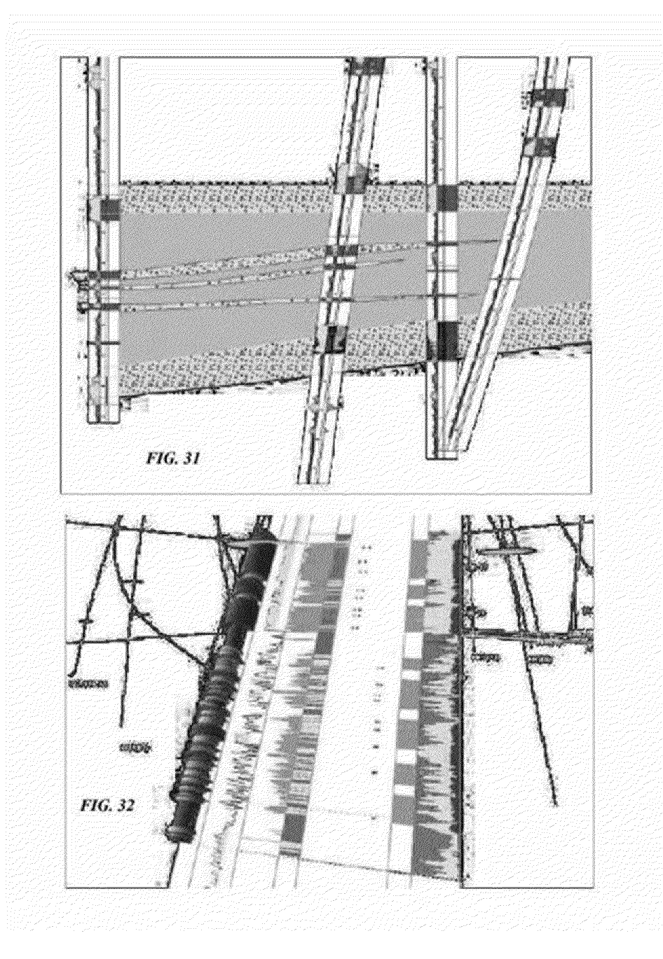

FIGS. 27 through 30 depict an instance of importing well header data into the present geological interpretation system. In particular, FIGS. 27 and 28 show two-dimensional pick plots of information derived from a prior geological survey. Based on this information, FIGS. 29 and 30 display how the information of FIGS. 27 and 28 may appear in a three-dimensional visualization of the subject geological region using the functions and features of the presently disclosed system. FIGS. 31 and 32 further show importing interval data into the present system.

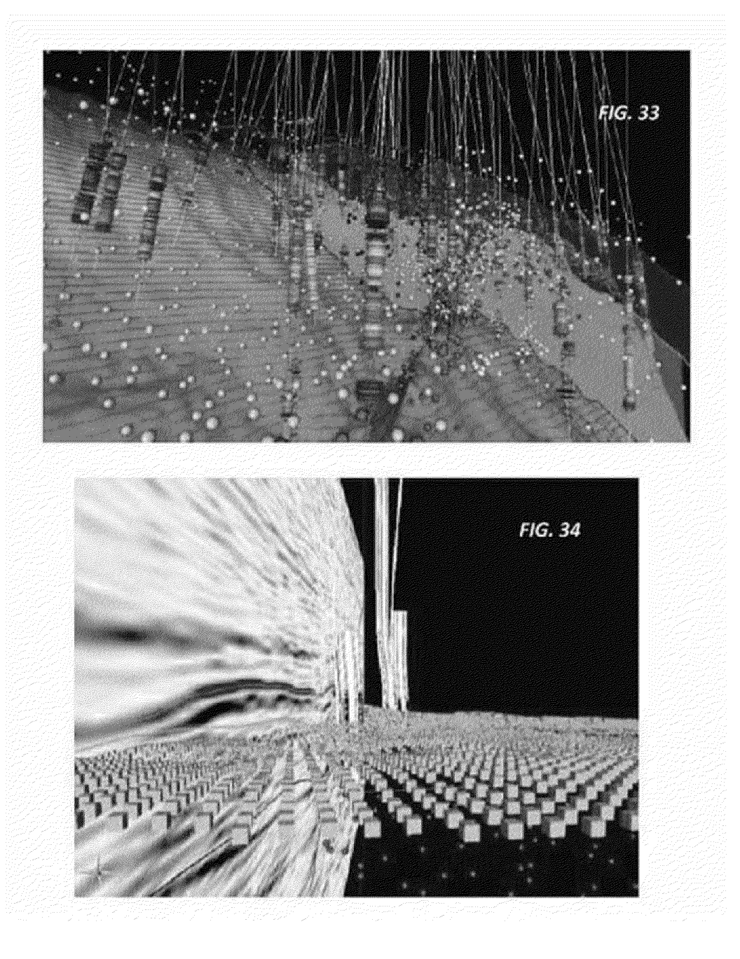

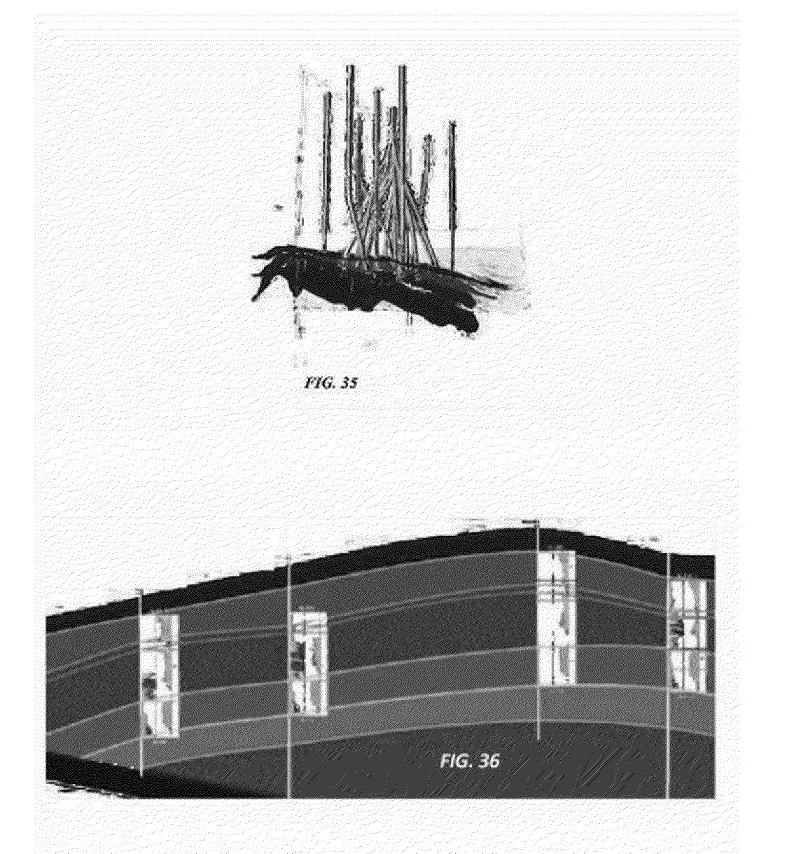

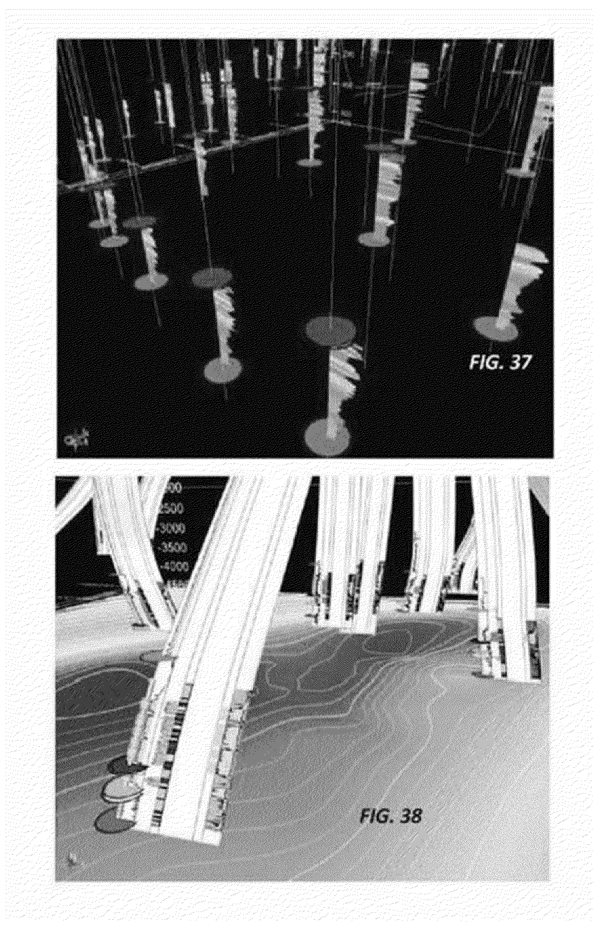

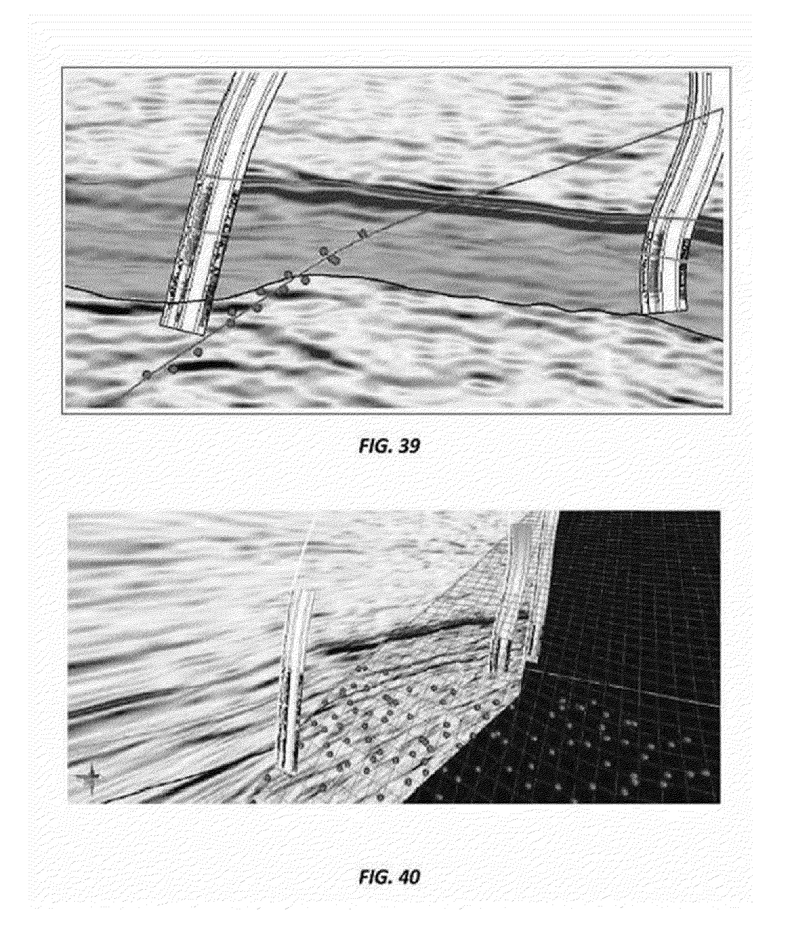

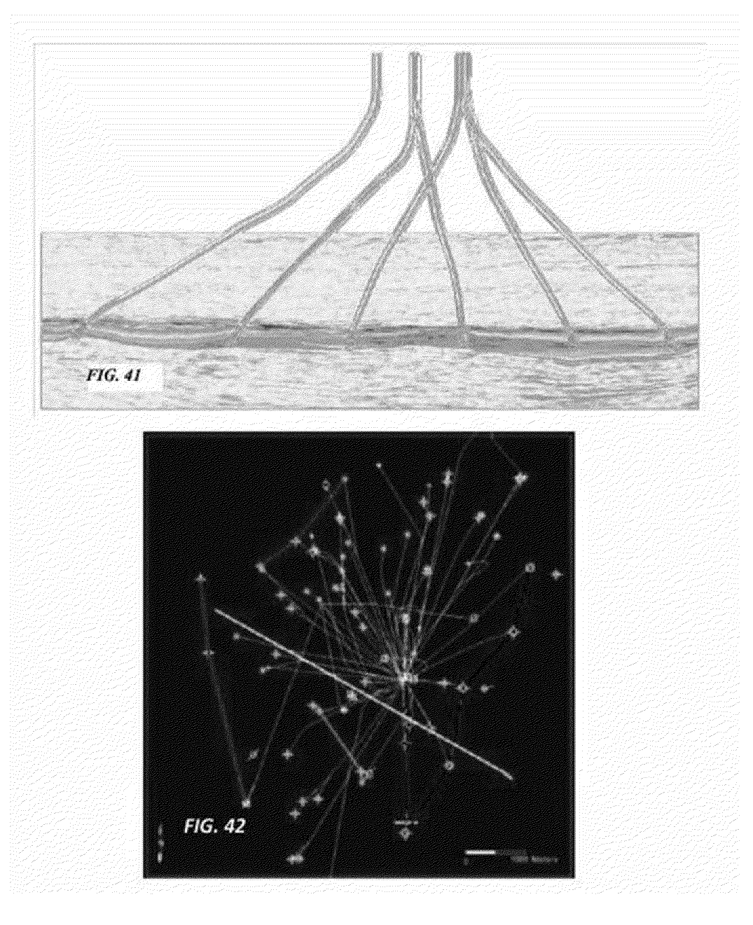

FIGS. 33 and 34 present views of importing pointset data into the present geological interpretation system. FIG. 35 shows exporting grid and map data from the present system. FIGS. 36 and 37 depict graphical data querying and filtering in association with manipulation of the present system. FIG. 38 shows adding three-dimensional editable pick representations in association with manipulation of the present system. FIGS. 39 and 40 provide views of interwell pick interpretation in association with manipulation of the present system. FIGS. 41 and 42 exhibit forming cross-sectional definitions in association with manipulation of the present geological interpretation system.

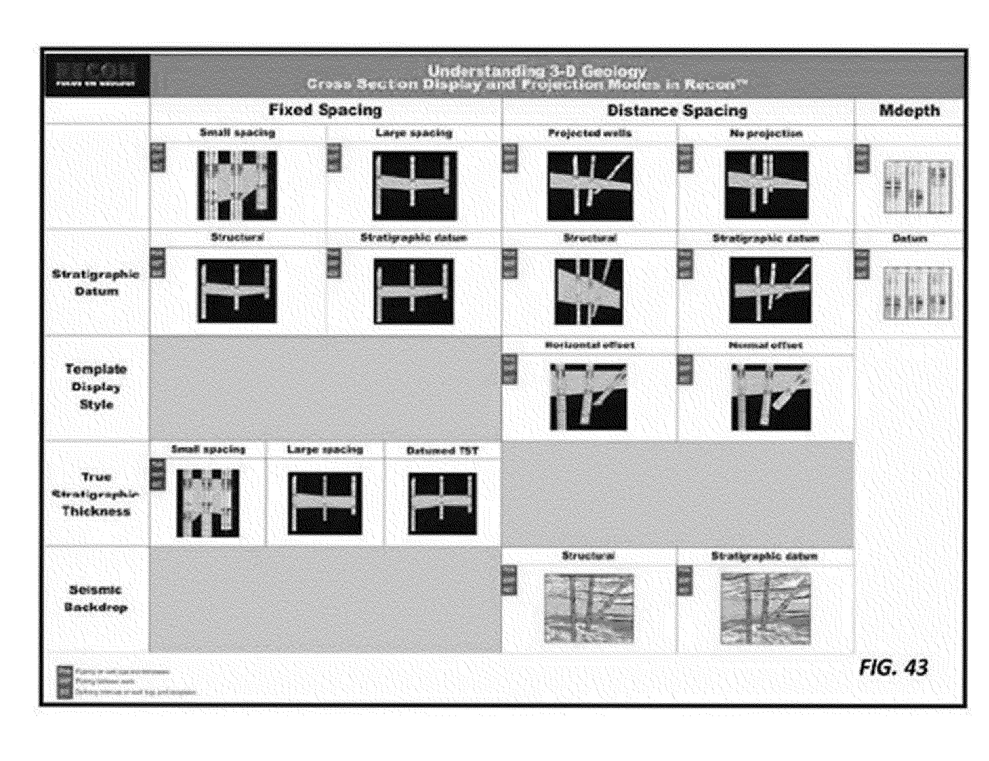

FIG. 43 shows forming correlation representations of the predetermined geological region from the present geological interpretation system. In particular, FIG. 43 outlines the options for understanding three-dimensional geology cross section displays and projection modes available in the present system. Such options include the ability to select fixed spacing and distance spacing visualizations, as well as measured depth representations. The visualizations provide stratigraphic datum displays, template display styles, and true stratigraphic thickness presentations. In addition, a user may select seismic backdrop representations.

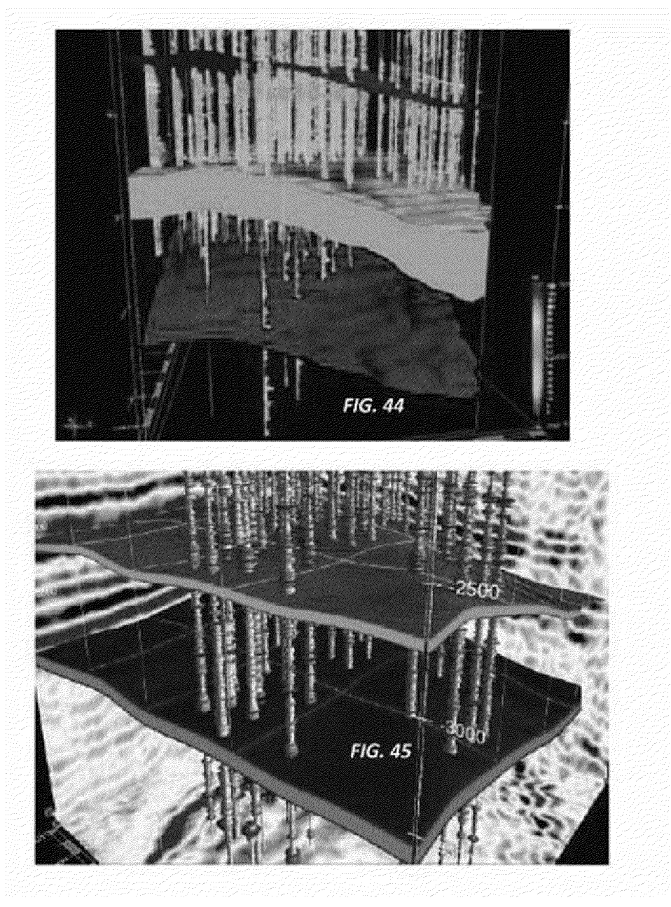

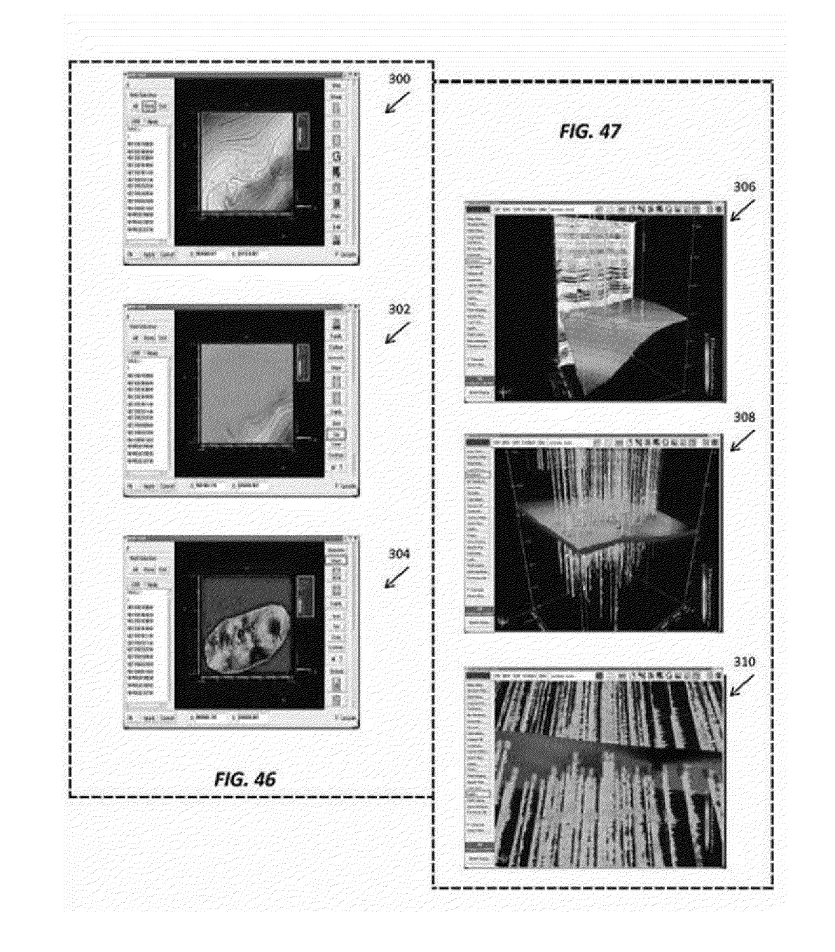

FIGS. 44 and 45 present performing three-dimensional thickness calculations in association with manipulation of the present system. FIGS. 46 and 47 show displays from the group consisting essentially of structure maps, isochore maps, and well log zone average maps in association with manipulation of the present geological interpretation system. In particular, FIG. 46, with its set of two-dimensional screen shots 300, 302, and 304. provide color visualizations of a geological region that may include a set of related picks. While such information is highly useful, it simply does not compare to the three-dimensional visualizations appearing in respectively corresponding screen shots 306, 308, and 310 of FIG. 47. In particular, screen shot 308 shows how a full set of picks may be integrated with a contour visualization. Screen shot 310, moreover, shows how the three-dimensional pick representations of screen shot 308 may be rotated, enlarged, and shown in perspective view as is not possible in corresponding screen shot 304 of FIG. 46.

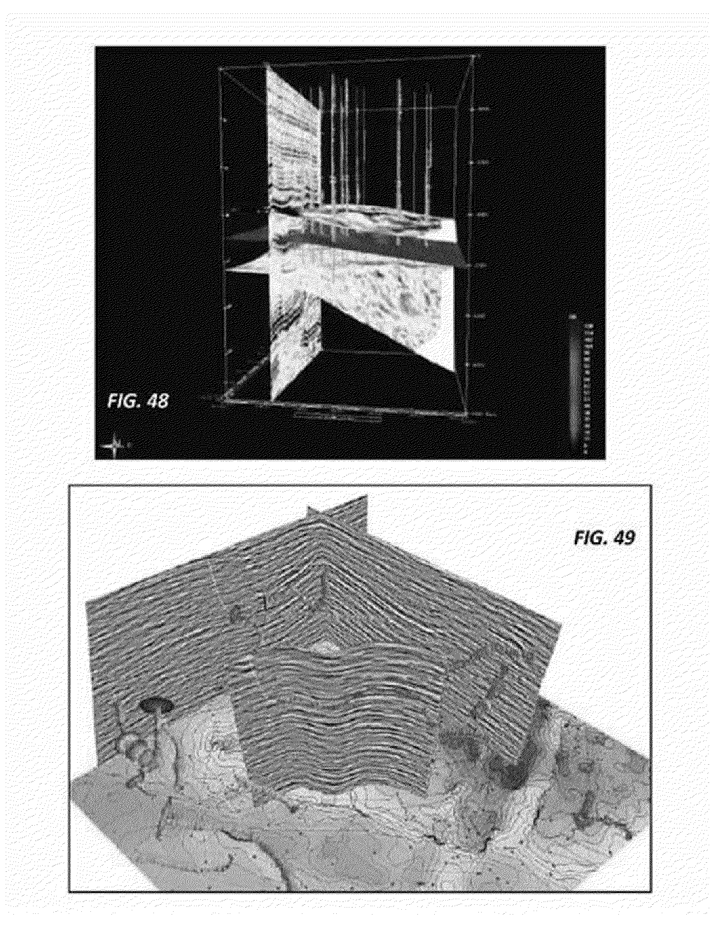

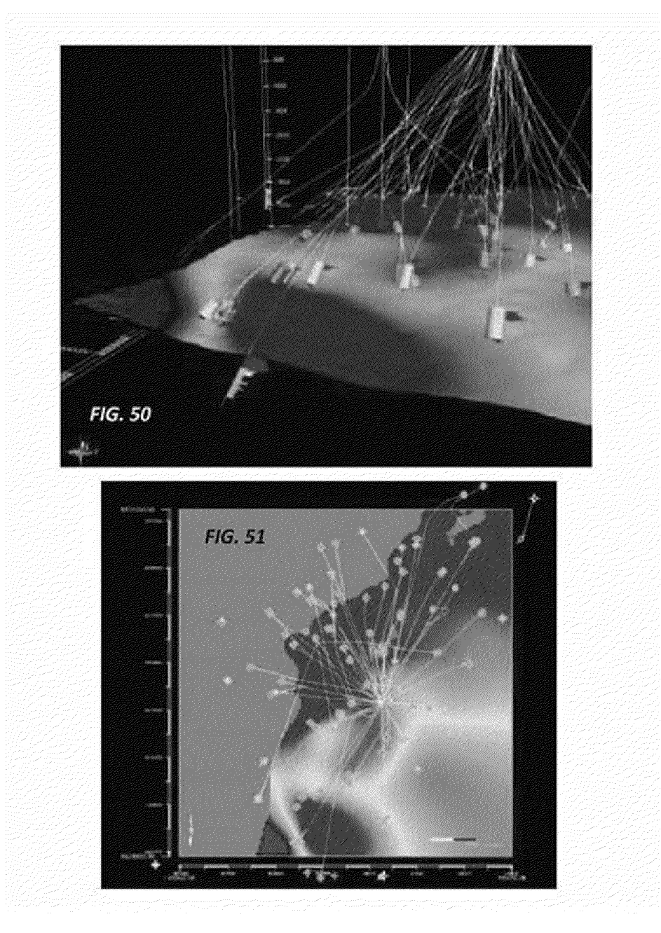

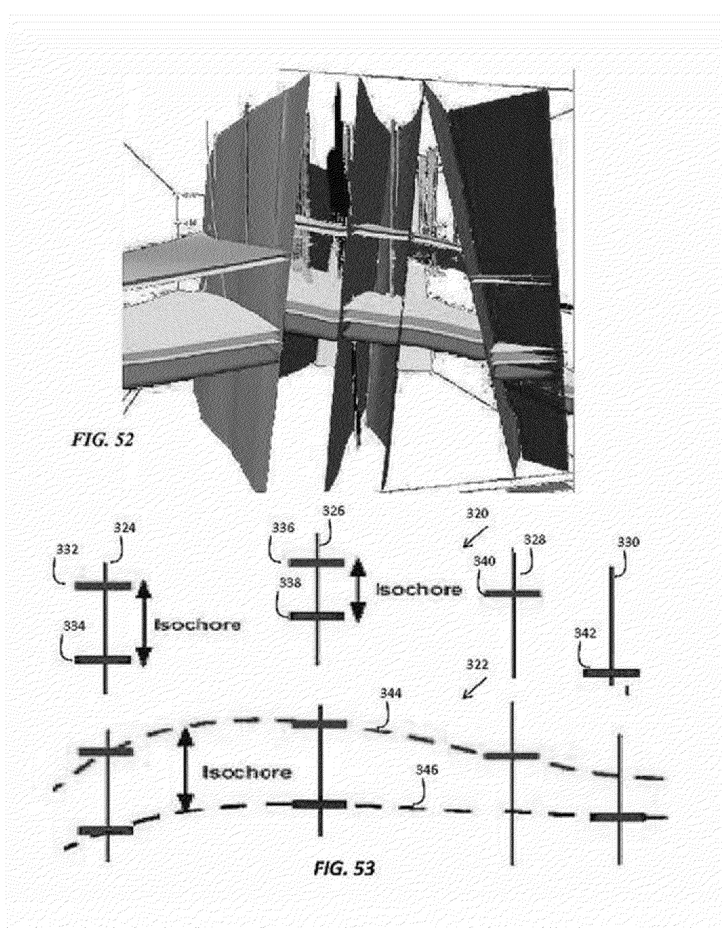

FIGS. 48 and 49 display seismic slices of the predetermined geological region. FIGS. 50 and 51 show how net-to-gross maps are generated based on well log cutoffs or calculated log curves for the predetermined geological region in association with manipulation of the present system. FIG. 52 present performing surface and fault modeling of the predetermined geological region in association with manipulation of the present system.

FIGS. 53 through 55 show forming isochore visualizations of the predetermined geological region from the present geological interpretation system, including isochores from structural horizons in addition to isochores calculated from isochore pointsets. That is, with reference to FIG. 53, there appear two representations 320 and 322 of the same set of isochore measurements taken at picks 324, 326, 328, and 330. In the case of isochore creation using top and base picks: Well 324 includes measured picks 332 and 334 and Well 326 includes picks 336 and 338. In this case, no isochore values are calculated for isochore 328 and 330, because the top and base picks are not both present. Well 328, in contrast only includes pick measurement 340, while well 330 only includes point measurement 342. The resulting isochore map generated using this dataset is therefore not inclusive of all available data.

The presently disclosed system may determine that the pick measurements 332, 336, and 340 form a structural horizon 344 Likewise pick measurements 334, 338, and 342 form a structural horizon 346. This is determined even though there is not a pick measurement on well 328 to associate with structural horizon 346. Nor is there a pick measurement on well 330 to associate with structural horizon 344. The present system, that is, has the ability to associate utilize all picks and the resulting structural horizons to calculate isochore pointsets that result in the determination of structural horizons.

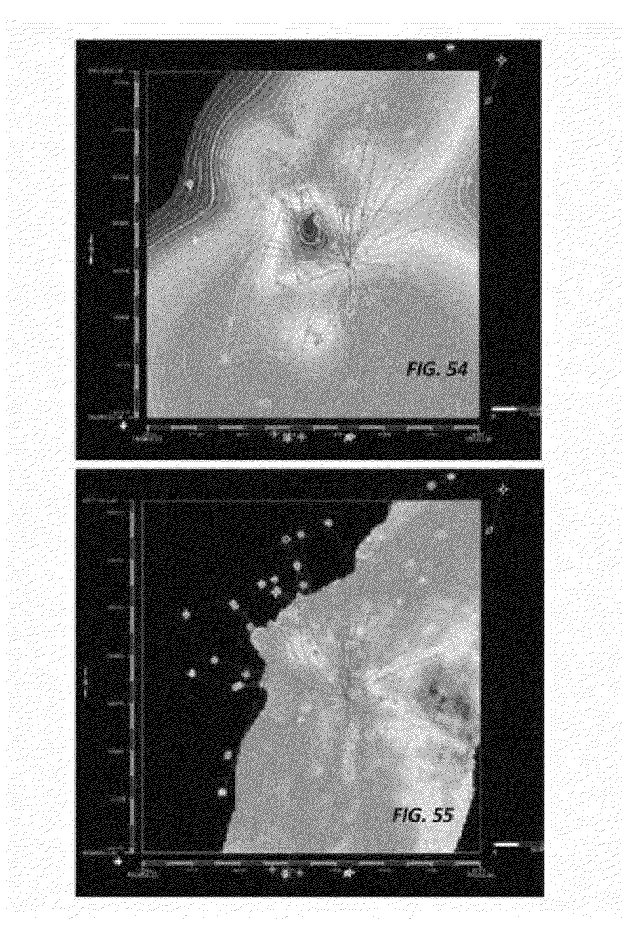

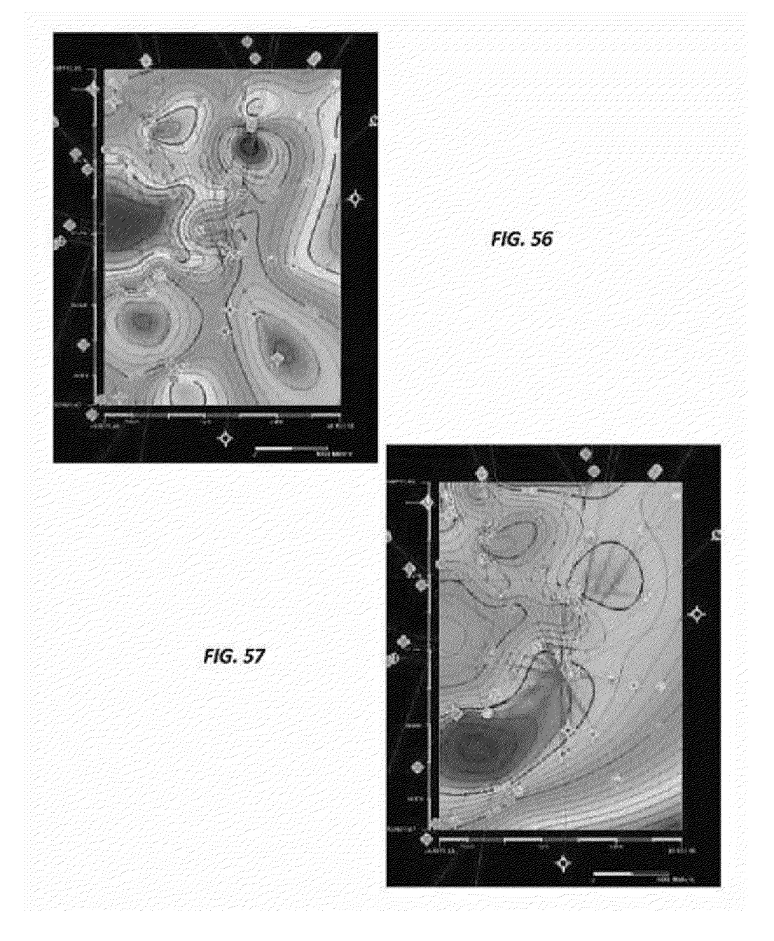

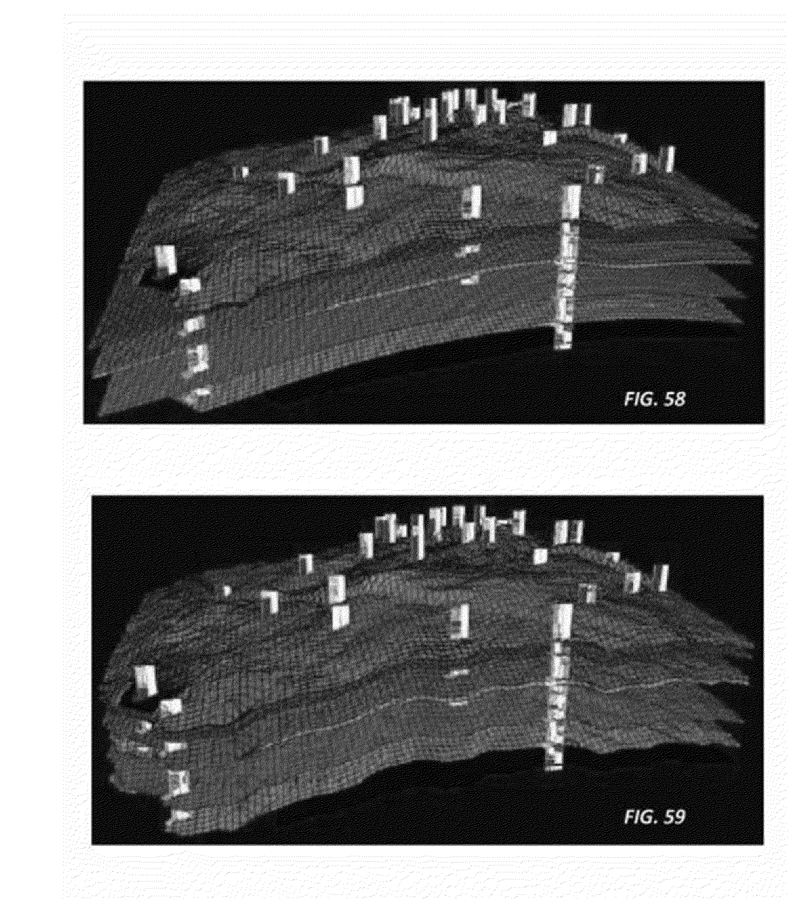

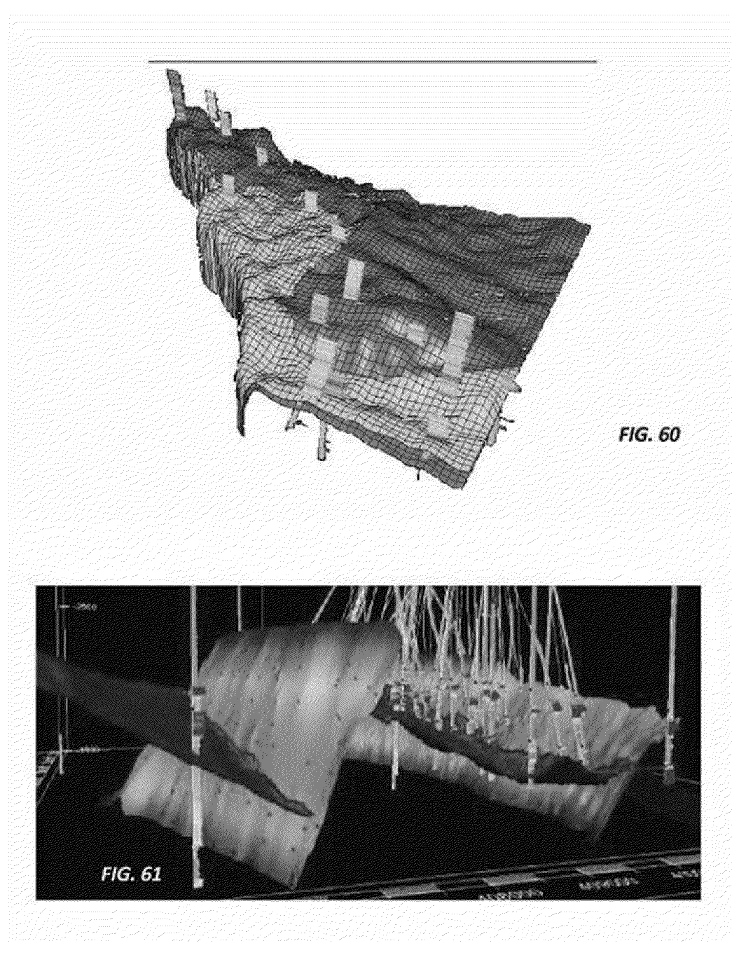

FIG. 54 shows the isochore calculated only using those wells where both the top and base picks for the zone are defined. FIG. 55 shows the isochore calculated while utilizing all picks for the top and base surfaces. FIGS. 56 and 57 show forming well log zone average visualizations of the predetermined geological region from the present system, including isochores from structural horizons in addition to zone averages calculated from zone average pointsets. FIGS. 58 and 59 exhibit functions of performing one-step conformable mapping operations for the predetermined geological region from the present system. FIG. 60 shows performing a one-step seismic tie to log pick operations on the predetermined geological region from the present system.

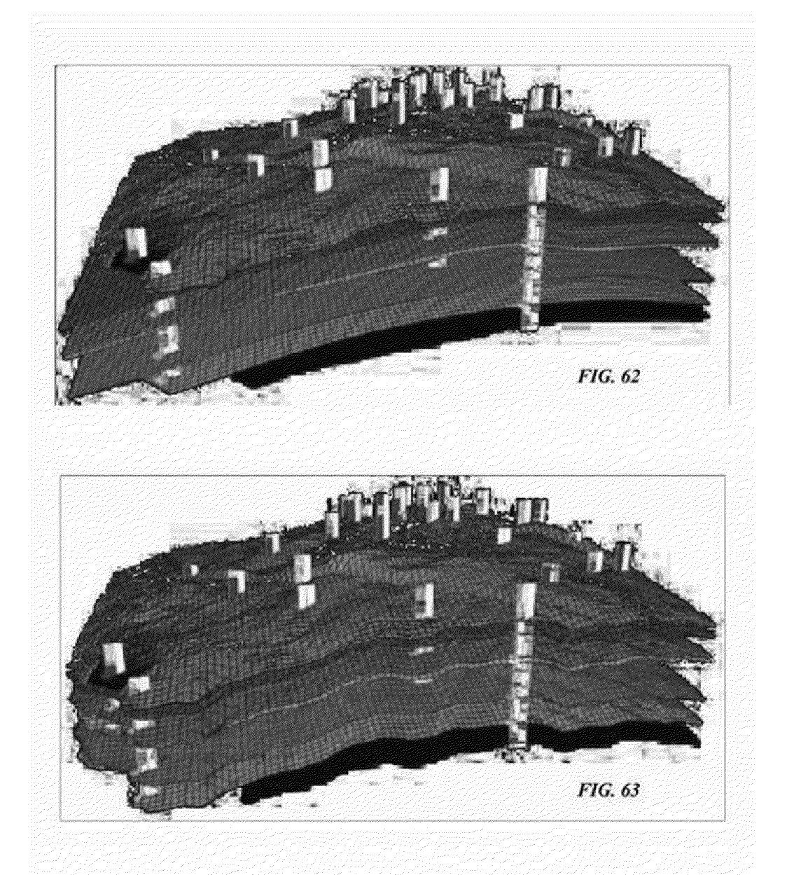

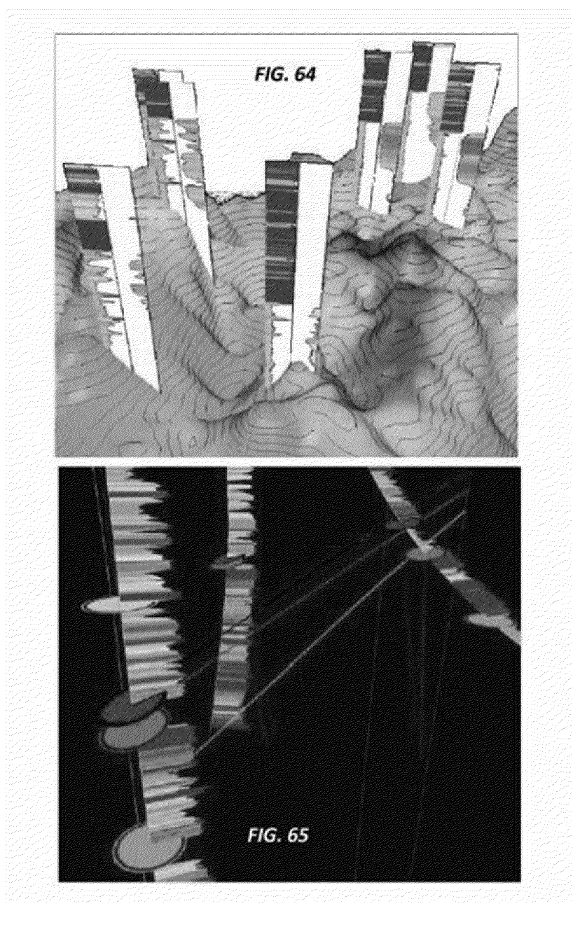

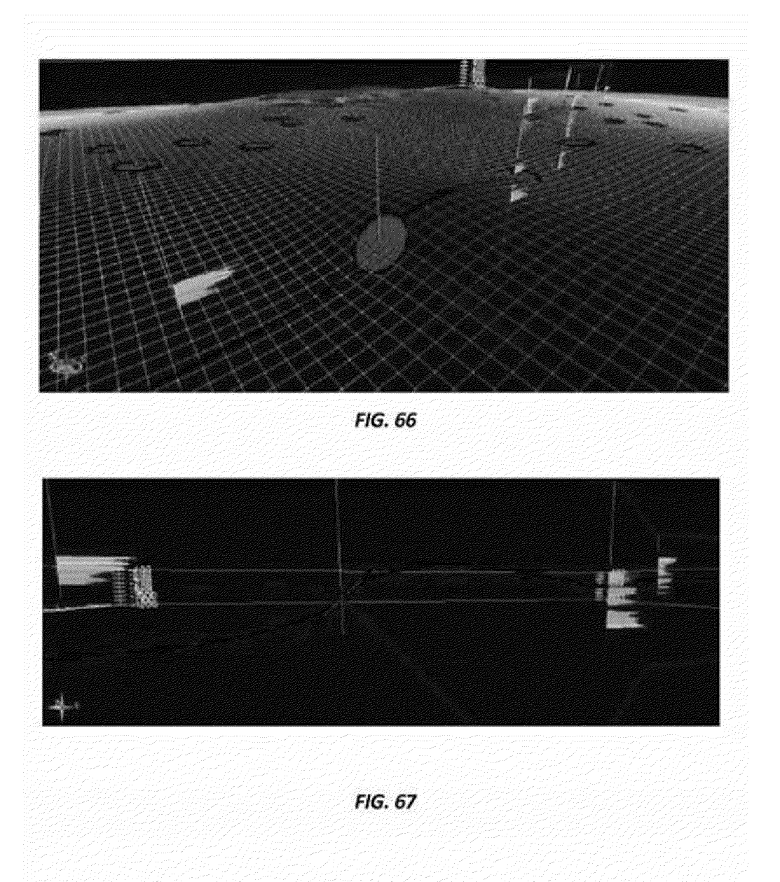

FIG. 61 presents how the present system executes a set of instructions for tying fault surfaces to fault-picks in selected wells of the predetermined geological region from the present system. FIGS. 62 and 63 present how the present system executes a set of instructions for performing recursive conformable mapping operations between multiple horizons of the predetermined geological region using the present system. FIG. 64 displays draping external grid values onto three-dimensional structure maps of the predetermined geological region from the present geological interpretation system. FIG. 65 shows three-dimensional dip/azimuth pick displays for picks measured on the predetermined geological region using the present geological interpretation system. FIGS. 66 and 67 relate to performing surface modeling operations using three-dimensional dip/azimuth pick information of the predetermined geological region using the present system—The Dip/azimuth information contained in the picks is honored by all surface modeling algorithms.

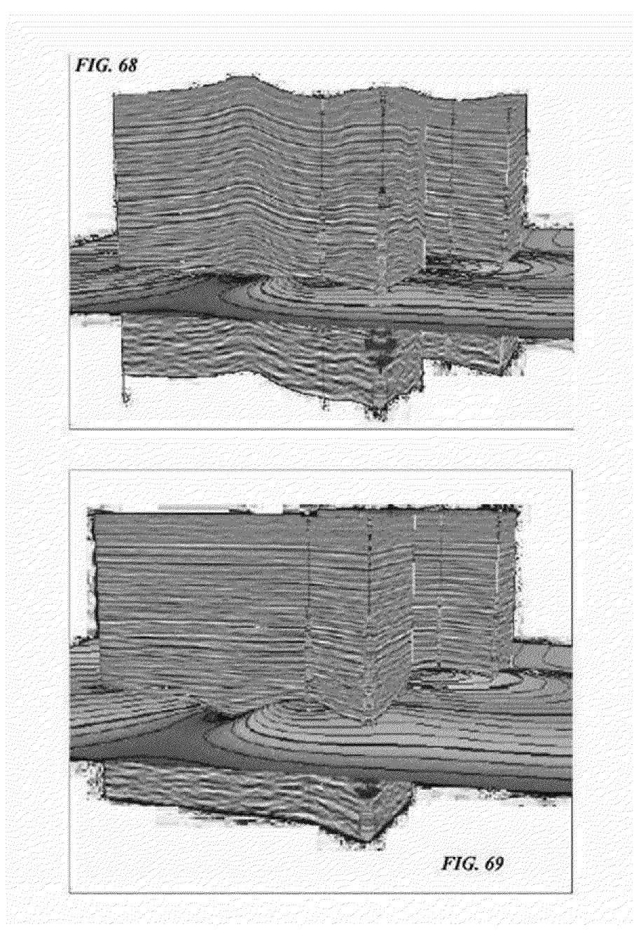

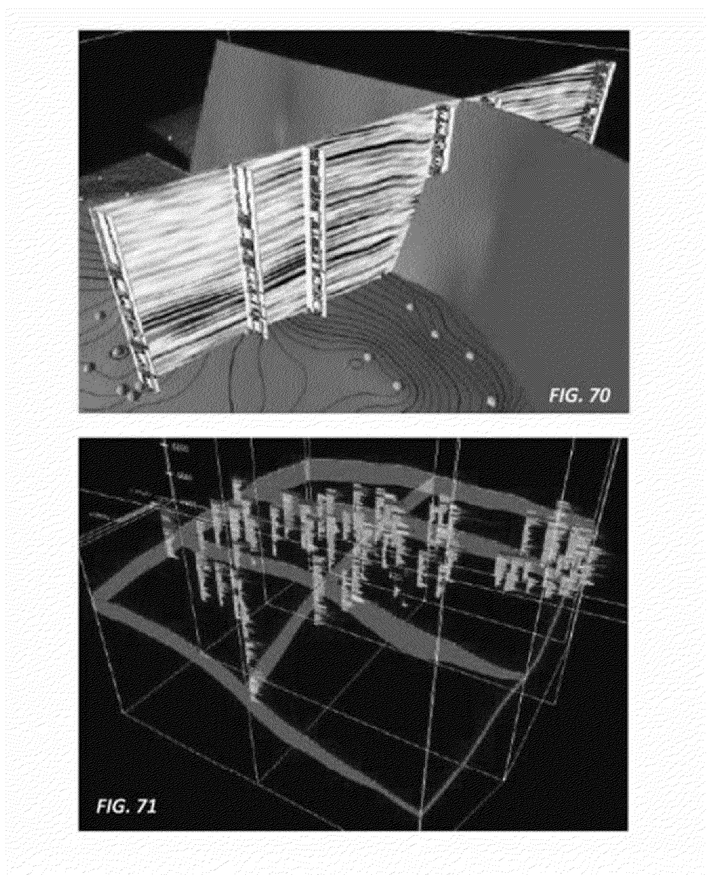

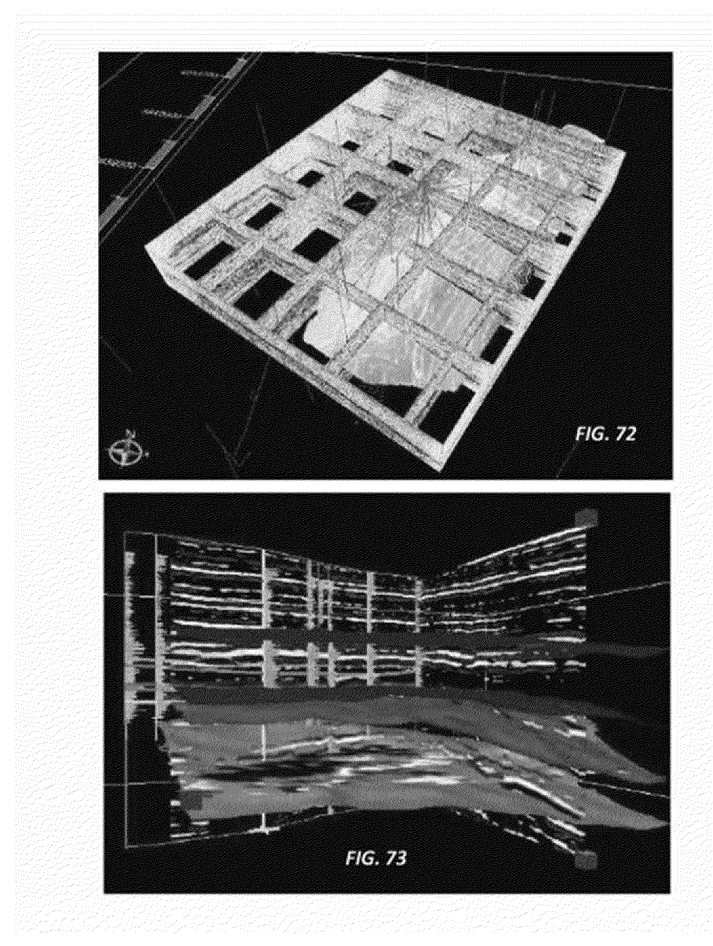

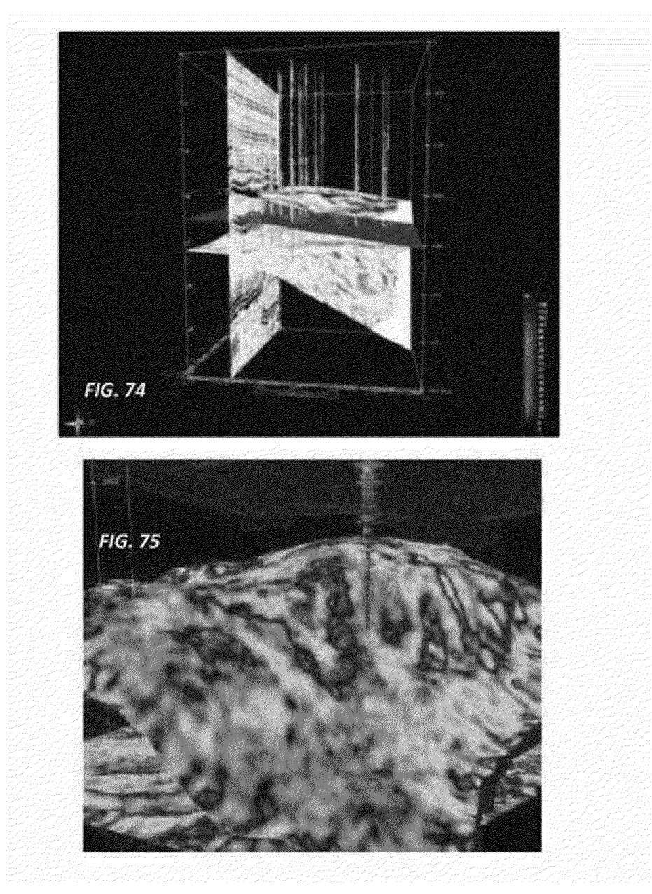

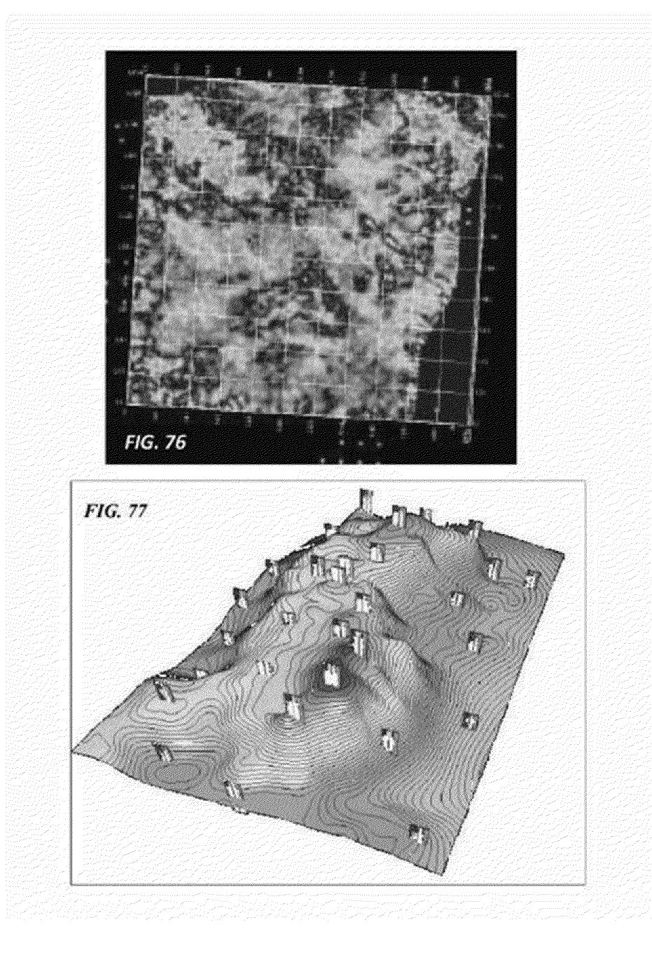

FIGS. 68 and 69 relate to performing interactive three-dimensional datuming of seismic cross-sections and slices of the predetermined geological region from the present system. FIGS. 70 and 71 relate to forming three-dimensional visualizations of cross-sections for wells of the predetermined geological region from the present system. FIG. 72 display views of forming three-dimensional visualizations of seismic fence diagrams of the predetermined geological region from the present system. FIG. 73 shows performing interactive seismic opacity filtering for a plurality of views of the predetermined geological region. FIG. 74 through 76 exhibit forming stratigraphic slicing of three-dimensional seismic volumetric interpretations of the predetermined geological region.

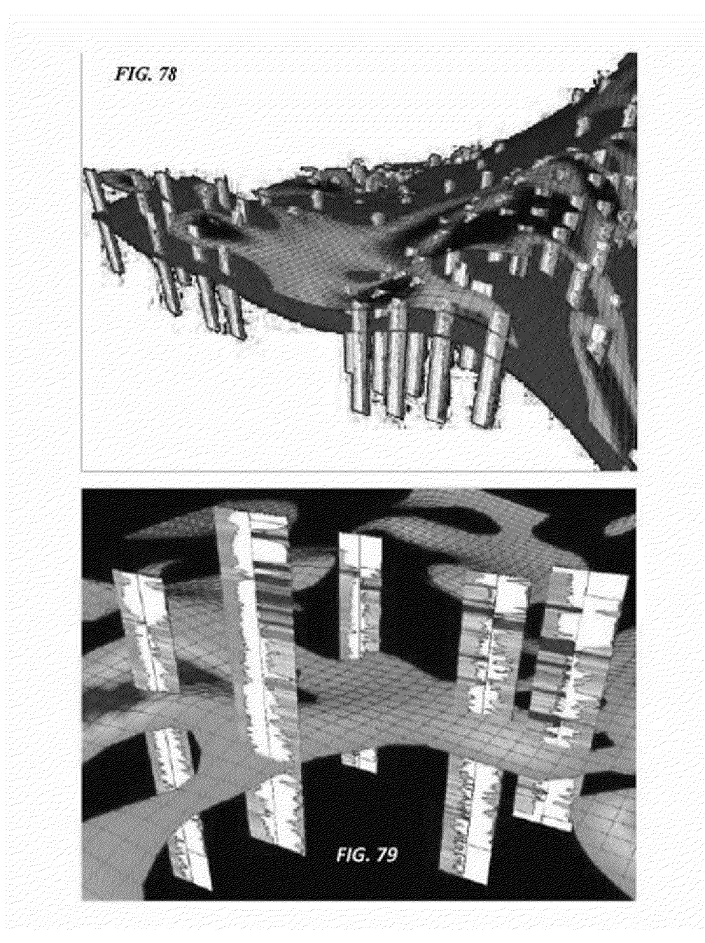

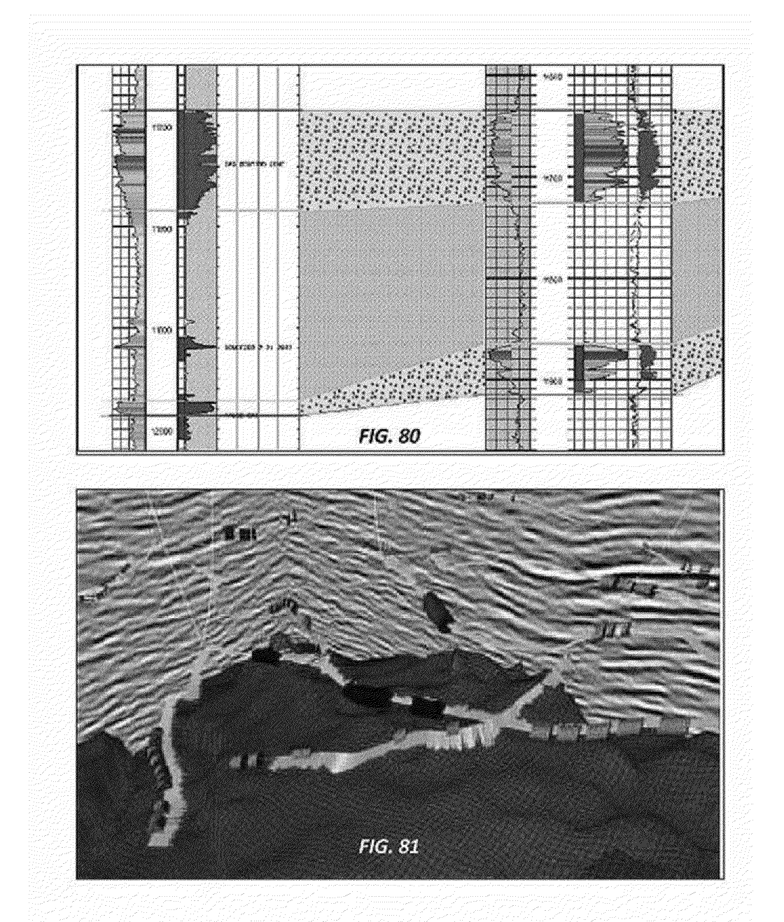

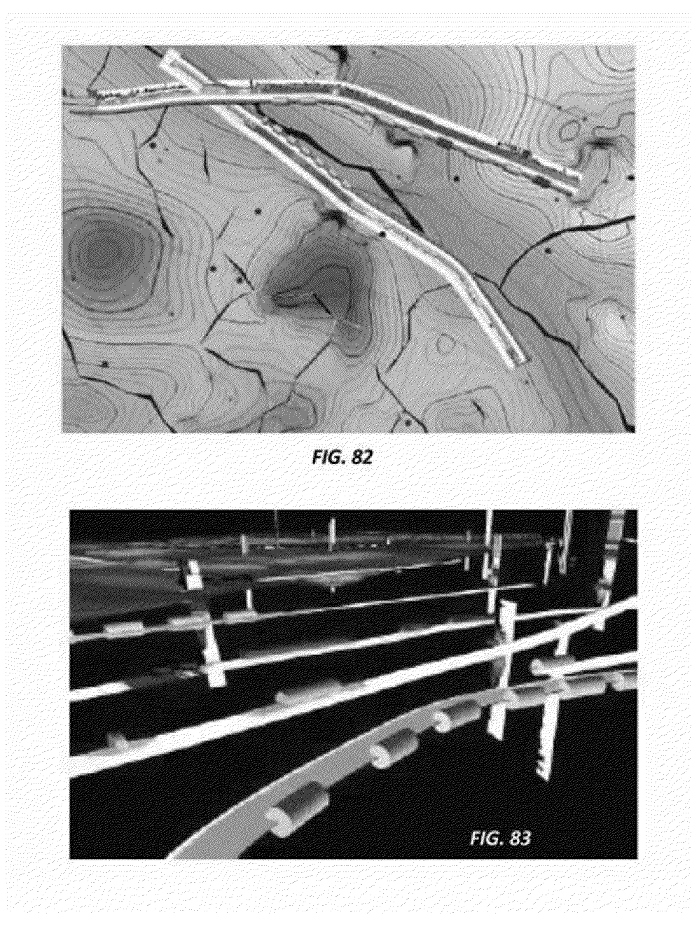

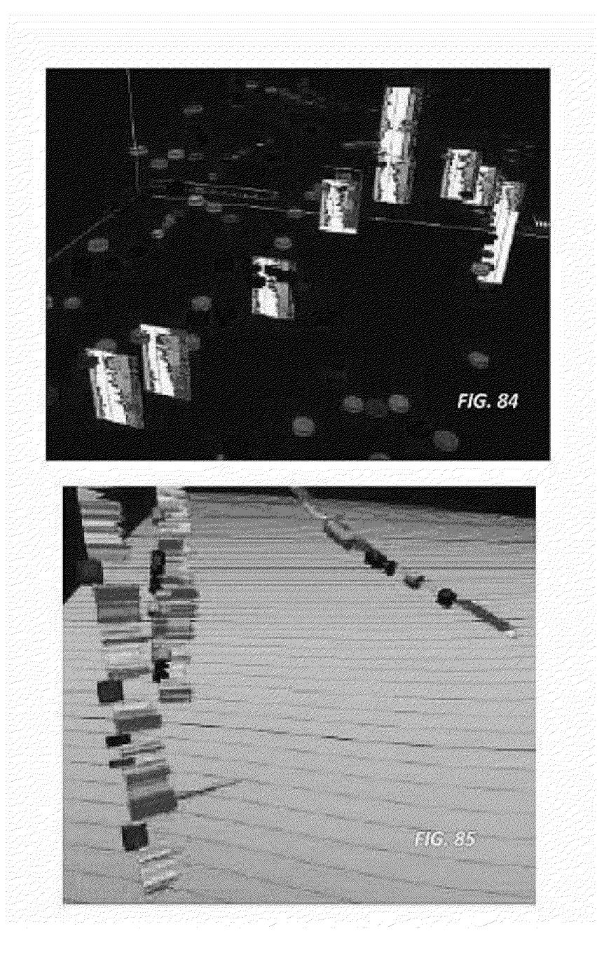

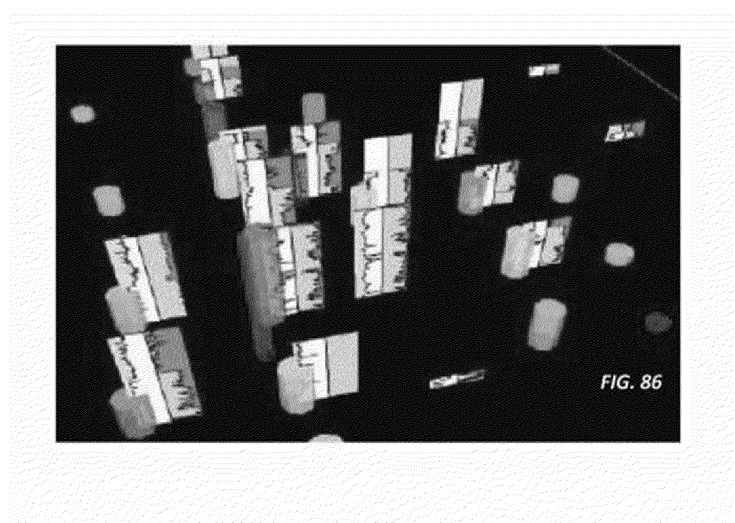

FIG. 77 depicts forming color-filled three-dimensional contours of the predetermined geological region from the present geological interpretation system. FIGS. 78 and 79 illustrate performing interactive filtering of three-dimensional structure and zone average maps of the predetermined geological region from the present geological interpretation system. FIG. 80 shows displays utilizing substitute curves for missing log curve data for a particular well from the predetermined geological region. FIG. 81 through 83 display how the present system and process function in integrating time-stamped production and completion intervals. Finally, FIGS. 84 through 86 illustrate how the present system presents in multi-dimensional images changes in energy resource injection volumes over time.

Then, having described the various illustrative three-dimensional displays, the following description shows various ways in which the dynamic, real-time three-dimensional updating and geological interpretation functions support interpretation of an essentially unlimited number of well logs in two- and three-dimensional space. A grid of sequence stratigraphic cross-sections may be generated across the entire field within which one may recognize geological features, such as a carbonate ramp, made up of high-frequency depositional sequences.

Isochore and zone attribute maps of sequence stratigraphic units showed the distribution of reservoir facies through time. As correlation changes may be made, the maps may be instantaneously updated, allowing for quick reinterpretation. For an oil field that contains hundreds of horizontal wells that penetrate a reservoir interval containing more than 1,000 faults, the challenge of interpreting chrono- and lithostratigraphic picks in the hundreds of horizontal wells may be significantly reduced by system 108, which correlates these wells directly in three-dimensions, without the need for creating complex, and often confusing, projections of the three-dimensional well trajectories into two dimensional cross-sections.

Horizons interpreted in seismic interpretation software may be imported for comparison with the well log-based picks. After correcting the stratigraphic picks in the wells, any structural anomalies caused by velocity variations may be corrected with the click of a button, upon which the seismic horizon may be tied to the final picks, while also honoring the seismic horizons and faults. The well log correlation of hundreds of horizontal and vertical wells may be aided by the integration of dynamic production data, including production and injection intervals.

All interval data may be displayed in both the well log templates as well as cylinders along the three-dimensional trajectories of the well logs in three-dimensional. Because all interval data may be time-stamped, three-dimensional queries may be performed, leading to the corroboration of correlation hypotheses, as well as providing insight into development related issues affecting the day-to-day operation of the field.

The end result of the integration of all the available data may be a robust correlation of the sequence stratigraphic framework of the field, combining all horizontal wells, faults, seismic horizons and production data. System 108 provides a central database environment for storing a wide range of data types, allowing applications to more easily access and share data crucial to the successful interpretation of a field. The system communicates with as many industry-standard databases as possible, while also focusing on direct interaction with all available best-of-class software applications.

The cascading sub-process 150 allows changing one parameter and, in response to the change, automatically modifies an entire interpretation for the affected geological region. For example, if the user shows a porosity map for a zone in the base map, and then makes a change to the top structure pick for that zone, cascading sub-process 150 will automatically update all parameters required for the final update of the porosity map (i.e., all the steps shown in the circular diagram).

After placing the pick for the top of the channel, cascading sub-process will automatically regenerate the top of channel structural surface using the new top pick, the base of the channel surface, re-datum the wells using the new structures. Then cascading sub-process 150 automatically regenerates the zone average values at the wells using the new structures, distribute the zone average values across the reservoir, and applies the porosity cutoff filter. Then, system 108 will show the updated display in three-dimensional, base map, and cross-section views.

System 108 provides a flexible, free-form interval database that adjusts to the data instead of forcing the user to conform to a predefined data structure. This enables the interpreter to quickly and easily integrate contextual interval data from a wide range of sources. The larger the variety of data that is made available in the disclosed system's three-dimensional interpretation environment, the higher the quality of the resulting interpretation will be.

The data to define any interval includes class name (e.g., facies or production), type name (e.g., grainstone or perforated), top measured depth, base measured depth, and well name or UWI. A simple space delimited, column based text file containing interval data may be imported using the wizard. System 108 will automatically construct a spreadsheet with multiple sheets representing the various classes containing the interval types. After importing the intervals, the user may create, combine, or delete classes and types and assign colors and fill patterns for the individual interval types. Optional interval attributes include start and stop time, value, and text remarks.

System 108 defines intervals in the disclosed system, which may be defined and edited directly on the wells displayed in a two-dimensional correlation window. The user may click and drag the computer 10 cursor to define an interval for both straight and deviated wells, as well as drag-and-drop defined intervals between wells to speed up interactive interval interpretation workflow.

The user may select and edit intervals directly in three-dimensions. After selecting an interval, the user may change the class, type, interval depth or values. All intervals may be time stamped using start and stop dates. The user may perform such queries as “show all injection intervals with volumes greater than 500 b/d from 2001 through 2004” and see the results displayed in three-dimensions.

All intervals may be referenced in well log templates. The user may combine the interval data with log curves to highlight facies changes or completion intervals. The user may fill a log curve with an interval class, which will automatically pick up all types with their color and pattern fill parameters. Depth-referenced text comments may be placed in templates using the interval remark fields. Intervals may be calculated and used in equations in the disclosed system log calculator.

The disclosed geological interpretation system's two dimensional correlation view may datum any seismic cross-section based on any three-dimensional horizon. This stratigraphic datum mode is very useful when interpreting subtle stratigraphic traps. Using the disclosed geological interpretation system cascading sub-process 150, an interpreter may drag-and-drop picks for a datum horizon and see the seismic cross-section shift in real-time.

The geological interpretation system 108 ability to load an unlimited number of wells to be displayed in the base map does not force the user to map horizons over the entire project area. An interpreter may easily resize the project area-of-interest (AOI) in the base map, after which the disclosed system will automatically redisplay the requested map using the same mapping parameters (e.g., a porosity map for a particular zone) specified by the user. Real-time roaming through the base map is accomplished by simply clicking and dragging a new AOI rectangle. A unique advantage of this feature is to enable the merging of both regional scale well log and seismic data with detailed field level data in a single the disclosed system project. This ensures that interpretations are kept consistent between regional and local scales, providing for a more accurate geological interpretation—the disclosed system's base map roaming is an example of its scalable applicability ranging from small, early stage exploration projects through large, mature development projects.

The three-dimensional geological interpretation workflows here disclosed are aided by its linked two dimensional correlation views. To bridge the spatial differences between these two dimensional representations and the three-dimensional world, the disclosed system allows the interpreter to change lines-of-section in the base map in real-time and to observe the immediate re-projection of these wells in the two dimensional cross-section view. Apart from changing the line-of-section in real-time, the interpreter may also change which wells are projected into the line-of-section. Clicking on the wells in the base map or in 3-D will add or subtract projected wells from the two dimensional correlation view. The direct link between the two dimensional and three-dimensional interpretation views helps geoscientists more quickly determine the optimal geological interpretation.

The interpretation while drilling (IWD) workflows of system 108 may be integrated with the three-dimensional geological interpretation environment, combining three-dimensional views with cross-section and base map views to give the asset team the most comprehensive view of the subsurface situation and enabling the team to change its interpretations on the fly.

There are several ways to integrate logging while drilling (LWD) data and measurement while drilling (MWD) into the disclosed system during the drilling process. With the disclosed system, the user may qualitatively and quantitatively check whether user grid honors the input data points by visualizing user log data, user interpreted picks, and the surfaces based on user interpretation in three-dimensional. Users can overlay three-dimensional log templates of horizontal wells onto a faulted surface mapped conformable to a seismic horizon.

The disclosed system may access three-dimensional seismic data directly from Landmark SeisWorks® projects and may visualize seismic data along user-defined cross-sections, and along in-lines and cross-lines for both the seismic project and the geological area-of-interest. Seismic time-slices may also be shown in three-dimensions and in the base map. All visualization is performed in real-time, allowing the user to dynamically drag cross-sections across the volume to interactively interpret the wells-logs in conjunction with the seismic.

As with all of the disclosed three-dimensional cross-sections, the seismic cross-sections may be datumed interactively in two dimensional and three-dimensional, and the user may continue to interpret in the stratigraphically datumed seismic view. Besides seismic color ramp controls, the disclosed system may apply opacity and filtering parameters to the seismic shown in three-dimensions.

Interactive XY grid increment changes. All the disclosed system structural surface grids share the gridding area-of-interest parameters defined in the limits dialog. This allows the user to change the X and Y increments for all of the disclosed system structure grids at one time. The user may use this feature to reduce the amount of time spent in generating structural surfaces. For example, the user may initially generate all structural surfaces at a relatively large XY increment ensuring quick response during interpretation.

One example of the advantages of having a true three-dimensional foundation may be found in the disclosed system's ability to automatically back-interpolate picks at the location where a structural surface intersects a well without a pick for that surface. In its two dimensional correlation view the disclosed geological interpretation, system uses these back-interpolated picks to shift wells without picks for the datum surface to the datum, thus improving the correlation workflow.

In geological interpretation system 108, the user may switch between two different zone thickness calculation methods on the fly. The user may have the disclosed system calculate thickness values between top and base picks at the well and pass this point set to the various gridding algorithms. Alternatively, the disclosed system may generate the individual top and base surfaces using different algorithms and then calculate the thickness between them using a grid operation. The added advantage of generating isochores from structural grids is that the user may access the disclosed system's conformable gridding functionality to incorporate relations between structural horizons as well as seismic structure information in the interwell region.

Geological interpretation system 108 saves significant amounts of time and resources by enabling the user to off-load all of the interpretation-dependent three-dimensional modeling tasks to the disclosed system. Using system's dynamic zone averaging, a quick study of the influence of sampling intervals on vertical heterogeneity may be made.

For the purposes of the following, 3-D geologic interpretations refer to (3-D) geological interpretations of two-dimensional geological data relating to a predetermined geological region. 3-D models refers to the process of describing a system, process or phenomenon that accounts for known or inferred properties to be used in simulating and predicting results.

For the purposes of the following, interpretation refers to the interpretation of geological data performed by a user of the disclosed system, method, and computer readable medium. Typically, data interpretation occurs during a process known as well-log correlation or seismic interpretation. The present disclosure enables the incorporation of geological and geophysical data and interpretations to form 3-D interpretations and models.

The present disclosure further provides a geological scenario manager for managing uncertainties and allowing a user to easily perform a risk analysis of multiple 3-D geologic interpretations and models. The geological scenario manager of the present disclosure enables interpretation version control of edits to interpretation objects. Using the teachings of the present disclosure project data created during an entire project lifetime may be tracked. Further, the tracked interpretation objects of the present disclosure do not need to be duplicated for multiple sessions or scenarios. The geological scenario manager allows quantitative and qualitative analysis of multiple interpretations of input data to help a user resolve uncertainties associated with multiple equiprobable 3-D geologic interpretations and models. Further, the geological scenario manager provides a data tracking feature, enabling users to track and record some or all edits to interpretation objects

To provide this functionality, the geological scenario manager tracks interpretation objects edited or created by a user. Interpretation objects are dynamic in nature and are created by the user during the analysis of the input data for the 3-D geologic model. For example, interpretation objects could include picks, grids, faults, seismic horizons, isochores, zone average maps, point sets, intervals, planned well trajectories, culture, annotations, group assignments and well list assignments, calculated well logs, cross section definitions, and the like among many others. In addition, interpretation objects may include geological data added throughout the project, such as new well locations or updated well locations.

Each tracked object is assigned a unique identification code and time stamp.

The geological scenario manager tracks interpretation objects and metadata associated with the interpretation object. Such metadata may include the interpretation edit; interpreter; interpretation edit effect on values, parameters, and dependencies; date and time of interpretation edit among other tracked metadata. An edit to an interpretation object may include adding an interpretation object, changing the value of an interpretation object, or deletion of an interpretation object.

Table 1 below shows one embodiment of tracked interpretation objects and the associated object parameters. Table 1 shows one listing of tracked interpretation objects, however, the geological scenario manager of the present disclosure may track many other interpretation objects.

TABLE 1
Possible Tracked Object listing

| OBJECT | TYPE | PARAMETERS TRACKED |
|---|---|---|
| Picks | Inter-well | Location, Shape, Size, Color, Values, |
| | | Dip/Azimuth, Confidence, etc. |
| | Well | Well Location, Shape, Size, Color, Values, |
| | | Dip/Azimuth, Confidence, etc. |
| | Well Fault | Well Location, Shape, Size, Color, Values, |
| | | Dip/Azimuth, Confidence etc. |
| Grids | Pick Surfaces | Algorithm, Grid Filter, Datum, Color Overlay, |
| | | Style, Conformability, Dynamic terminations, |
| | | Extrapolations, Grid parameters, Display |
| | | selection |
| | Seismic Horizons | Grid Filter, Datum, Color Overlay, Style, |
| | | Dynamic terminations, Display selection |
| | Pointsets | Algorithm, Grid Filter, Datum, Color Overlay, |
| | | Style, Conformability, Dynamic terminations, |
| | | Extrapolations, Grid parameters, Display |
| | | Selection |
| | Static Grids | Grid Filter, Datum, Color Overlay, Style, |
| | | Dynamic terminations, Display selection |
| Faults | Fault Segments | Algorithm, Grid Filter, Datum, Color Overlay, |
| | | Style, Conformability, Dynamic terminations, |
| | | Extrapolations, Grid parameters, Display |
| | | Selection |
| | Fault Grids | Grid Filter, Datum, Color Overlay, Style, |
| | | Dynamic terminations, Display selection |
| Stratigraphic | | Order and Members, Framework setup, Grid |
| Column | | dependencies, etc. |
| Isochores | | Contours, Colors spectrums, Cut-off range, |
| | | Bounding surfaces, markers display, etc. |
| Zone Average | | Zone definition, Attribute, distribution algorithm, |
| Maps | | data source, display style, contour definition, |
| | | Thickness, etc |
| Culture Data | | Intersections, Colors, lease boundaries, 3D and |
| | | Map selections, activations and displays. Display |
| | | styles, |
| Annotations | Shapes | Annotation objects, styles, placements, shapes, |
| | | fills |
| | Images | Tiff, JPG, placement, size, anchor point(s) |
| | Text | Text, Font, placement, style, color, etc. |
| HyperLinks | Text Note | Link type, display style & settings, external |
| | | applications & links. |
| | PDF document | Link type, display style & settings, external |
| | | applications & links. |
| | Image (JPG, TIFF, | Link type, display style & settings, external |
| | PNG) | applications & links. |
| | Spreadsheet | Link type, display style & settings, external |
| | | applications & links. |
| | Word (Text) | Link type, display style & settings, external |
| | document | applications & links. |
| | User Defined | Link type, display style & settings, external |
| | Command/3^{rd} party | applications & links. |
| | link | |
| Intervals | | 3D View selections, Style, Fills, patterns, Filter |
| | | settings, Well relationship, date and value settings |
| | | and displays. 2D View displays, map display, |
| | | Width, size, Color, etc. |
| Cross Sections | | Associated wells, selected profiles, cross section |
| | | nodes, color, fill style, dynamic cross section |
| | | buffers, well projection buffer, seismic |
| | | background, zone fill rules (up/down, Patterns, |
| | | Opacity |
| Wells | Deviations & Position | Coordinates and orientation, deviation algorithm, |
| | Logs | parameters |
| | Curves | Log name, data range, settings: log10, discrete, |
| | | scaling limits, display style, color spectrum |
| | Groups & Well lists | Memberships in Cross-sections and Well lists and |
| | | logical user defined groups |
| | Well Templates | Template definitions with all parameters incl. |
| | | Tracks, scaling, orientation, fill colors and |
| | | spectrums, etc. |
| | Substitute logs | Curve-alias definitions |
| Secondary | Application Controls | |
| Interpretation | and Settings | |
| Objects | Window placements | |
| & Project Settings | and Sizes | |
| | Data selections and | |
| | activations | |
| | Color Assignments | |
| | Project Limits | |
| | Grid Increments | |
| | Grid Masks | |
| | Gridding Algorithms | |
| | and Parameters | |
| | Conformability | |
| | definitions | |
| | Grid Extrapolation | |
| | controls | |
| | Zone patterns | |
| | Well Template | |
| | Definitions | |
| | Substitute Logs/ | |
| | Curve Alias | |
| | definitions | |
| | Fault Polygons | |
| | Contour definitions | |
| | View Displays: | |
| | objects selected for | |
| | display in each view | |
| | Calculator Equations | |
| | Display Limits | |
| | Vertical Exaggeration | |
| | Legends | |

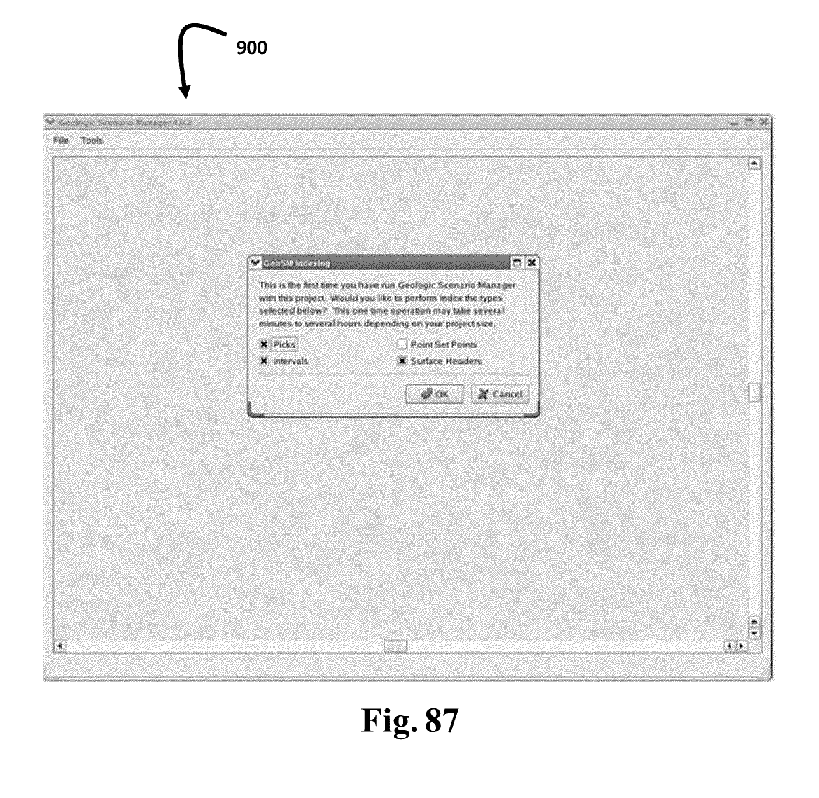

FIG. 87 shows view 900 of the indexing feature of the present disclosure. To start the geological scenario manager, a user may select data to be indexed. The geological scenario manager may then track all indexed objects selected by the user. In another embodiment, the geological scenario manager may automatically select which interpretation objects to track based on a predetermined list of interpretation objects. As shown in FIG. 87, this particular embodiment of the geological scenario manager will track picks, intervals, and surfaces of the input data. Thus, throughout the project, any edits made to picks, intervals, or surfaces are logged. The logging process enables a user to perform a risk analyses by quantitatively and qualitatively analyzing the effect of various interpretations on the resulting 3-D geologic interpretations and models.

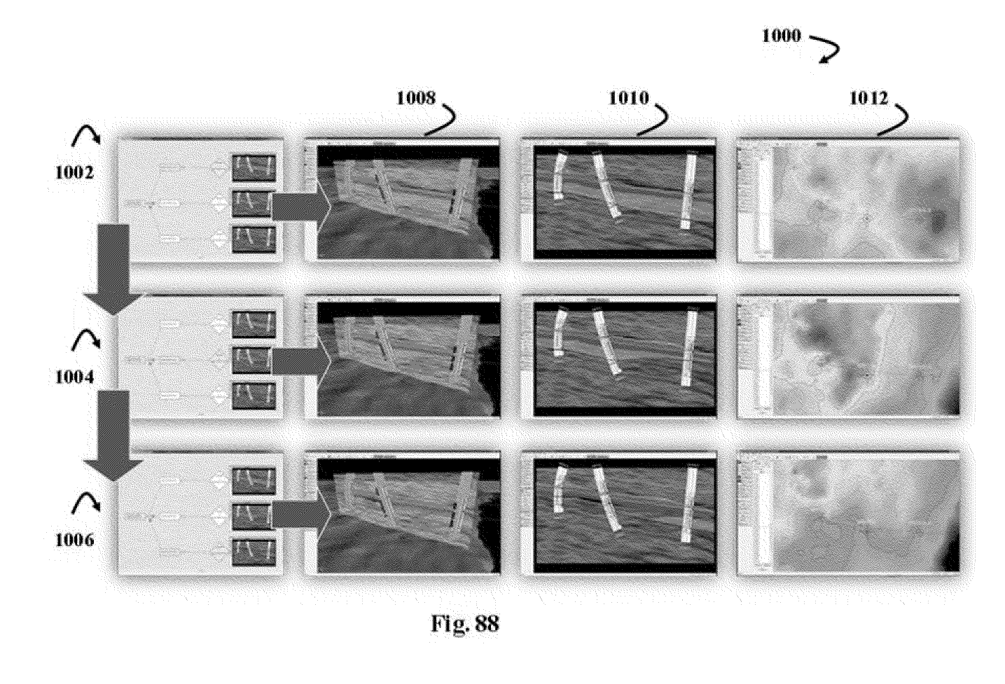

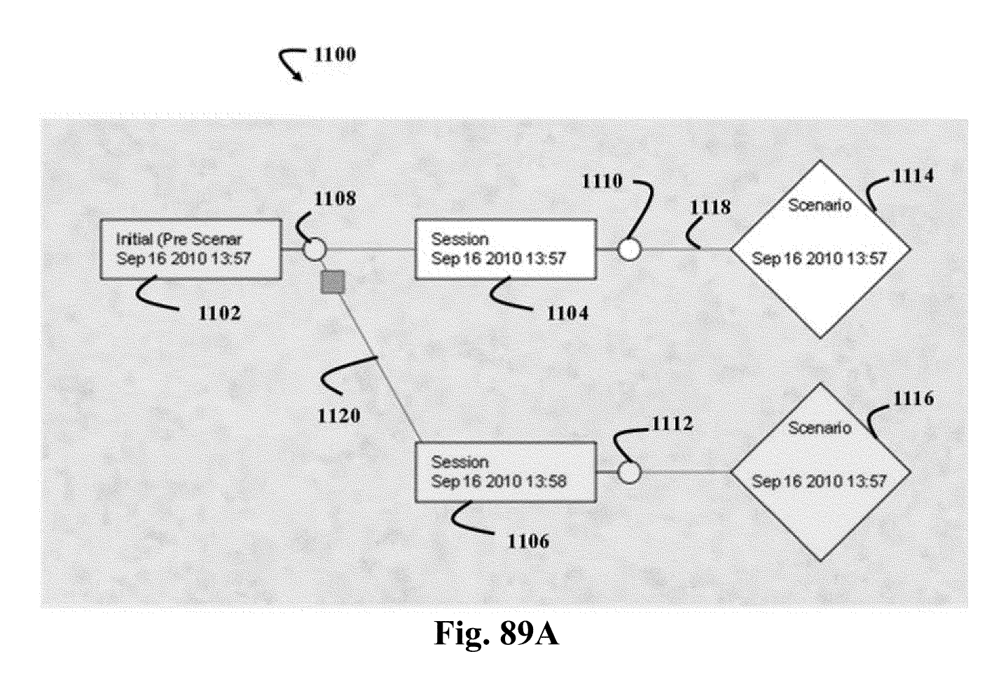

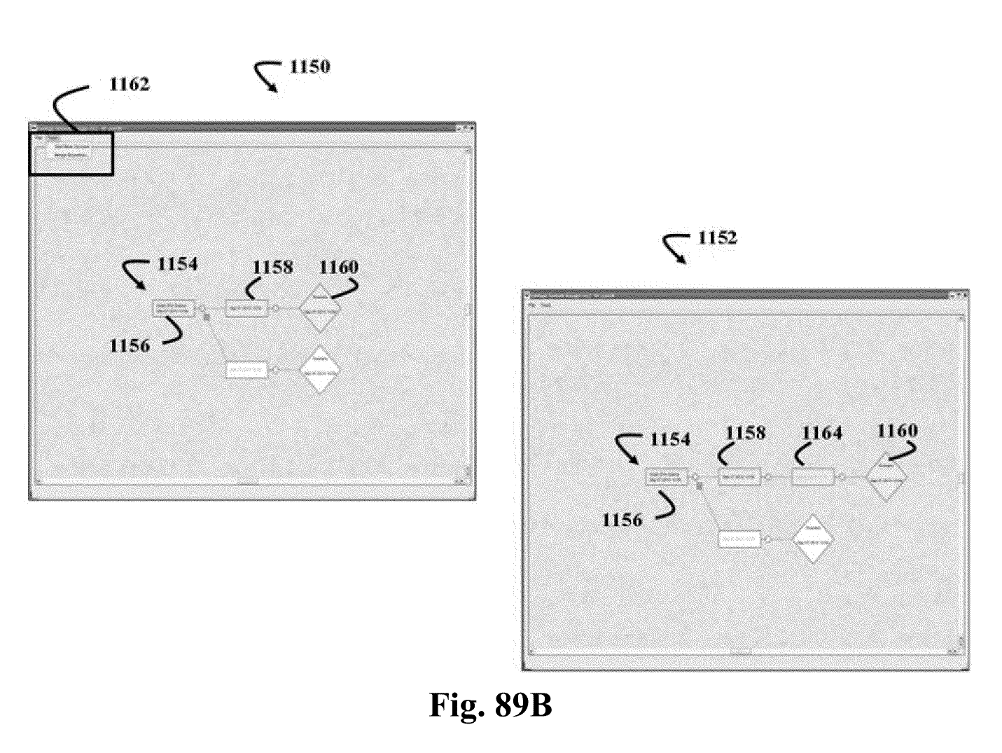

FIG. 88 shows exemplary view 1000 enabling a user to manage risk associated with multiple equiprobable interpretations. FIG. 88 shows branches 1002, 1004, and 1006 representing different interpretation analysis. Each branch begins with the same initial input data and possibly some initial interpretations. A user then interprets the initial input data to create a 3-D geologic interpretation. Thus, differing interpretations on the initial input data form branches 1002, 1004, 1006. Each of these branches terminate in scenarios which comprise all the interpretations made on the initial input data through the branch. The scenarios may then be used to create multiple, alternative 3-D geologic interpretations and models.

In one level of comparison, the present disclosure provides the ability to compare multiple scenarios, or what is known as a branch level comparison. In another level of comparison, the present disclosure provides the ability to incorporate a single geologic feature or profile from one scenario into another scenario, or what is known as a partial comparison. FIG. 88 shows an exemplary view of branch level comparison.

A scenario may be used to create 3-D cross section view 1008, 2-D cross section view 1010, and/or 2-D base map views 1012 among other views. Thus, the geological scenario manager of the present disclosure enables a user to perform a risk analysis by quantitatively and qualitatively comparing the effects different interpretations produce in 3-D geologic interpretations and models. By dynamically switching between the different scenarios, users are able to interactively compare, evaluate, and rank the suitability of each the different scenarios.

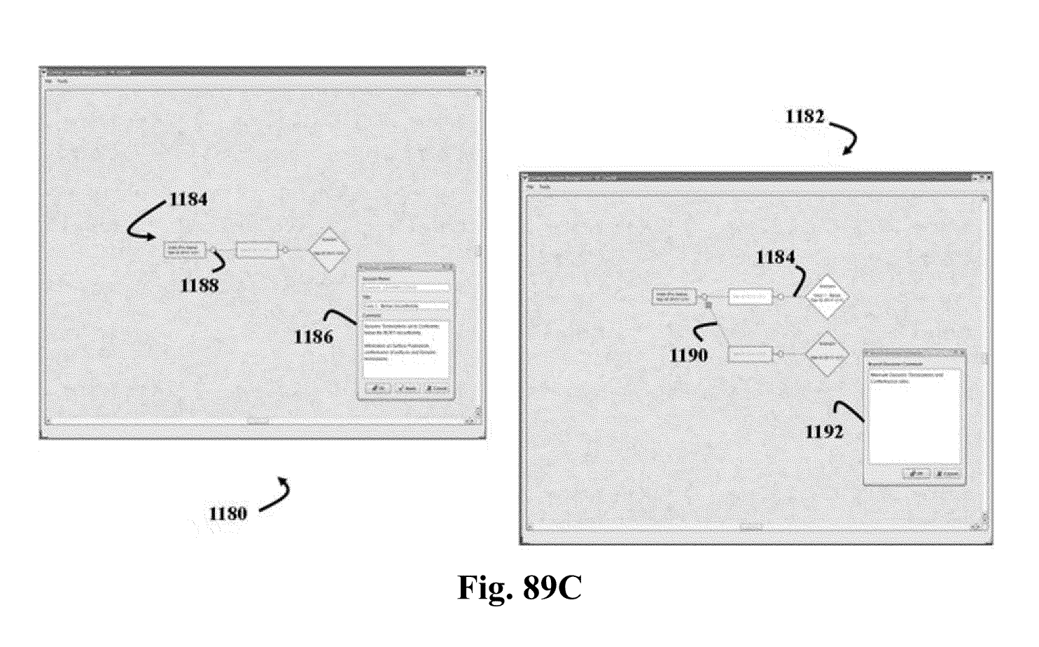

FIG. 89A presents view 1100 of some of the basic functionality of the present disclosure. FIG. 89A shows sessions 1102, 1104, and 1106; decision points 1108, 1110, 1112; scenarios 1114 and 1116; and branches 1118 and 1120. Initial session box 1102 includes all input data to be used on the project and any initial interpretations on that input data. Session boxes 1102, 1104, and 1106 include tracked interpretation objects. A user creates a session to track all work or interpretations made during that session. The geological scenario manager then tracks and stores all interpretation objects and metadata during that session. A user may click on a session box to view all of the interpretation objects modified during that session. As shown, session boxes 1102, 1104, and 1106 display a session name and session time. Further, although not shown here, a user may enter comments about the session so other users may gain a better understanding of the need to create a new session. The user comments may serve other purposes as intended by the user. In another embodiment, each user could add titles to each session.

In another embodiment, a user could set one of the branches as a base case. The designation of base case serves to identify to other users that the designated branch is the primary branch from which work should be done. Users may then branch off the base case to perform various interpretation edits, since the base case includes the primary data. A user may change which branch is given the designation of the base case at any time.

The present disclosure further provides the ability to revisit earlier sessions and undo or redo interpretations or other work created during the session. Further, the teachings of the present disclosure enable a user to re-run 3-D interpretations and models which were created using the data of that session. In this way, the present disclosure enables multi-session undo and re-do capabilities for persistent data including tracked interpretation objects, static data, and other data. Decision points enable a user to add a new session to a branch, create a new branch off an existing branch, or merge two branches.

Branches represent a work flow of all the sessions in the branch. Each branch represents an individual scenario, which includes all edits made to interpretation objects in the branch. A user may then run various 3-D geologic interpretations and models from the scenario or view, redo, or undo edits to interpretation objects created in that branch.

Decision point 1108 branches initial session box 1102 into branch 1118 and branch 1120. Branch 1118 comprises initial session box 1102, session box 1104 decision point 1110, and scenario 1114. Branch 1120 comprises initial session box 1102, session box 1106, decision point 1112, and scenario 1116. Each branch represents different interpretations of the initial input data. A user may then view, compare, and analyze 3-D geological interpretations and models created from each scenario to gain a better understanding of the correctness of assumptions made during the interpretation process. Highlighting on branch 1120 indicates it is an active branch, meaning a user may create 3-D geological interpretations or models that will be captured in scenario 1116. A user may click on a different scenario or session, indicating that it will now be the active branch. All tracked interpretation object edits will be saved in the appropriate session along the branch.

In one embodiment, a user may delete an active branch, but a warning would notify the user that there is still project data in the branch. In another embodiment, a user could backup an active branch, all the tracked interpretation objects and associated metadata would then be backed-up and stored.

In one embodiment, a user may move the various features of user interface presented in view 1100 as needed. For example, various users may move session boxes, decision points, scenarios, branches, among other features around the user interface as desired. Further, a user may zoom-in or zoom-out on certain areas of the project. For example, the user may zoom in to more clearly view branch 1118. As a project becomes more complex, with multiple branches, sessions, and scenarios, these interface features allow the user to easily organize and navigate around the project space.

FIG. 89B shows views 1150 and 1152 providing an exemplary interface for adding a session to an existing branch. Views 1150 and 1152 show active branch 1154 comprising initial session box 1156, session box 1158, and scenario 1160. Scenario 1160 includes all edits to tracked interpretation objects made in sessions 1156 and 1158. As shown in view 1150, a user may add a session box to active branch 1154 by selecting add session box button 1162. As shown in view 1152, session box 1164 is then added to active branch 1154. In other embodiments, other user interfaces may be used to add session boxes to the project space.

FIG. 89C shows views 1180 and 1182 providing an exemplary user interface for branching from an active branch. View 1180 shows active branch 1184, comment box 1186, and decision point 1188. Comment box 1186 allows a user to title a branch and make comments about the branch. A user may create a new branch from decision point 1188. As shown in view 1182, the user has created new branch 1190, having comment box 1192. Other embodiments may employ other user interfaces to add new branches to a project.

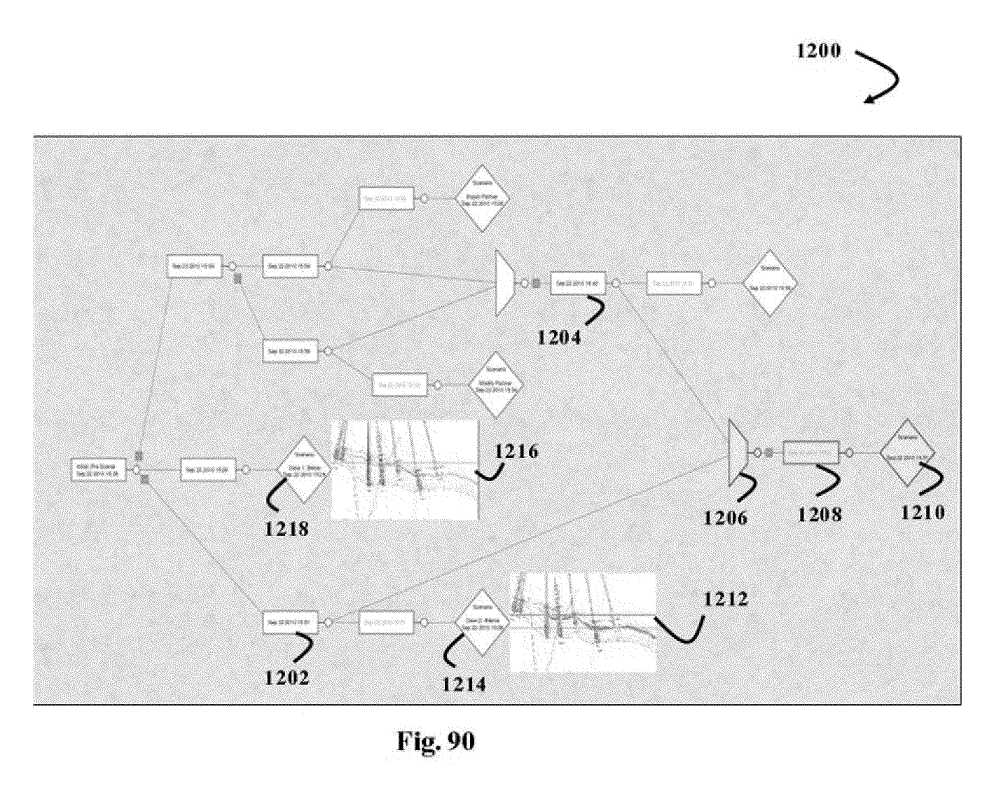

FIG. 90 shows view 1200 presenting additional features of the disclosed subject matter. View 1200 shows session boxes 1202 and 1204. The branches of session boxes 1202 and 1204 are merged 1206 to produce session box 1208 and scenario 1210. Further, FIG. 90 shows pictures 1212 and 1216 representing 3-D geologic interpretations of scenarios 1214 and 1218 respectively.

When scenarios 1204 and 1202 are merged, tracked interpretation objects in the merged branches may conflict. The geological scenario manager determines if a conflict exist by examining the uniqueness of each tracked interpretation object. The geological scenario manager determines the uniqueness of each tracked interpretation object based on the interpretation object's parameters compared to the set of parameters of the conflicting interpretation object. For example, the geological scenario manager would consider a pick unique if the pick is defined for a particular named surface in a particular well. The geological scenario manager would consider two picks in conflict if the named surface pick in a well is at a different depth in each branch or session, resulting in differing 3-D geologic interpretations or models.

Table 2 below shows an exemplary list of parameters compared to determine the uniqueness of each tracked interpretation object.

TABLE 2
Parameters to determine interpretational object uniqueness

| OBJECT | TYPE | Uniqueness comparison |
|---|---|---|
| Picks | Inter-well | Name, (X, Y, Z) coordinates |
| | Well | UWI, name, mdepth |
| | Well Fault | UWI, name, mdepth |
| Grids | Pick Surfaces | Name |
| | Seismic Horizons | Name |
| | Pointsets | Name |
| | Static Grids | Name |
| Faults | Fault Segments | Name |
| | Fault Grids | Name |
| Stratigraphic | | Give the user the choice which Strat Column to honor, |
| Column | | or to merge the two Strat Columns into one. The user |
| | | will distinguish based on the Scenario Column. |
| Culture Data | | Name |
| Annotations | Shapes | Name |
| | Images | Name |
| | Text | Name |
| HyperLinks | Text Note | Name |
| | PDF document | Name |
| | Image (JPG, TIFF, | Name |
| | PNG) | |
| | Spreadsheet | Name |
| | Word (Text) document | Name |
| | User Defined Command/ | Name |
| | 3^{rd} party link | |
| Intervals | | UWI, Start & Stop MD, Class, Type |
| Cross Sections | | Name |
| Wells | Deviations & Position | Name of .dev file |
| | Logs | |
| | Curves | Name of individual log curve name, requires creation |
| | | of updated .rcn files |
| | Groups & Well lists | Name |
| | Well Templates | Name |
| | Substitute logs | Name of Curve-alias definitions |
| Secondary | Application Controls | Give user the choice which scenario to honor (for all |
| Interpretation | and Settings | Seconday Interpretation Objects & Project Settings) |
| Objects | Window placements and | Give user the choice which scenario to honor |
| & Project Settings | Sizes | |
| | Data selections and | Give user the choice which scenario to honor |
| | activations | |
| | Color Assignments | Give user the choice which scenario to honor |
| | Project Limits | Give user the choice which scenario to honor |
| | Grid Increments | Give user the choice which scenario to honor |
| | Grid Masks | Give user the choice which scenario to honor |
| | Gridding Algorithms | Give user the choice which scenario to honor |
| | and Parameters | |
| | Conformability | Give user the choice which scenario to honor |
| | definitions | |
| | Grid Extrapolation | Give user the choice which scenario to honor |
| | controls | |
| | Zone patterns | Give user the choice which scenario to honor |
| | Well Template | Give user the choice which scenario to honor |
| | Definitions | |
| | Fault Polygons | Name |
| | Contour definitions | Give user the choice which scenario to honor |
| | View Displays: objects | Give user the choice which scenario to honor |
| | selected for display in | |
| | each view | |
| | Calculator Equations | Name |
| | Display Limits | Give user the choice which scenario to honor |
| | Vertical Exaggeration | Give user the choice which scenario to honor |
| | Legends | Give user the choice which scenario to honor |

To manage conflicts, the present disclosure enables a conflict resolution system. In one embodiment, a user may select a primary branch and all conflicts will be resolved in favor of the primary branch.

In other embodiments a more granular approach may be taken. For example, the geological scenario manager of the present disclosure may notify the user of conflicts between tracked interpretation objects which affect 3-D geologic interpretations and models. The user may then choose a winning tracked interpretation object, resolving the conflict.

In another embodiment, a user may resolve conflicts between branches by selecting parameters associated with each tracked interpretation object by which to resolve the conflict. For example, since the geological scenario manager of the present disclosure tracks the interpreter who made the interpretation edit to a tracked interpretation object, conflicts may be resolved in favor of a certain interpreter. In another embodiment, more recent interpretation object edits could be favored over older interpretation object edits. Still other conflict resolution methods and parameters may be used.

Pictures 1212 and 1216 may be created by clicking on scenarios 1214 and 1218 respectively. Pictures 1212 and 1216 show 2-D cross section view produced using the teachings of the present disclosure. Based on the input data and interpretations on that data, the present disclosure enables the creation and display of manipulable 3-D geological interpretations and models of geological data. Pictures 1212 and 1216 help inform the user of the effects differing interpretations of input data produce in the 3-D geologic interpretations and models.

The merging, branching, and session creation features of the geological scenario manager enable a user to make and track interpretations on input data. These features used in combination allow the user an unlimited number of possibilities in tracking interpretations, re-using old interpretations, combining interpretations, re-interpreting, and creating new interpretations among many other possibilities. For example, rather than re-creating an older model if newer interpretations prove flawed, a user may simply go back to an old session or scenario to resume work from the earlier interpretation, by creating a new scenario branch. Additionally, a user could merge two sessions, mapping overlapping geological regions, to gain a more complete picture of the entire geological region. The geological scenario manager further enables a user to compare differing interpretations to gain a more complete understanding of the predetermined geological region, and produce more accurate 3-D geologic interpretations and models. In this way, the teachings of the present disclosure not only enable a user to better understand a predetermined geological region, but also quickly and effectively manage multiple equiprobable 3-D interpretations and models.

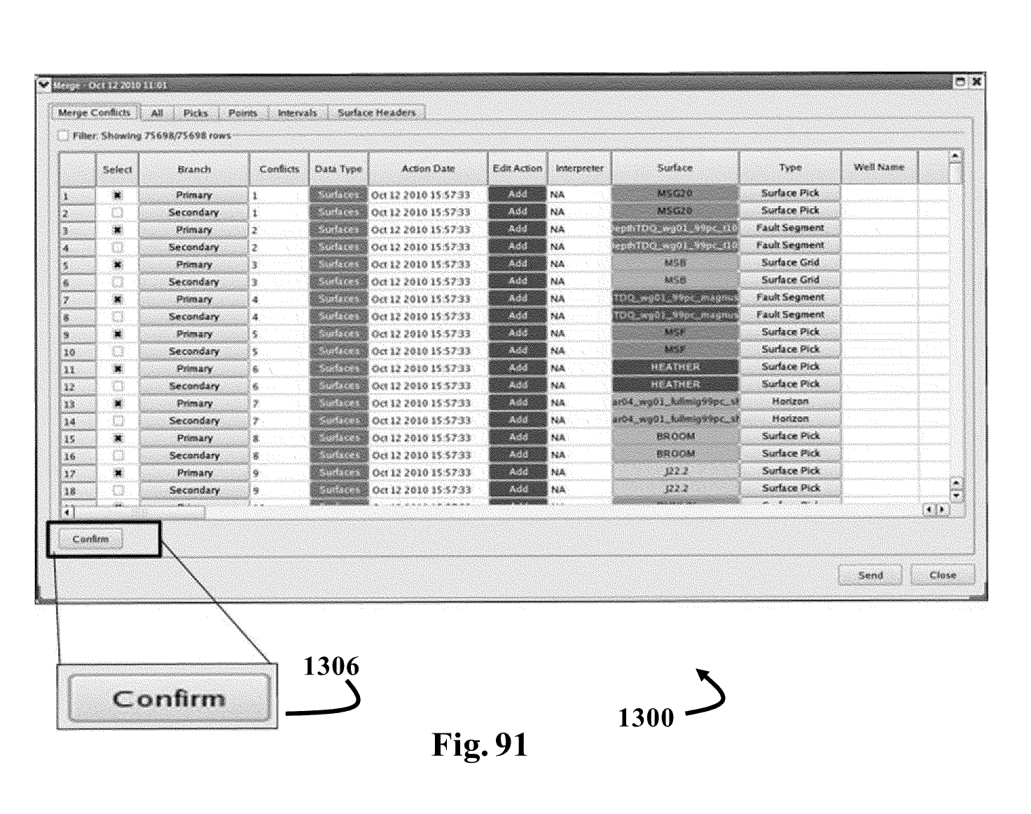

FIG. 91 shows exemplary view 1300 for a user interface for enabling conflict resolution. View 1300 shows conflicts between tracked interpretation objects in a primary and a secondary branch. Column 1302 shows whether the tracked interpretation object belongs to the primary or secondary branch. In the embodiment of FIG. 91, the interpretation object belonging to the primary branch wins out by default. A user may select or deselect an interpretation object from Column 1304 to override the default settings. The user then confirms, creating a new branch from the primary and secondary branches. FIG. 91 shows only one of many possible user interfaces and represents only one conflict resolution process enabled by the teachings of the present disclosure.

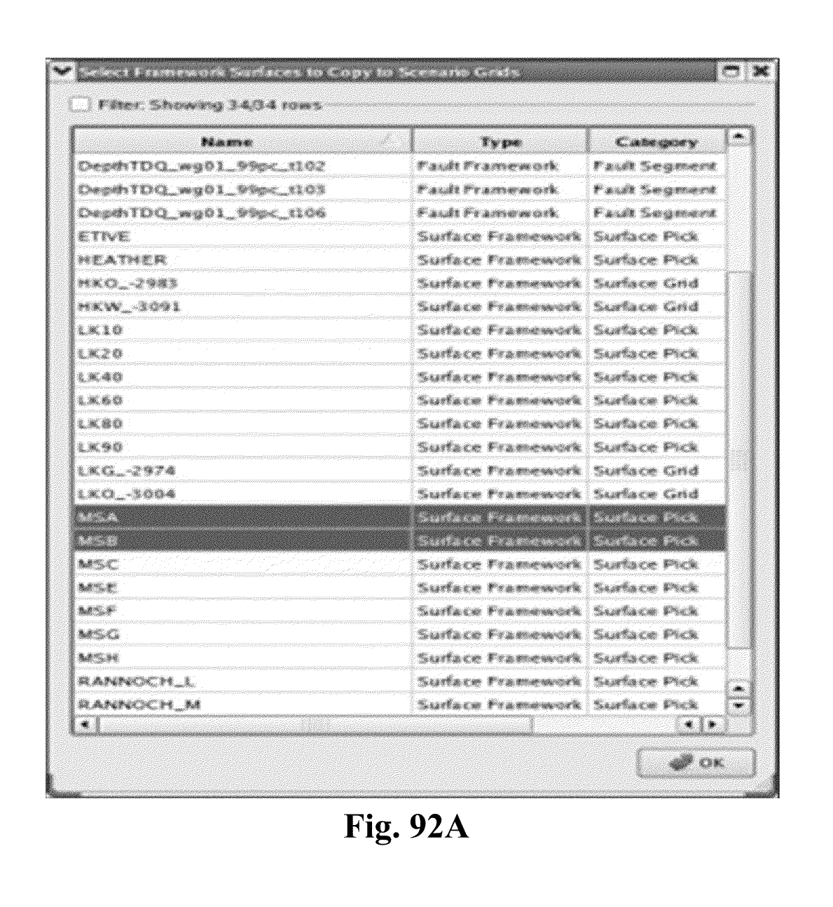

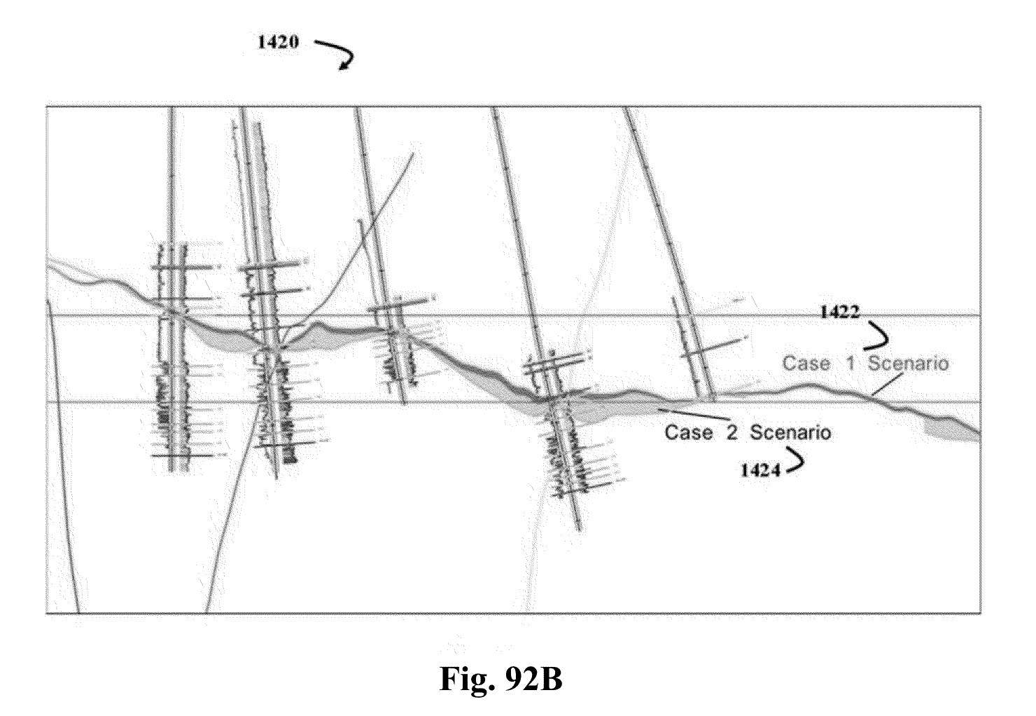

FIG. 92A shows an exemplary view 1400 for a user interface enabling a user to perform partial comparisons between scenarios. A user may perform partial comparisons by placing a single or multiple edited tracked interpretation objects or entire features associated with a predetermined geologic region from one scenario to another. A user may use the partial comparison feature with any of the objects listed in Table 1 or Table 2, among other tracked interpretation objects and geological features. The user may then visualize the effect of a tracked interpretation object edit in multiple scenarios to better determine the correct interpretation.

View 1400 shows a surface level comparison. That is, a user may place an entire surface from one scenario in another scenario. The user may then conduct a risk analysis to determine which surface reduces the risk associated with the final 3-D geological interpretation or model. In other embodiments, a much more granular approach may be taken. For example, in one embodiment a user may place a pick from one scenario in another.

In one embodiment, a user may “push” a tracked interpretation object from a session, multiple sessions, or a scenario to other scenarios or sessions. For example, if a user is working in a branch, they may push the tracked interpretation object or geologic feature to another scenario. In another embodiment, a user may “pull” a tracked interpretation object from another session or scenario to the active session or scenario. In this embodiment, a user could view all the tracked interpretation objects or geologic features made throughout the entire project lifetime, including in other branches.

FIG. 92A shows a view of the pushing feature of the present disclosure. That is, the named surfaces may be pushed to other sessions or scenarios.

FIG. 92B shows 2-D cross sectional view 1420 of a predetermined geologic region. View 1420 results from surface 1422 from a first scenario and surface 1424 from a second scenario being pushed to a third scenario. A user may then perform a risk analysis, comparing surfaces 1422 and 1424 to reduce risk in the resulting 3-D geologic interpretations and models. In certain situations, surfaces pushed into a new scenario may conflict with a surface in the new scenario. For example, if the pushed surface and the existing surface in the new scenario have the same name. Since the user would wish to view both surfaces simultaneously, the conflict resolution system of the present disclosure may append the scenario name to the end of the pushed surface name. A user may later resolve the conflict as needed.

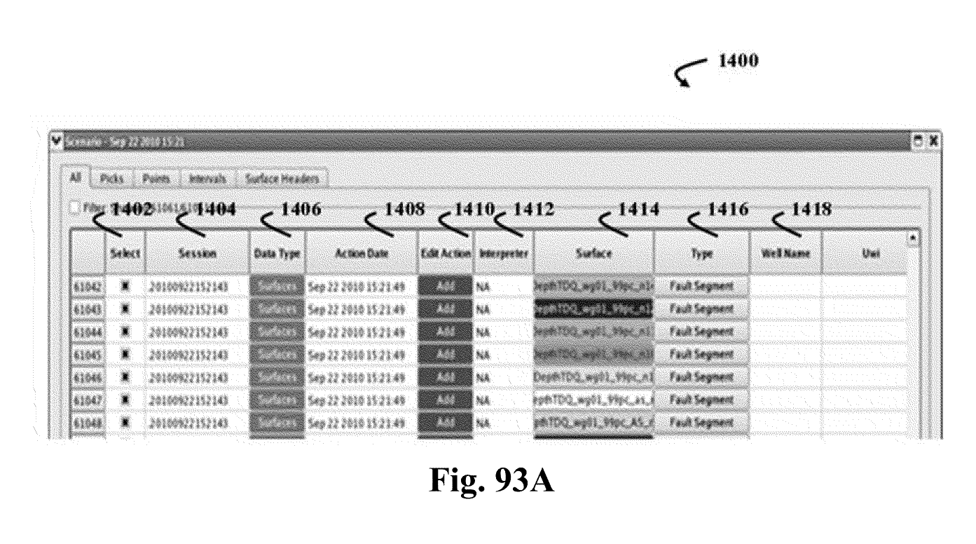

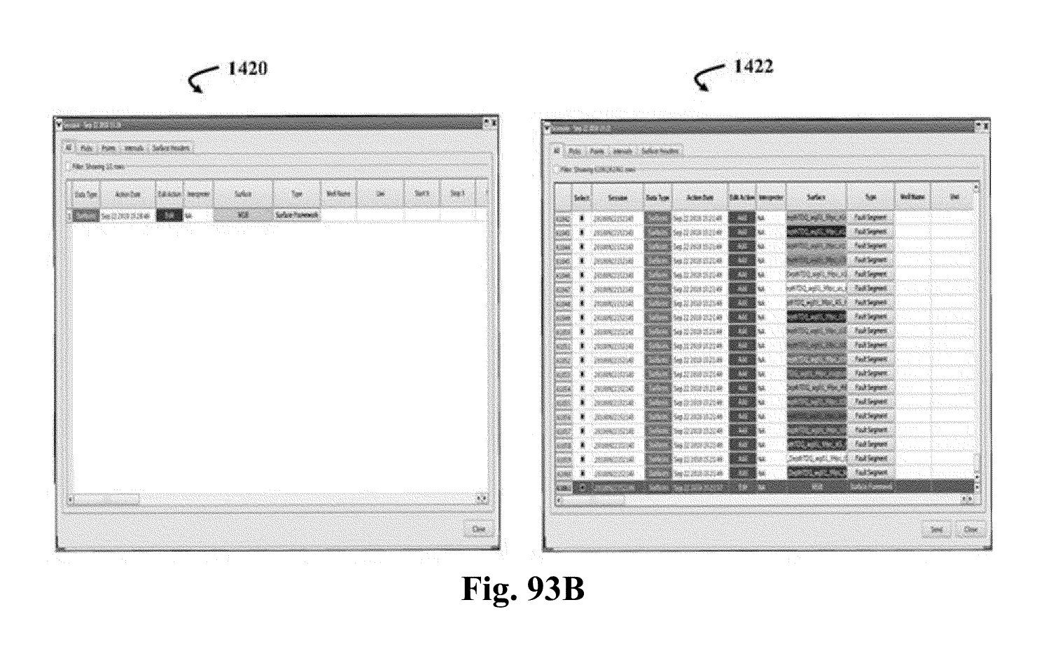

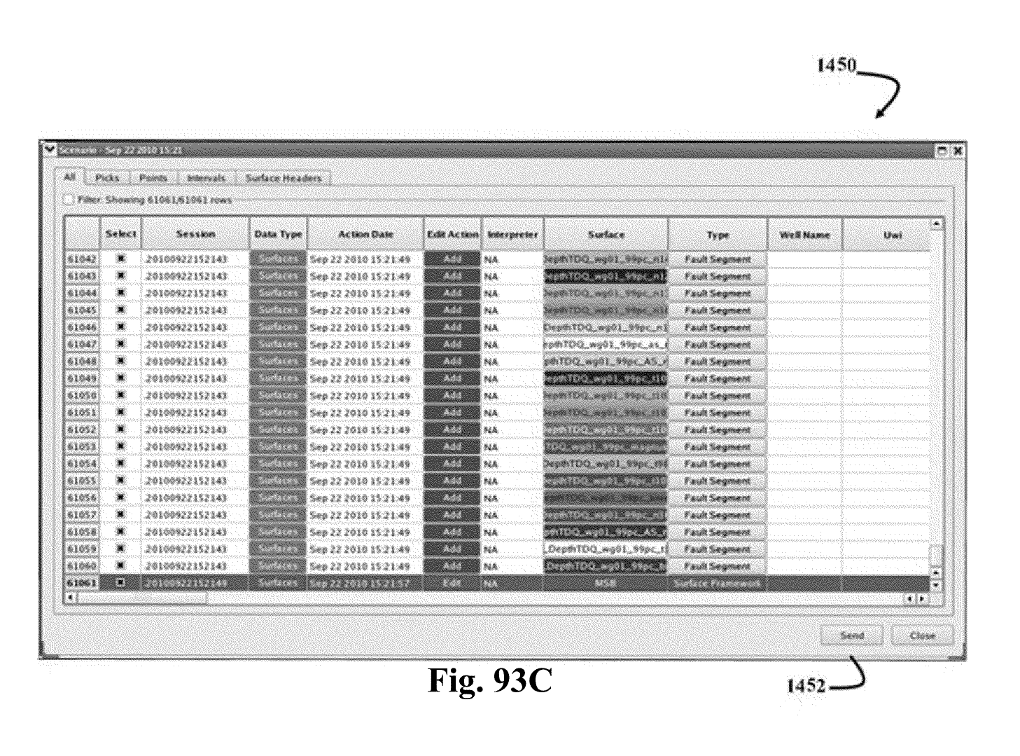

FIG. 93A shows a view 1400 of the user interface for the interpretation object tracker of the present disclosure. The interpretation object tracker of the present disclosure tracks interpretation objects used to create 3-D geologic interpretations and models, allowing a user to track work done throughout a project. Thus the interpretation object tracker provides an audit trail of work done throughout the project. Users may review the metadata associated with each interpretation object to view the interpretation edit; interpreter; interpretation edit effect on values, parameters, and dependencies; date and time of interpretation edit among other tracked metadata. By clicking a session box, multiple session boxes, a scenario box, or multiple scenario boxes, the interpretation object tracker allows a user to view interpretation objects edited in a single session, over multiple sessions, over an entire branch, or over multiple branches. In this way, the geological scenario manager allows a user to view, undo, or redo any edits to tracked interpretation objects which have been made throughout the project lifetime.

View 1400 shows tracked interpretation objects throughout the branch. View 1400 includes select column 1402, session column 1404, data type column 1406, action date column 1408, edit action column 1410, interpreter column 1412, surface column 1414, type column 1416, and well name column 1418 among other tracked parameters. The user interface of view 1400 allows a user to select which data to use in the 3-D geologic interpretations and models to be created using the teachings of the present disclosure.

Select column 1402 allows a user to select or de-select an interpretation object for incorporation in 3-D geologic interpretations and models. Session column 1404 displays the session in which each interpretation object was edited. Data type column 1406 shows the data type of each interpretation object. Action date column 1408 shows when the interpreter made an edit to the 3-D geologic interpretation object. Interpreter column 1410 shows the interpreter who made an edit. Surface column 1412 displays the surface or surfaces affected by the interpretation edit. Type column 1414 shows the interpretation source data for the surface.

The user interface shown by view 1400 further enables a user to sort interpretation objects by any of the columns 1402-1418, as well as columns not pictured above.

View 1400 shows an exemplary user interface for accessing some of the functionality enabled by the interpretation object edit tracking of the present disclosure. The user interface of 1400 not only provides ease-of-use while streamlining the 3-D geologic interpretation and modeling process, but also enables improved project management.

View 1400 allows a project manager to understand employee thought processes while creating 3-D geologic interpretations and models. That is, a user may now review all the work steps done to get to a final work product. For example, using the interpretation object tracker of the present disclosure, a project manager may view the work steps that led to the 3-D interpretations and models. Such a feature enables a project manager to better control project goals during the project lifetime, and other enterprise employees to review the project long after completion. As oil and gas exploration projects may take anywhere from years to decades, the ability to review work steps throughout a project lifetime may prove critical to the success or failure of the project and future projects.

FIG. 93B shows views 1420 and 1422 of the interpretation object tracker for a single session and of a scenario respectively. Thus, a user may view the audit trail for a single session or an entire scenario or branch. Further, a user may view an audit trail of multiple session or multiple branches to view all edits to tracked interpretation objects which occurred throughout the project lifetime. View 1420 may appear if a user selects a single session box, bringing up the audit trail of only the selected session. View 1422 would appear if a user selected a scenario, presenting the audit trail for all the sessions along the branch.

FIG. 93C shows a view 1450 of a user interface for the interpretation object tracker or audit trail of the present disclosure. View 1450 shows send button 1452, enabling a user to send tracked interpretation objects to a geologic interpretation, geologic modeling tool, or other similar geologic simulation tool (ex. reservoir simulation tool). Thus, a user may undo or redo interpretations to view 3-D geologic interpretations and models in geologic interpretation tools. A user may send tracked interpretation objects from a single session, multiple sessions, a single scenario, or multiple scenarios to a geologic interpretation tool. Thus, the geological scenario manager supports project virtual reconstruction, as a user can easily view snapshots of work done throughout a project lifetime by clicking on the individual sessions or scenarios and sending the tracked interpretation objects to a geologic interpretation tool. Further, a user could undo or redo a single or multiple interpretation objects from each of the scenarios and sessions selected. The reader will note, the geological scenario manager resolves conflicts as described if multiple sessions or scenarios are chosen.

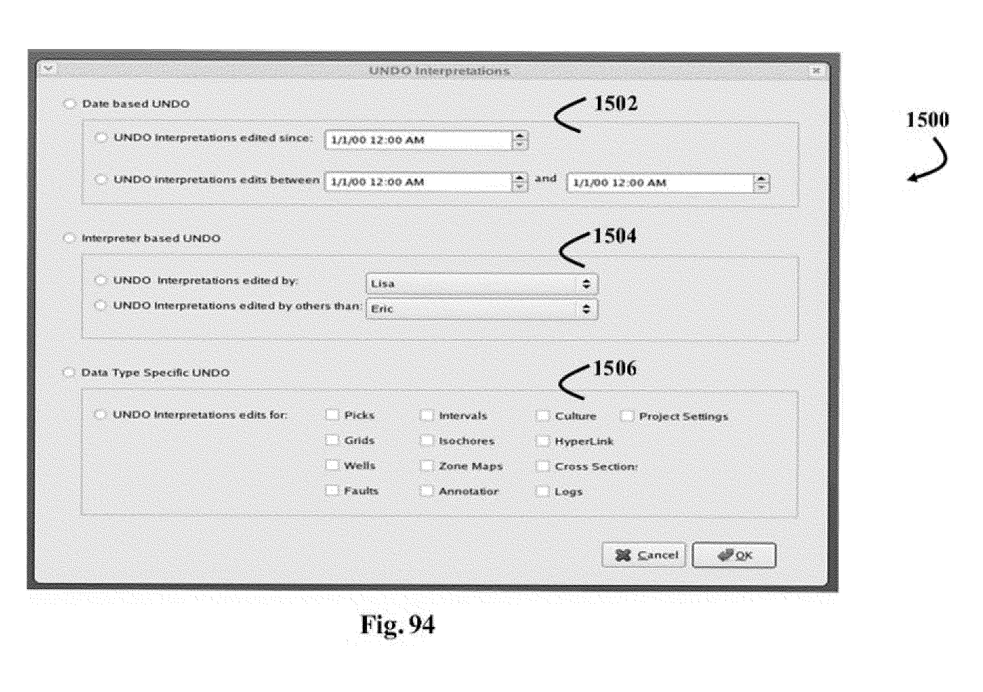

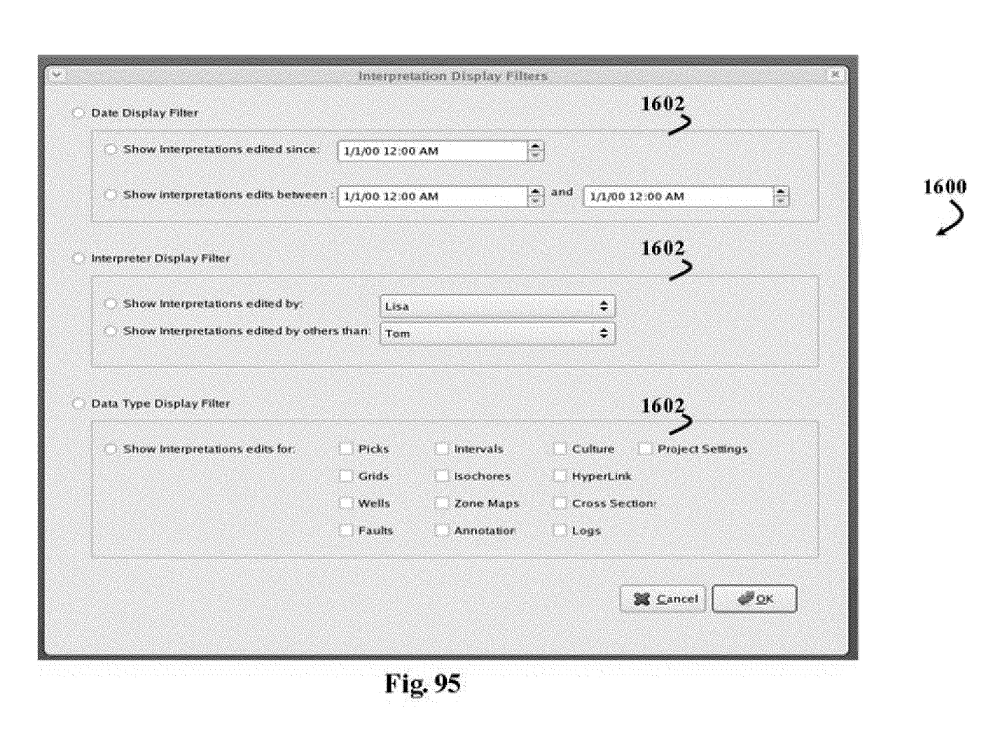

FIG. 94 provides another view 1500 of one embodiment of a user interface for allowing users to undo edits to tracked interpretation objects. The user interface of view 1500 includes date based undo feature 1502, interpreter based undo feature 1504, and data type specific undo feature 1506. In this way, a user may undo certain edits to tracked interpretation objects that occurred over a single session, multiple session, a single scenario, or multiple scenarios. Date based undo feature 1502 enables a user to undo edits based on the date of the edit to the tracked interpretation object. Interpreter based undo feature 1504 allows a user to undo edits based on specific interpreters. Data type specific undo feature 1506 enables a user to undo edits to certain types of tracked interpretation objects.

FIG. 95 shows view 1600 of an exemplary user interface for allowing a user to filter tracked interpretation objects. Using the user interface of view 1600, a user may filter tracked interpretation objects from a single session, multiple sessions, a single scenario, or multiple scenarios. View 1600 of the user interface provides date display filter 1602, interpreter display filter 1604, data type display filter 1606. Date display filter 1602 filters tracked interpretation objects by date. Interpreter display filter 1604 filters tracked interpretation objects by interpreter. Data type display filter 1606 filters tracked interpretation objects by data type. A user may easily sift through the specific tracked interpretation objects they wish to view and incorporate into their 3-D interpretations and models.

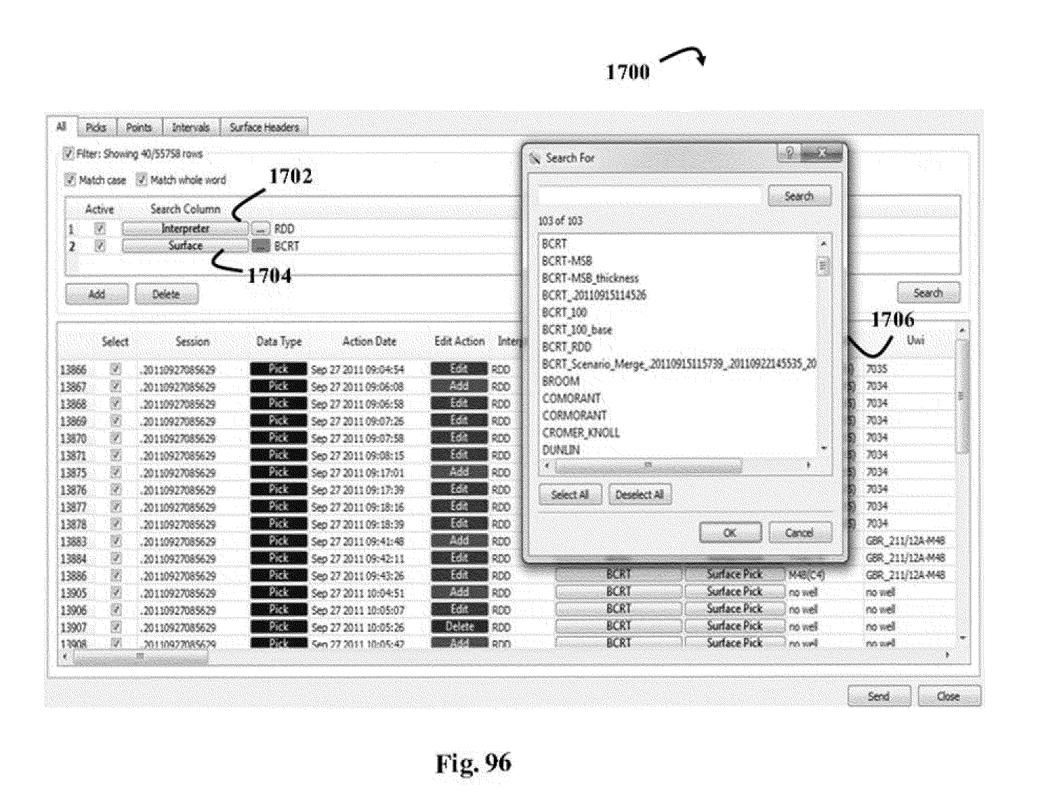

FIG. 96 provides view 1700 of another user interface for using the filtering features of the present disclosure. FIG. 96 shows filter 1702 set to search for the interpreter search column. Thus, a user may search for edits to tracked interpretation objects made by a certain interpreter or set of interpreters. Filter 1704 has been set to surface, bringing up all interpretation edits to tracked interpretation objects having the surface name. Pop-up 1706 shows all surfaces a user may select, bringing up the tracked interpretation objects edited with the surface name. A user may also search any of the columns listed in FIG. 93A or any of the objects listed in Table 1.

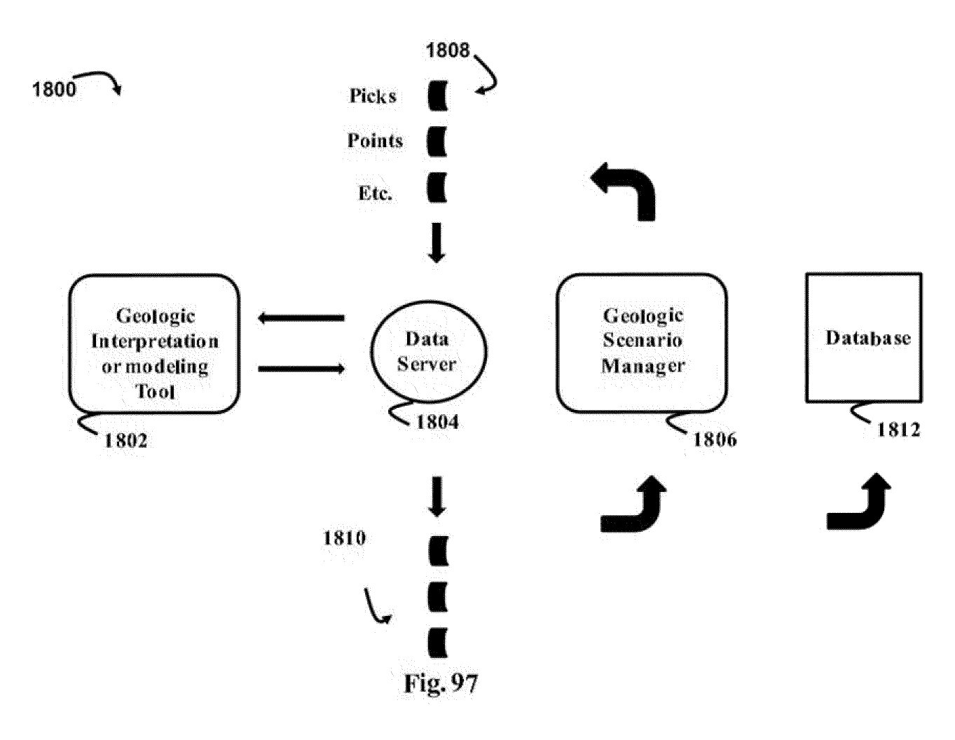

FIG. 97 shows software architecture 1800 for using the geological scenario manager to provide interpretation version control for a geologic interpretation tool. The geological scenario manager of the present disclosure provides tracking of interpretation objects used throughout a project lifetime, thus data does not need to be duplicated for each change to a tracked interpretation object.

FIG. 97 shows software architecture 1800 comprising geologic interpretation or modeling tool 1802, data server 1804, geological scenario manager 1806, and database 1812. Geologic interpretation tool 1802 constructs 3-D geologic interpretations and models from 2-D geologic data pertaining to a predetermined geologic region as described heretofore. If a user is working in geologic interpretation tool 1802, all edits to tracked interpretation objects, along with the associated metadata, will be passed to data server 1804.

Data server 1804 would then transmit the changes to tracked interpretation objects 1810 to geological scenario manager 1806. Data server 1804 may store tracked interpretation object edits in database 1812 if needed. Geological scenario manager 1806 would then associate the tracked interpretation objects 1810 with the correct session or sessions. Thus, a user could make edits in geologic interpretation tool 1802 and the edits would automatically be saved in geological scenario manager 1806. This enables geological scenario manager 1806 to provide interpretation version control functionality among the other features described herein. Further, geological scenario manager 1806 does not need to duplicate all project data for each change. Additionally, by saving edits to tracked interpretation objects and other metadata in various sessions, the geological scenario manager supports project virtual reconstruction. That is a user may run geologic interpretations and models in the geologic interpretation tool for each session to see how the geologic interpretation or model has changed over time without repeating the work of earlier sessions.

As described heretofore, a user may wish to use other functionalities of geological scenario manager 1806. For example, a user may wish to merge two branches, the user would then send tracked interpretation objects 1808 and associated metadata to geologic interpretation tool 1802 to view geologic interpretations and models created by tracked interpretation objects 1808. To accomplish this the user would send data from a session or scenario to from geological scenario manager 1806 to data server 1804. Data server 1804 would then send geologic data 1808 to geologic interpretation tool 1802. A user could then run geologic interpretations and models on tracked interpretation objects 1808 in geologic interpretation tool 1802.

In summary, the present disclosure provides a method and system for performing geological interpretation operations in support of energy resources exploration and production perform well log correlation operations for generating a set of graphical data describing the predetermined geological region. The process and system interpret the geological environment of the predetermined geological region from measured surface and fault data associated with the predetermined geological region. Allowing the user to query and filter graphical data representing the predetermined geological region, the method and system present manipulable three-dimensional geological interpretations of two-dimensional geological data relating to the predetermined geological region and provide displays of base map features associated with the predetermined geological region. The method and system automatically update the manipulable three-dimensional geological interpretations of two-dimensional data relating to the predetermined geological region, as well as calculate three-dimensional well log and seismic interpretations of geological data relating to the predetermined geological region. Moreover, time-related visualizations of production volumes relating to the predetermined geological region are provided for enhancing the ability to interpret and model various geological properties of various geological regions.

The processing features and functions described herein for a method and system for dynamic, three-dimensional geological interpretation and modeling may be implemented in various manners. Moreover, the process and features here described may be stored in magnetic, optical, or other recording media for reading and execution by such various signal and instruction processing systems. The foregoing description of the preferred embodiments, therefore, is provided to enable any person skilled in the art to make or use the claimed subject matter. Thus, the claimed subject matter is not intended to be limited to the embodiments shown herein but is to be accorded the widest scope consistent with the principles and novel features disclosed herein.

What is claimed is:

1. A method for a geological scenario manager, the method comprising the following steps:
receiving input data, wherein said input data comprises geographic data for energy resource exploration and/or production;
receiving a plurality of interpretation objects from at least one interpreter;
assigning a unique identifier to each of said plurality of interpretation objects, said unique identifier stored on a non-transitory computer readable medium;
permitting at least one of said interpreters to create a first scenario, said first scenario based on said input data and said interpretation objects;
permitting at least one of said interpreters to perform at least one interpretation edit;
tracking each of said interpretation edits, wherein said tracking includes storing on said non-transitory computer readable medium at least:
said interpretation edit;
a time, said time corresponding to the time said interpretation edit was made;
a date, said date corresponding to the date said interpretation edit was made; and
said interpreter who made said interpretation edit.

2. The method of claim 1, additionally comprising the step of permitting at least one of said interpreters to add metadata to said input data, said interpretation objects, and/or said first scenario.

3. The method of claim 1, additionally comprising the step of permitting at least one of said interpreters to view a graphical visualization of at least a portion of said first scenario.

4. The method of claim 3, wherein said graphical visualization includes all interpretation edits for said portion of said first scenario.

5. The method of claim 4, additionally comprising the step of permitting at least one of said interpreters to revert back to any interpretation edit for said portion of said first scenario.

6. The method of claim 1, additionally comprising the steps of:
permitting at least one of said interpreters to branch from said first scenario to create a second scenario, said branch occurring at, before, or after any interpretation edit;
permitting at least one of said interpreters to perform additional interpretation edits to both said first scenario and said second scenario; and
tracking said branching and all of said additional interpretation edits made to either said first scenario or second scenario.

7. The method of claim 6, additionally comprising the step of permitting at least one of said interpreters to merge said first scenario and said second scenario and in response to said merging of first scenario and said second scenario, performing conflict resolution.

8. The method of claim 7, wherein said conflict resolution is performed according to one of the following:
one of said interpreters designating said first scenario or said second scenario as a primary branch and said conflict resolution resolves conflicts in favor of said primary branch;
prompts one of said interpreters to interactively resolve each of said conflicts;
one of said interpreters designates a priority of said interpreters and said conflict resolution resolves conflicts in favor of said priority;
each conflict is resolved in favor of the particular interpretation edit that was completed later than the corresponding conflicting interpretation edit.

9. The method of claim 6, additionally comprising the step of permitting at least one of said interpreters to compare said first scenario and said second scenario, said comparison comprising:
branch level comparison; or
partial comparison.

10. The method of claim 1, wherein said plurality of interpretation objects comprises at least two from the group comprising:
picks;
faults;
seismic horizons;
isochores;
wells; and
well logs.

11. The method of claim 1, wherein said plurality of interpretation object comprise at least one of each of the following:
picks;
faults;
seismic horizons;
isochores;
wells; and
well logs.

12. A non-transitory computer readable medium encoded with instructions executable on a processor, the instructions comprising the following steps:
receiving input data, wherein said input data comprises geographic data for energy resource exploration and/or production;
receiving a plurality of interpretation objects from at least one interpreter;
assigning a unique identifier to each of said plurality of interpretation objects, said unique identifier stored on a non-transitory computer readable medium;
permitting at least one of said interpreters to create a first scenario, said first scenario based on said input data and said interpretation objects;
permitting at least one of said interpreters to perform at least one interpretation edit;
tracking each of said interpretation edits, wherein said tracking includes storing on said non-transitory computer readable medium at least:
said interpretation edit;
a time, said time corresponding to the time said interpretation edit was made;
a date, said date corresponding to the date said interpretation edit was made; and
said interpreter who made said interpretation edit.

13. The method of claim 12, additionally comprising the steps of:
permitting at least one of said interpreters to branch from said first scenario to create a second scenario, said branch occurring at, before, or after any interpretation edit;
permitting at least one of said interpreters to perform additional interpretation edits to both said first scenario and said second scenario; and
tracking said branching and all of said additional interpretation edits made to either said first scenario or second scenario.

14. The non-transitory computer readable medium of claim 13, additionally comprising the step of permitting at least one of said interpreters to merge said first scenario and said second scenario and in response to said merging of first scenario and said second scenario, performing conflict resolution.

15. The non-transitory computer readable medium of claim 14, wherein said conflict resolution is performed according to one of the following:
one of said interpreters designating said first scenario or said second scenario as a primary branch and said conflict resolution resolves conflicts in favor of said primary branch;
prompts one of said interpreters to interactively resolve each of said conflicts;
one of said interpreters designates a priority of said interpreters and said conflict resolution resolves conflicts in favor of said priority;
each conflict is resolved in favor of the particular interpretation edit that was completed later than the corresponding conflicting interpretation edit.

16. The non-transitory computer readable medium of claim 13, additionally comprising the step of permitting at least one of said interpreters to compare said first scenario and said second scenario, said comparison comprising:
branch level comparison; or
partial comparison.

17. The method of claim 12, additionally comprising the step of permitting at least one of said interpreters to view a graphical visualization of at least a portion of said first scenario.

18. The method of claim 17, wherein said graphical visualization includes all interpretation edits for said portion of said first scenario.

19. The method of claim 18, additionally comprising the step of permitting at least one of said interpreters to revert back to any interpretation edit for said portion of said first scenario.

20. A method for a geological scenario manager, the method comprising the following steps:
receiving input data, wherein said input data comprises geographic data for energy resource exploration and/or production;
receiving a plurality of interpretation objects from at least one interpreter;
assigning a unique identifier to each of said plurality of interpretation objects, said unique identifier stored on a non-transitory computer readable medium;
permitting at least one of said interpreters to create a first scenario, said first scenario based on said input data and said interpretation objects;
permitting at least one of said interpreters to branch from said first scenario to create one or more additional scenarios, said branch occurring at, before, or after any interpretation edit;
permitting at least one of said interpreters to add metadata to said input data, said interpretation objects, and/or one or more of said scenarios;
permitting at least one of said interpreters to view a graphical visualization of at least a portion of one or more of said scenarios, said graphical visualization including all interpretation edits for said portion of said one or more scenarios;
permitting at least one of said interpreters to revert back to a point in any of said scenarios, said point at, before, or after any of said interpretation edits or said branches;
permitting at least one of said interpreters to perform at least one interpretation edit to at least one of said scenarios;
tracking each of said interpretation edits and said branching, wherein said tracking includes storing on said non-transitory computer readable medium at least:
said interpretation edit or said branching;
a time, said time corresponding to the time said interpretation edit or said branching was made;
a date, said date corresponding to the date said interpretation edit or said branching was made; and
said interpreter who made said interpretation edit or said branch;
permitting at least one of said interpreters to merge at least two scenarios and in response to said merging of at least two scenarios, performing conflict resolution;
permitting at least one of said interpreters to compare at least two of said scenarios, said comparison comprising:
branch level comparison; or
partial comparison.
